(19) United States
(12) Patent Application Publication
(10) Pub. No.: US 2023/0111860 A1
(43) Pub. Date: Apr. 13, 2023

(54) CONFIGURATION OF UE MEASUREMENTS

(71) Applicant: Telefonaktiebolaget LM Ericsson (publ), Stockholm (SE)

(72) Inventors: Massimo CONDOLUCI, Sundbyberg (SE); Ali EL ESSAILI, Aachen (DE)

(21) Appl. No.: 17/910,515

(22) PCT Filed: Dec. 16, 2020
(86) PCT No.: PCT/EP2020/086472

§ 371 Date: Sep. 9, 2022

Related U.S. Application Data
(60) Provisional application No. 62/968,433, filed on Jan. 31, 2020.
(60) Provisional application No. 63/010,137, filed on Apr. 15, 2020.

(51) Int. Cl. H04W 24/10

(52) U.S. Cl. CPC H04W 24/10

(57) ABSTRACT

A method performed by a vehicle-to everything, V2X, application enabler, VAE, client includes receiving a user equipment, UE, measurements configuration request from a vehicle-to everything, V2X, application-specific client. The method further includes processing the UE measurements configuration request. The method further includes transmitting the UE measurements configuration request to a vehicle-to everything, V2X, application enabler, VAE, server. The method further includes receiving a UE measurements configuration response from the VAE server. The method further includes processing the UE measurements configuration response. The method includes transmitting the UE measurements configuration response to the V2X application-specific client.

### TECHNICAL FIELD

The present disclosure relates generally to communications, and more particularly to communication methods and related devices and nodes supporting communications.

### BACKGROUND

An important aspect for V2X (vehicle to everything) applications is related to having information about network capabilities in a certain geographical area or in a certain time window in order to support the decision process of applications. Examples of such information are expected/predicted performance or achievable quality of service (QoS) that could be used by the application e.g. to select a certain path according to achievable QoS along that path or to adapt vehicle's behavior according to expected performance.

3GPP investigated how to enhance the knowledge of applications about network state and performance considering V2X applications in TS 23.287. In particular, 3GPP has defined the Procedure for notification on potential QoS change to the V2X Application Server (TS 23.287, clause 6.4.1), which is based on the procedure for QoS Sustainability Analytics defined in TS 23.288, clause 6.9. The consumer of QoS Sustainability analytics may request the network data analytics function (NWDAF) analytics information regarding the QoS change statistics for an observation period in the past in a certain area or the likelihood of a QoS change for an observation period in the future in a certain area. Note that NWDAF collects the relevant statistics information and/or measurements on the QoS key performance indicator (KPI) for the relevant key performance indicators (KPIs) of interest from the Operations, Administration and Maintenance (OAM) system. 5GAA released a white paper on “Making 5G Proactive and Predictive for the Automotive Industry” in December 2019, which focused on automotive industry needs in terms of having accurate information about predicted network performance. In this white paper, 5GAA considered that accurate prediction could be enabled by using client performance measurements, i.e., network performance KPIs measured in the UE or in the application (e.g. data rate, latency, packet loss rate, etc.).

### SUMMARY

Currently, there is not a standardized way for applications to provide measurements to network functions in a mobile network. This aspect is missing when considering application level measurements, both at server and client side, and also when considering UE-level measurements (i.e., measurements from chipset/modem) that could be available at application level.

Various embodiments of inventive concepts described herein provide ways of configuring the delivery of UE/application measurements collected from the application layer to relevant network functions. An advantage that may be achieved is avoidance of being bound to using application-specific or network-specific implementations and may provide measurements to network functions regardless of the operators to which a V2X UE is connected.

According to some embodiments of inventive concepts, a method performed by a vehicle-to everything, V2X, application-specific server includes transmitting a user equipment, UE, measurements configuration request to a vehicle-to everything, V2X, application enabler, VAE, server. The method includes receiving a UE measurements configuration response from the VAE server. The method includes processing the UE measurements configuration response.

Analogous embodiments of V2X application-specific servers and computer programs are also provided.

According to other embodiments of inventive concepts, a method performed by a vehicle-to everything, V2X, application enabler, VAE, server includes receiving a user equipment, UE, measurements configuration request from one of a vehicle-to everything, V2X, application-specific server or a VAE client. The method includes processing the UE measurements configuration request. The method includes transmitting a UE measurements configuration response to the one of the V2X application-specific server or the VAE client.

Analogous embodiments of VAE servers and computer programs are also provided.

According to yet other embodiments of inventive concepts, a method performed by a vehicle-to everything, V2X, application-specific client includes transmitting a user equipment, UE, measurements configuration request towards a vehicle-to everything, V2X, application enabler, VAE, server. The method includes receiving a UE measurements configuration response from the VAE server. The method includes processing the UE measurements configuration response.

Analogous embodiments of V2X application specific clients and computer programs are also provided.

According to further embodiments of inventive concepts, a method performed by a vehicle-to everything, V2X, application enabler, VAE, client includes receiving a user equipment, UE, measurements configuration request from a vehicle-to everything, V2X, application-specific client. The method includes processing the UE measurements configuration request. The method includes transmitting the UE measurements configuration request to a vehicle-to everything, V2X, application enabler, VAE, server. The method includes receiving a UE measurements configuration response from the VAE server. The method includes processing the UE measurements configuration response. The method includes transmitting the UE measurements configuration request to the V2X application-specific client.

Analogous embodiments of VAE clients and computer programs are also provided.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a signaling diagram illustrating an embodiment of a V2X application enabler (VAE) server registration to V2X application-specific server for UE measurements in accordance with some embodiments of inventive concepts;

FIG. 2 is signaling diagram illustrating an embodiment of a V2X application-specific server providing UE measurements to VAE Server in accordance with some embodiments of inventive concepts;

FIG. 3 is signaling diagram illustrating an embodiment of a VAE server registration to a VAE client for UE measurements from a V2X application-specific client in accordance with some embodiments of inventive concepts;

FIG. 4 is signaling diagram illustrating an embodiment of a V2X application-specific client providing UE measurements to a VAE Server via a VAE Client in accordance with some embodiments of inventive concepts;

FIG. 5 is a signaling diagram illustrating an embodiment of a process for configuring a UE measurements configuration triggered by a V2X application-specific server in accordance with some embodiments of inventive concepts;

FIG. 6 is signaling diagram illustrating an embodiment of cancelling a UE measurements configuration at a V2X application-specific server triggered by a VAE server in accordance with some embodiments of inventive concepts;

FIG. 7 is signaling diagram illustrating an embodiment of cancelling a UE measurements configuration at a V2X application-specific server in accordance with some embodiments of inventive concepts;

FIG. 8 is signaling diagram illustrating an embodiment of a process for a UE measurements configuration triggered by a V2X application-specific client in accordance with some embodiments of inventive concepts;

FIG. 9 is signaling diagram illustrating an embodiment of cancelling a UE measurements configuration at a V2X application-specific client triggered by a VAE server in accordance with some embodiments of inventive concepts;

FIG. 10 is signaling diagram illustrating an embodiment of cancelling a UE measurements configuration at a V2X application-specific client triggered by a V2X application-specific client in accordance with some embodiments of inventive concepts;

FIG. 11 is signaling diagram illustrating an embodiment of a VAE Server processing UE measurements for notifications to V2X applications, applied to the case of notification on QoS Sustainability Analytics in accordance with some embodiments of inventive concepts;

FIG. 12 is signaling diagram illustrating an embodiment of a VAE Client processing UE measurements for notifications to V2X applications, applied to the case of notification on QoS Sustainability Analytics in accordance with some embodiments of inventive concepts;

FIG. 13 is signaling diagram illustrating an embodiment of updating parameters of network procedures with UE measurements, applied to the case of notification on QoS Sustainability Analytics in accordance with some embodiments of inventive concepts;

FIG. 14 is signaling diagram illustrating an embodiment of providing UE measurements to relevant network functions in accordance with some embodiments of inventive concepts;

FIG. 15 is signaling diagram illustrating an embodiment of a VAE server subscribing to receive UE measurements from a V2X UE in accordance with some embodiments of inventive concepts;

FIG. 16 is signaling diagram illustrating an embodiment of a V2X UE sending UE measurements to a VAE server in accordance with some embodiments of inventive concepts;

FIG. 17 is signaling diagram illustrating an embodiment of a process for a VAE client triggering a request of a UE measurements configuration from a VAE server in accordance with some embodiments of inventive concepts;

FIG. 18 is signaling diagram illustrating an embodiment of canceling a UE measurements configuration that triggers an invalidation of previously configured UE measurements configuration in accordance with some embodiments of inventive concepts;

FIG. 19 is signaling diagram illustrating an embodiment of monitoring and control of QoS for eV2X communications in accordance with some embodiments of inventive concepts;

FIG. 20 is a block diagram illustrating a V2X UE according to some embodiments of inventive concepts;

FIG. 21 is a block diagram illustrating a VAE server according to some embodiments of inventive concepts;

FIG. 22 is a block diagram illustrating a V2X application-specific server according to some embodiments of inventive concepts;

FIGS. 23-28 are flow charts illustrating operations of a VAE server according to some embodiments of inventive concepts;

FIGS. 29-31 are flow charts illustrating operations of a VAE client according to some embodiments of inventive concepts;

FIGS. 32-35 are flowcharts illustrating operations of a V2X application-specific server according to some further embodiments of inventive concepts;

FIGS. 36-40 are flow charts illustrating operations of a VAE server according to some further embodiments of inventive concepts;

FIGS. 41-43 are flow charts illustrating operations of a V2X application-specific client according to some embodiments of inventive concepts;

FIGS. 44-47 are flow charts illustrating operations of a VAE client according to some embodiments of inventive concepts;

FIG. 48 is a block diagram of a wireless network in accordance with some embodiments;

FIG. 49 is a block diagram of a user equipment in accordance with some embodiments

FIG. 50 is a block diagram of a virtualization environment in accordance with some embodiments;

FIG. 51 is a block diagram of a telecommunication network connected via an intermediate network to a host computer in accordance with some embodiments;

FIG. 52 is a block diagram of a host computer communicating via a base station with a user equipment over a partially wireless connection in accordance with some embodiments;

FIG. 53 is a block diagram of methods implemented in a communication system including a host computer, a base station and a user equipment in accordance with some embodiments;

FIG. 54 is a block diagram of methods implemented in a communication system including a host computer, a base station and a user equipment in accordance with some embodiments;

FIG. 55 is a block diagram of methods implemented in a communication system including a host computer, a base station and a user equipment in accordance with some embodiments; and

FIG. 56 is a block diagram of methods implemented in a communication system including a host computer, a base station and a user equipment in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

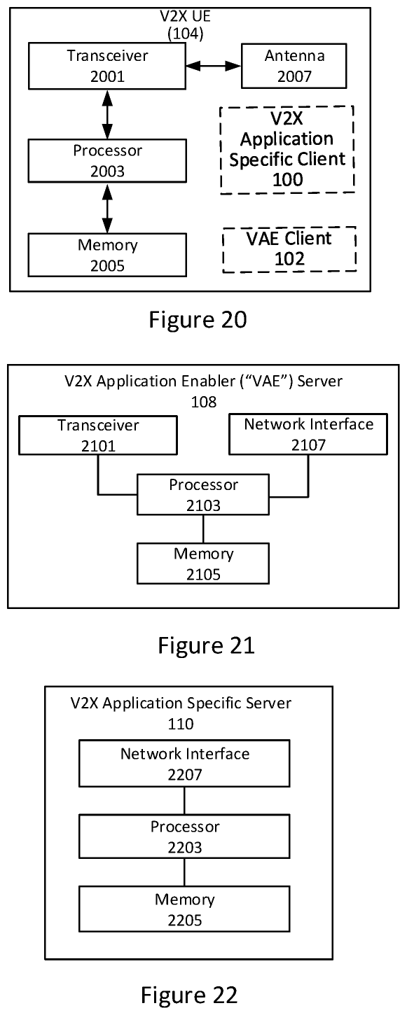

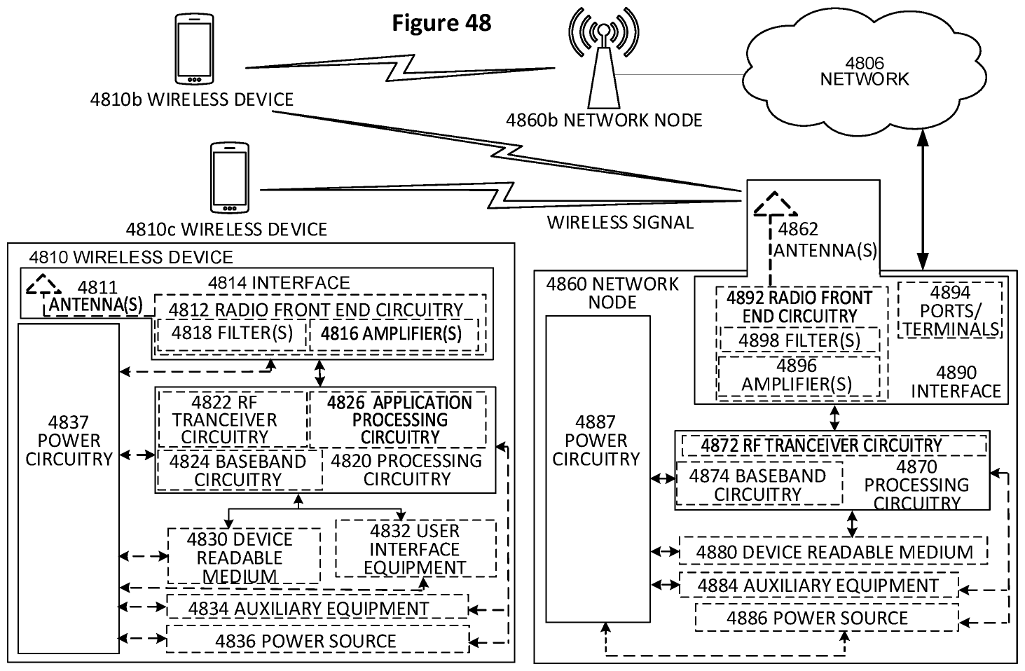

FIG. 20 is a block diagram illustrating elements of a V2X UE 104 (also referred to as a VAE client, a V2X application-specific client, a mobile terminal, a mobile communication terminal, a wireless communication device, a wireless terminal, mobile device, a wireless communication terminal, user equipment, UE, a user equipment node/terminal/device, etc.) configured to provide wireless communication according to embodiments of inventive concepts. (V2X UE 104 may be provided, for example, as discussed below with respect to wireless device 4810 of FIG. 48.) The V2X UE 104 may implement a VAE client 102 and a V2X application-specific client 100 where the VAE client 102 and V2X application specific client use the components (transceiver 2001, processor 2003, memory 2005, etc.) of V2X UE 104. As shown, V2X UE 104 may include an antenna 2007 (e.g., corresponding to antenna 4811 of FIG. 48), and transceiver circuitry 2001 (also referred to as a transceiver, e.g., corresponding to interface 4814 of FIG. 48) including a transmitter and a receiver configured to provide uplink and downlink radio communications with a base station(s) (e.g., corresponding to network node 4860 of FIG. 48, also referred to as a RAN node) of a radio access network. V2X UE 104 may also include processing circuitry 2003 (also referred to as a processor, e.g., corresponding to processing circuitry 4820 of FIG. 48) coupled to the transceiver circuitry, and memory circuitry 2005 (also referred to as memory, e.g., corresponding to device readable medium 4830 of FIG. 48) coupled to the processing circuitry. The memory circuitry 2005 may include computer readable program code that when executed by the processing circuitry 2003 causes the processing circuitry to perform operations according to embodiments disclosed herein. According to other embodiments, processing circuitry 2003 may be defined to include memory so that separate memory circuitry is not required. V2X UE 104 may also include an interface (such as a user interface) coupled with processing circuitry 2003, and/or V2X UE 104 may be incorporated in a vehicle.

As discussed herein, operations of V2X UE 104 may be performed by processing circuitry 2003 and/or transceiver circuitry 2001. For example, processing circuitry 2003 may control transceiver circuitry 2001 to transmit communications through transceiver circuitry 2001 over a radio interface to a radio access network node (also referred to as a base station) and/or to receive communications through transceiver circuitry 2001 from a RAN node over a radio interface. Moreover, modules may be stored in memory circuitry 2005, and these modules may provide instructions so that when instructions of a module are executed by processing circuitry 2003, processing circuitry 2003 performs respective operations (e.g., operations discussed below with respect to Example Embodiments relating to wireless devices).

FIG. 21 is a block diagram illustrating elements of a V2X Application Enabler (VAE) server 108 (also referred to as a network node, base station, eNodeB/eNB, gNodeB/gNB, etc.) of a Network configured to provide cellular communication according to embodiments of inventive concepts. (VAE server 108 may be provided, for example, as discussed below with respect to network node 4860 of FIG. 48.) As shown, the VAE server 108 may include transceiver circuitry 2101 (also referred to as a transceiver, e.g., corresponding to portions of interface 4890 of FIG. 48) including a transmitter and a receiver configured to provide uplink and downlink radio communications with mobile terminals. The VAE server 108 may include network interface circuitry 2107 (also referred to as a network interface, e.g., corresponding to portions of interface 4890 of FIG. 48) configured to provide communications with other nodes (e.g., with other base stations) of the RAN and/or core network CN. The network node may also include processing circuitry 2103 (also referred to as a processor, e.g., corresponding to processing circuitry 4870) coupled to the transceiver circuitry, and memory circuitry 2105 (also referred to as memory, e.g., corresponding to device readable medium 4880 of FIG. 48) coupled to the processing circuitry. The memory circuitry 2105 may include computer readable program code that when executed by the processing circuitry 2103 causes the processing circuitry to perform operations according to embodiments disclosed herein. According to other embodiments, processing circuitry 2103 may be defined to include memory so that a separate memory circuitry is not required.

As discussed herein, operations of the VAE server 108 may be performed by processing circuitry 2103, network interface 2107, and/or transceiver 2101. For example, processing circuitry 2103 may control transceiver 2101 to transmit downlink communications through transceiver 2101 over a radio interface to one or more mobile terminals UEs and/or to receive uplink communications through transceiver 2101 from one or more mobile terminals UEs over a radio interface. Similarly, processing circuitry 2103 may control network interface 2107 to transmit communications through network interface 2107 to one or more other network nodes and/or to receive communications through network interface from one or more other network nodes. Moreover, modules may be stored in memory 2105, and these modules may provide instructions so that when instructions of a module are executed by processing circuitry 2103, processing circuitry 2103 performs respective operations (e.g., operations discussed below with respect to Example Embodiments relating to VAE server 108).

According to some other embodiments, a network node may be implemented as a core network CN node without a transceiver. In such embodiments, transmission to a VAE client 102 may be initiated by the network node so that transmission to the V2X UE 104 device is provided through a network node including a transceiver (e.g., through a base station or VAE serve r). According to embodiments where the network node is a VAE server including a transceiver, initiating transmission may include transmitting through the transceiver.

FIG. 22 is a block diagram illustrating elements of a V2X application specific server 110 of a communication network configured to provide cellular communication according to embodiments of inventive concepts. As shown, the V2X application specific server 110 may include network interface circuitry 2207 (also referred to as a network interface) configured to provide communications with other nodes of the core network and/or the radio access network RAN. The V2X application specific server 110 may also include a processing circuitry 2203 (also referred to as a processor) coupled to the network interface circuitry, and memory circuitry 2205 (also referred to as memory) coupled to the processing circuitry. The memory circuitry 2205 may include computer readable program code that when executed by the processing circuitry 2203 causes the processing circuitry to perform operations according to embodiments disclosed herein. According to other embodiments, processing circuitry 2203 may be defined to include memory so that a separate memory circuitry is not required.

As discussed herein, operations of the V2X application specific server 110 may be performed by processing circuitry 2203 and/or network interface circuitry 2207. For example, processing circuitry 2203 may control network interface circuitry 2207 to transmit communications through network interface circuitry 2207 to one or more other network nodes and/or to receive communications through network interface circuitry from one or more other network nodes. Moreover, modules may be stored in memory 2205, and these modules may provide instructions so that when instructions of a module are executed by processing circuitry 2203, processing circuitry 2203 performs respective operations (e.g., operations discussed below with respect to Example Embodiments relating to core network nodes).

Currently, there is not a standardized way for applications to configure and provide measurements to network functions in the mobile network. This aspect is missing when considering application level measurements, both at server and client side, and also when considering UE-level measurements (i.e., measurements from chipset/modem) that could be available at application level.

Various embodiments described herein provide mechanisms for configuring for configuring the delivery of UE/application measurements from the application layer towards the network to enable delivering UE/application measurements from the application layer towards the network by using 3GPP mechanisms (i.e., VAE layer). The mechanisms include mechanisms for the application layer to trigger a UE measurements configuration request towards the VAE layer, which then processes the request and provides a response which configures the application layer for UE application/measurements reporting.

Advantages that may be found using some embodiments of inventive concepts are a way of configuring measurements to be collected from application layer to relevant network functions. This avoids being bound to using application-specific or network-specific implementations and aids in the creation of a common framework for V2X players to provide measurements to network regardless of the operators in which they are connected.

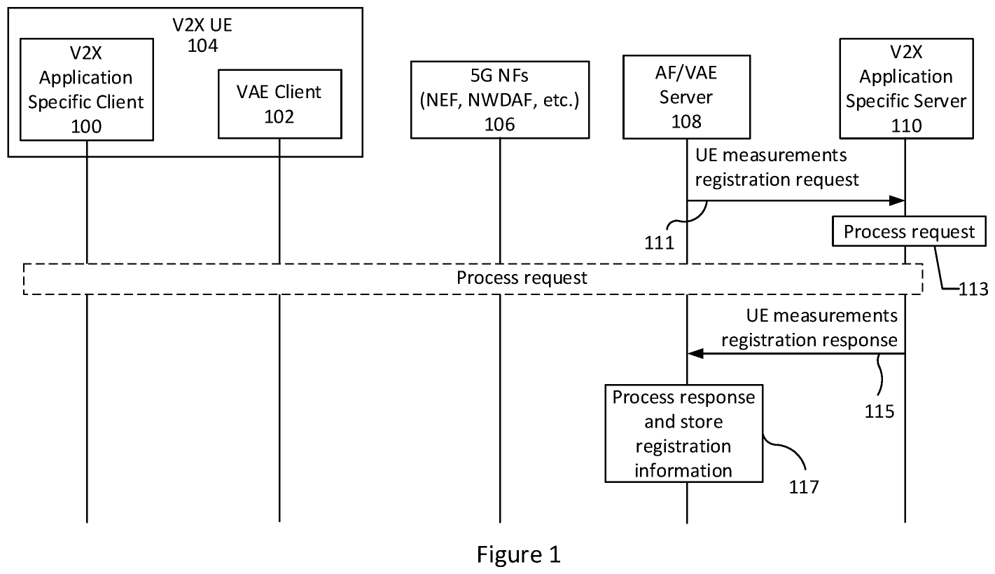

In the description that follows, the VAE framework as defined in TS 23.287 shall be used to describe various embodiments of inventive concepts. The VAE server 108 in FIGS. 1-11 may act as an application function (AF) towards the network functions 106 in the core network. If trusted, the VAE server 108 acting as an AF is configured with the information is authorized to exchange information with the network functions the VAE server 108 interacts with, e.g., NWDAF or policy control function (PCF). If the VAE server 108 acting as an AF is untrusted, the VAE server 108 acting as an AF is configured with the NEF information and is authorized to exchange information with the NEF, which then interacts with the relevant network functions, e.g., NWDAF and PCF. The VAE client 102 is configured with the VAE server information and is authorized to exchange information with the VAE server 108. The V2X application-specific server 110 is configured with the VAE server 108 information and is authorized to exchange information with the VAE server 108 and/or the VAE client 102 of a V2X UE 104. The V2X application-specific client 100 is configured with the VAE client information and is authorized to exchange information with the VAE client 102 and/or the VAE server 108. A V2X application-specific client 100 can be associated to different VAE clients 102. A V2X application-specific server 110 can be associated to different VAE servers 108.

The term “UE measurements” as used herein refer to (but not limited to) measurements available at application layer, which could be available either at server side of the application or at client side. Such measurements could be intended as measurements directly collected by the application layer, as well as measurements collected from the application layer from other layers of the protocol stack (e.g., facility layer, network layer), from modem/chipset, from entities such as operating system, etc.

Examples of specific UE measurement can be defined by (but not limited to) the following parameters:
KPI to be measured (latency, data rate, signal strength, etc.)
measurement side (e.g., server side, client side, end-to-end)
measurement layer (e.g., application layer, transport layer, L3 layer, L2 layer, PDCP (packet data convergence protocol) layer of 3GPP protocol)
measurement type (e.g., max value, min value, average value, Xth percentile, X-% confidence, range)
measurement window (e.g., generate measurements considering consecutive windows of X seconds each)
measurement frequency (e.g., one single report, periodic report every X seconds)

In some embodiments of inventive concepts, the VAE server 108 is enhanced to allow the VAE server 108 to gather UE measurements from a V2X application specific server 110.

VAE Server Registration to V2X Application-Specific Server for UE Measurements

The VAE server 108 is extended with functionality to allow the VAE server 108 to register to the V2X application-specific server 110 for receiving UE measurements.

Turning to FIG. 1, the VAE server 108 may run a procedure introduced herein for VAE server registration to V2X application-specific server for UE measurements, which allows the VAE server 108 to register to the V2X application-specific server for receiving UE measurements.

The VAE server 108 may register using an application program interface (API) V2X_Application_Specific_Server_Registration_UE_Measurements to register for reception of UE measurements from the V2X application-specific server 110.

The VAE server 108 uses the V2X_Application_Specific_Server_Registration_UE_Measurements API to send a UE measurements registration request to the V2X application-specific server 110 in operation 111. The request may include, but not be limited to, the following information:
V2X application-specific client ID (possibly implicit, e.g. the V2X application-specific client 100 instantiates a VAE client 102). If sets, the request indicates that the VAE Server 108 is interested in gathering UE measurements from the client side.
V2X application-specific server ID.
UE measurement. A list of UE measurements the VAE Server 108 is interested in. Potentially, each item of the list may include (but not be limited to) key performance indicator (KPI) to be measured, measurement side, measurement layer, measurement type, measurement window, measurement frequency.
V2X service ID. If included, it indicates the V2X service ID for which the UE measurements should refer to.
Application flow description (explicit or implicit): This information helps to identify, from a network perspective, the application specific traffic flow the UE measurement refers to. This can be useful if UE measurements are collected from network layer. This may be an SNI or a 5-Tuple.
GEO ID. The geographical area to which the VAE Server 108 registers to receive UE measurements (i.e., UE measurements should be provided if relevant to the indicated geographical area).
Time window(s). A time interval indicating that the VAE server 108 is registering to receive UE measurements only in the indicated time window(s).
Measurements Filter Information. This information includes possible information to filter UE measurements, for instance thresholds (e.g., UE measurements are provided only if above/below a certain threshold).

In operation 113, the V2X application-specific server 110 processes the request received from the VAE Server 108. The processing of the request might include for instance checking whether or not the UE measurements indicated in the request are supported by the V2X application-specific server 110.

If the request received from the VAE server 108 indicates that some UE measurements should be collected from client side, the V2X application-specific server 110 interacts with the relevant V2X application-specific client 100 to check whether such UE measurements can be provided by the V2X application-specific client 100.

In operation 115, the V2X application-specific server 110 uses the V2X_Application_Specific_Server_Registration_UE_Measurements API to send a UE measurements registration response to the VAE Server 108. The response may indicate whether or not the request is accepted. The response might also indicate that only some of the UE measurements included in the request are supported. The response might also include some changes to some of the parameters included in the request (e.g., the request was indicating that a certain UE measurement should be provided every 5 seconds, and the response indicates that such a UE measurement can be provided every 10 seconds).

In operation 117, the VAE server 108 processes the response sent by the V2X application-specific server 110. If needed, the VAE server 108 may store the relevant registration information associated to the UE measurements accepted by the V2X application-specific server 110.

V2X application-specific server providing UE measurements to VAE Server

In another embodiment of inventive concepts, the VAE server 108 is extended with functionality to allow the VAE server 108 to receive UE measurements by the V2X application-specific server 110.

UE Measurements from V2X Application-Specific Client

In further embodiments of inventive concepts, the VAE server 108 is extended with a functionality allowing the VAE server 108 to register to the VAE Client 102 for receiving UE measurements from the V2X application-specific client 100.

The VAE server 108 may use a procedure for VAE server registration to VAE client 102 for UE measurements from V2X application-specific client 100, allowing the VAE server 108 to register to the VAE Client 102 for receiving UE measurements from the V2X application-specific client 100. For this procedure, the following APIs are introduced:
The VAE server 108 is extended with the API
[symbol] [symbol] , used by the VAE server 108 to register to the VAE Client 102 for reception of UE measurements from V2X application-specific client 100.
The VAE Client is extended with the API [symbol] [symbol] [symbol] , used by the VAE client 102 to register for reception of UE measurements from V2X application-specific client 100.

V2X Application-Specific Server Providing UE Measurements to VAE Server

In another embodiment of inventive concepts, the VAE server 108 is extended with functionality to allow the VAE server 108 to receive UE measurements by the V2X application-specific server 110.

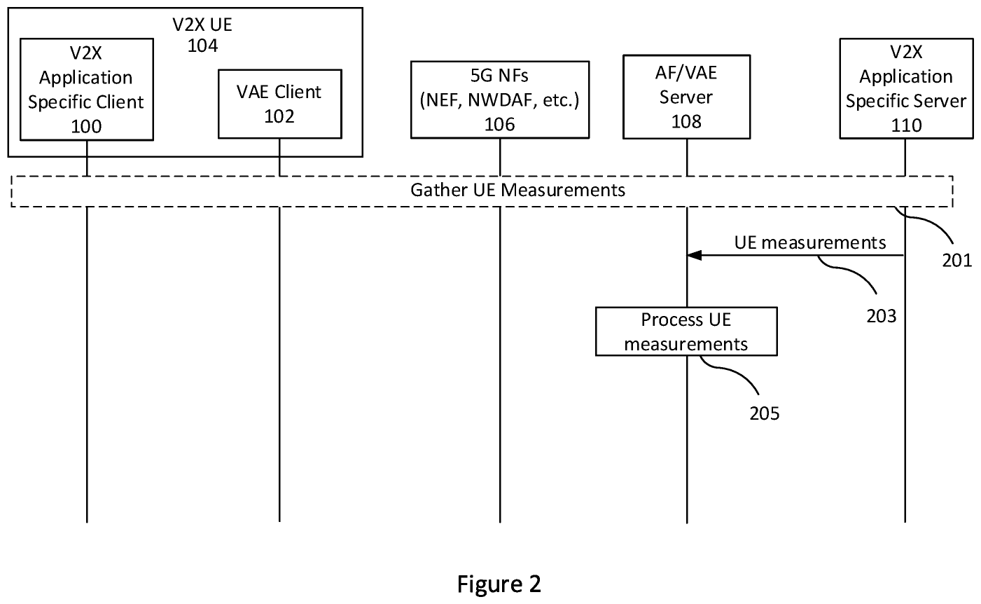

Turning to FIG. 2, the V2X application-specific server 110 may run a procedure introduced herein for the V2X application-specific server 110 providing UE measurements to the VAE server 108, allowing the V2X application-specific server 110 to provide the VAE server 108 with UE measurements.

The VAE server 108 is extended with the API V2X_Application_Specific_Server_UE_Measurements, used by the V2X application-specific server 110 to provide the VAE server 108 with UE measurements.

In operation 201, the V2X application-specific server 110 gathers the relevant UE measurements. If UE measurements should be gathered from the client side as well, this operation includes interaction between the V2X application-specific server 110 and the V2X application-specific client 100 for gathering such measurements.

In operation 203, the V2X application-specific server 110 may use the V2X_Application_Specific_Server_UE_Measurements API to send the UE measurements to the VAE server 108.

In operation 205, the VAE server 108 processes the UE measurements received from the V2X application-specific server. The processing might include, for instance, modification or translation of some part of the content of the UE measurements.

UE Measurements from V2X Application-Specific Client

In further embodiments of inventive concepts, the VAE server 108 is extended with a functionality allowing the VAE server 108 to register to the VAE Client 102 for receiving UE measurements from the V2X application-specific client 100.

The VAE server 108 may use a procedure for VAE server registration to VAE client 102 for UE measurements from V2X application-specific client 100, allowing the VAE server 108 to register to the VAE Client 102 for receiving UE measurements from the V2X application-specific client 100. For this procedure, the following APIs are introduced:
The VAE server 108 is extended with the API [symbol] [symbol] , used by the VAE server 108 to register to the VAE Client 102 for reception of UE measurements from V2X application-specific client 100.
The VAE Client is extended with the API [symbol] [symbol] [symbol] , used by the VAE client 102 to register for reception of UE measurements from V2X application-specific client 100.

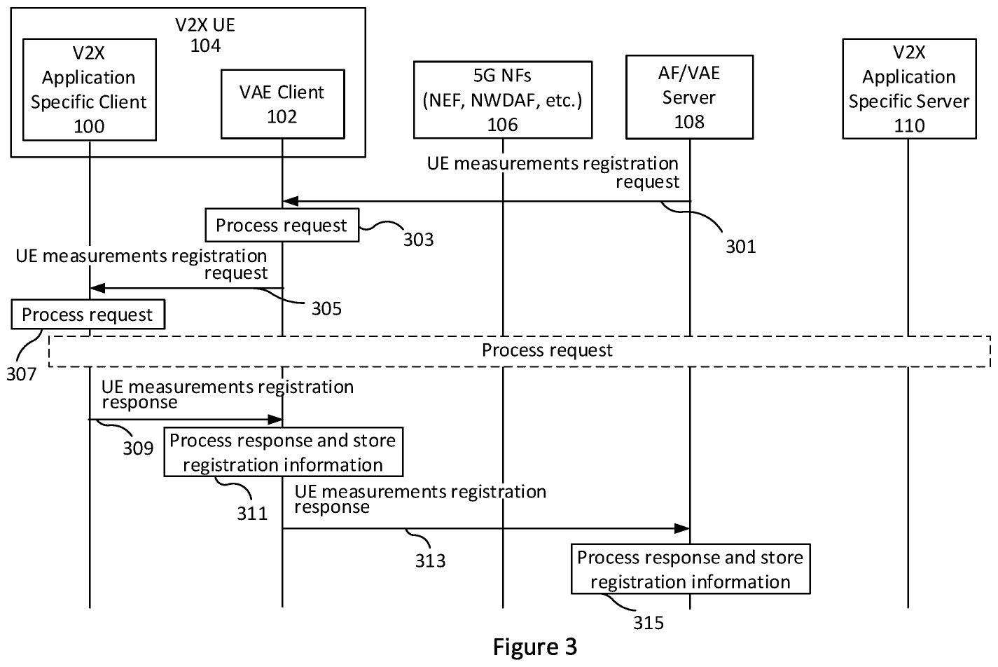

Turning to FIG. 3, a procedure for VAE server registration to the VAE client 102 for UE measurements from the V2X application-specific client 100 is illustrated.

In operation 301, the VAE server 108 uses the VAE_Client_Registration_UE_Measurements API to send a UE measurements registration request to the VAE client 102. The message may include, but not be limited to, the following information:
V2X application-specific client ID (possibly implicit, e.g. the V2X application-specific client 100 instantiates a VAE client 102).
V2X application-specific server ID. If set, the request indicates that the VAE server 108 is interested in gathering UE measurements from the server side.
UE measurement. A list of UE measurements the VAE server is interested in. Potentially, each item of the list includes (but not limited to) KPI to be measured, measurement side, measurement layer, measurement type, measurement window, measurement frequency.
V2X service ID. If included, it indicates the V2X service ID for which the UE measurements should refer to.
Application flow description (explicit or implicit): This information helps to identify, from a network perspective, the application specific traffic flow the UE measurement refers to. This is useful if UE measurements are collected from network layer. This may be an SNI or a 5-Tuple.
GEO ID. The geographical area to which the VAE server registers to receive UE measurements (i.e., UE measurements should be provided if relevant to the indicated geographical area).
Time windows. A time interval indicating that the VAE server registers to receive UE measurements only in the indicated time window.
Measurements Filter Information. This information includes possible information to filter UE measurements, for instance thresholds (e.g., UE measurements are provided only if above/below a certain threshold).

In operation 303, the VAE client 102 processes the request received from the VAE server 108. The processing might include for instance modification or translation of some part of the content of the request.

In operation 305, the VAE client 102 uses the V2X_Application_Specific_Client_Registration_UE_Measurements API to send a UE measurements registration request to the relevant V2X application-specific client 100.

In operation 307, the V2X application-specific client 100 processes the request received from the VAE client 102. The processing might include for instance checking if the UE measurements indicated in the request are supported by the V2X application-specific client 100.

If the request received from the VAE client 102 indicates that some UE measurements should be collected from server side, the V2X application-specific client 100 interacts with the relevant V2X application-specific server 110 to check whether such UE measurements can be provided by the V2X application-specific server 110.

In operation 309, the V2X application-specific client 100 uses the V2X_Application_Specific_Client_Registration_UE_Measurements API to send a UE measurements registration response to the VAE client 102, indicating whether the request is accepted or not. The response might also indicate that only some of the UE measurements included in the request are supported. The response might also include some changes to some of the parameters included in the request (e.g., the request was indicating that a certain UE measurement should be provided every 5 seconds, and the response indicates that such a UE measurement can be provided every 10 seconds).

In operation 311, the VA client 102 processes the response received by the V2X application-specific client 100. If needed, the VAE client 102 stores the relevant registration information associated to the UE measurements. The processing of the response might also include for instance modification or translation of some part of the content of the response before the UE measurements is sent to the VAE server 108.

In operation 313, the VAE client 102 uses the V2X_Application_Specific_Client_Registration_UE_Measurements API to send a UE measurements registration response to the VAE server 108.

In operation 315, the VAE server 108 processes the response received from the VAE client 102. If needed, the VAE server 108 stores the relevant registration information associated to the UE measurements.

V2X application-specific client 100 providing UE measurements to VAE server 108 via VAE client 102

In other embodiments of inventive concepts, the VAE server 108 is extended with a functionality allowing the VAE server 108 to receive UE measurements from the V2X application-specific client 100 via the VAE client 102.

The VAE server 108 may use a procedure for V2X application-specific client providing UE measurements to VAE server via VAE Client, allowing the VAE server 108 to receive UE measurements from the V2X application-specific client 100 via the VAE client 102. For this procedure, the following APIs are introduced:
The VAE server 108 is extended with the API VAE_Client_UE_Measurements, used by the VAE server 108 to receive UE measurements from the VAE client 102.
The VAE client 102 is extended with the API V2X_Application_Specific_Client_UE_Measurements, used by the VAE client 102 to receive UE measurements from the V2X application-specific client 100.

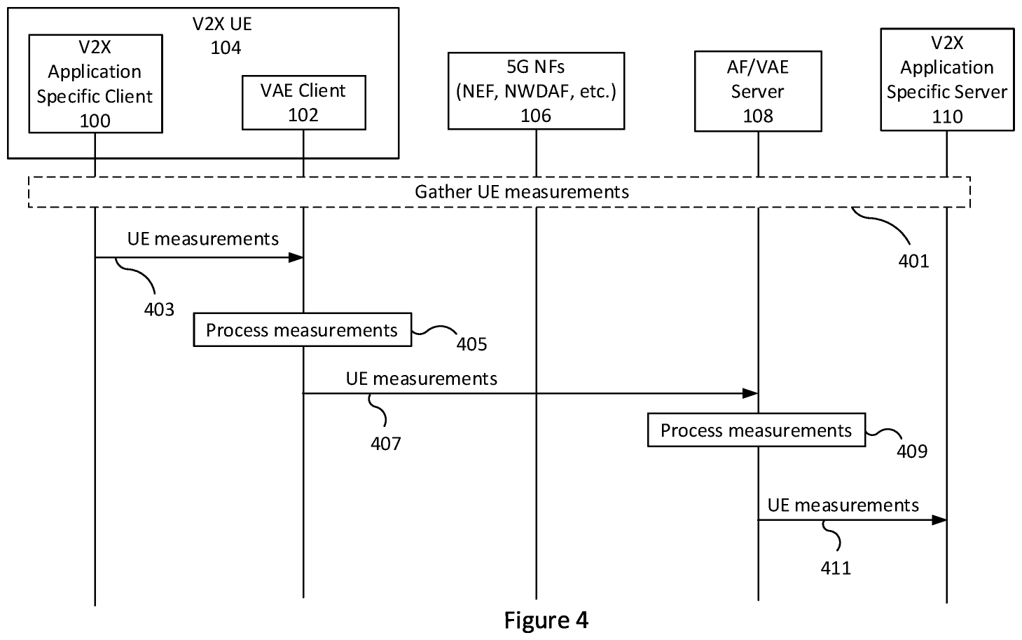

Turning to FIG. 4, a procedure for VAE server registration to the VAE client 102 for UE measurements from the V2X application-specific client 100 is illustrated.

In operation 401, the V2X application-specific client 100 gathers the relevant UE measurements. If UE measurements should be gathered from the server side as well, this operation includes interaction between the V2X application-specific client 100 and the V2X application-specific server 110 for gathering such measurements.

In operation 403, the V2X application-specific client 100 uses the V2X_Application_Specific_Client_UE_Measurements API to send the UE measurements to the VAE client 102.

In operation 405, the VAE client 102 processes the UE measurements received from the V2X application-specific client 100. The processing might include for instance modification or translation of some part of the content of the UE measurements.

In operation 407, the VAE client 102 uses the VAE_Client_UE_Measurements API to send the UE measurements to the VAE server 108.

In operation 409, the VAE server 108 processes the UE measurements received from the VAE client 102. The processing might include for instance modification or translation of some part of the content of the UE measurements. In some embodiments, the UE measurements are sent to the V2X application-specific server 110 in operation 411.

The procedures described in FIGS. 1 and 4 are based on the idea that the VAE server triggers the registration by sending a request to relevant receivers. This approach could involve some limitations, related to the fact that having a request triggered by a server-node (i.e., VAE server) might be not possible when considering HTTP-based implementations of the interface between the VAE server and the relevant receivers. This is of particular importance considering the procedure in FIG. 2, where considering an HTTP-based implementation of interaction between the VAE client 102 and V2X application specific client 104 with the VAE server 108 brings forth a challenge of having a VAE server 108 acting as client (from an HTPP point of view) towards the VAE client 102 and V2X application specific client 104.

Various embodiments of inventive concepts provide a procedure for configuring the delivery of UE/application measurements from application layer towards the network (i.e., VAE layer). The various embodiments provide a procedure where the application layer triggers a UE measurements configuration request towards the VAE layer, which then processes the request and provides a response which configures the application layer for UE application/measurements reporting. This provides one way to reduce or eliminate the implementation issues related to the registration procedure triggered by the VAE layer.

In the description that follows, the configuration of UE measurements between the application layer and the VAE layer shall be described, with focus on both request of the configuration and cancellation of the configuration. While the VAE layer, and in particular the VAE server, shall be used to explain the inventive concepts, the inventive concepts can be applied to a generic AF of a 5GS which interacts with the application layer.

As described above, examples of specific UE measurement can be defined by (but not limited to) the following parameters:
KPI to be measured (latency, data rate, signal strength, etc.)
measurement side (e.g., server side, client side, end-to-end)
measurement layer (e.g., application layer, transport layer, L3 layer, L2 layer, PDCP (packet data convergence protocol) layer of 3GPP protocol)
measurement type (e.g., max value, min value, average value, Xth percentile, X-% confidence, range)
measurement window (e.g., generate measurements considering consecutive windows of X seconds each)
measurement frequency (e.g., one single report, periodic report every X seconds)

Configuration of UE Measurements at V2X Application-Specific Server.

In various embodiments of inventive concepts, the VAE Server 108 is extended with a functionality to configure the reporting of UE measurements, where the V2X application-specific server 110 sends a request of UE measurement configuration to the VAE server 108, which processes such request and provides a response which configures the reporting of UE measurements. An additional functionality is introduced enabling the cancellation of previously configured UE measurements at the V2X application-specific server 110, where the cancellation that can be triggered either by the VAE Server 108 or the V2X application-specific server 110.

The capabilities of VAE framework are extended by adding the following enhancements related to this embodiment:

The API V2X_Application_Specific_Server_UE_Measurements_Configuration is introduced at the VAE server 108 to support UE measurements configuration with the V2X application specific server 110.

A procedure for UE measurements configuration at the V2X application-specific server 110 is introduced, allowing the V2X application specific server 110 to send a request of UE measurement configuration to the VAE server 108.

A procedure for UE measurements configuration cancellation at the V2X application-specific server 110 triggered by the VAE server 108 is introduced, allowing the VAE server 108 to trigger the cancellation of a previous UE measurements configuration at the V2X application-specific server 110.

A procedure for UE measurements configuration cancellation at the V2X application-specific server 110 triggered by the V2X application-specific server 110 is introduced, allowing the V2X application-specific server 110 to trigger the cancellation of a previous UE measurements configuration towards the VAE server 108.

Procedure for UE Measurements Configuration at V2X Application-Specific Server

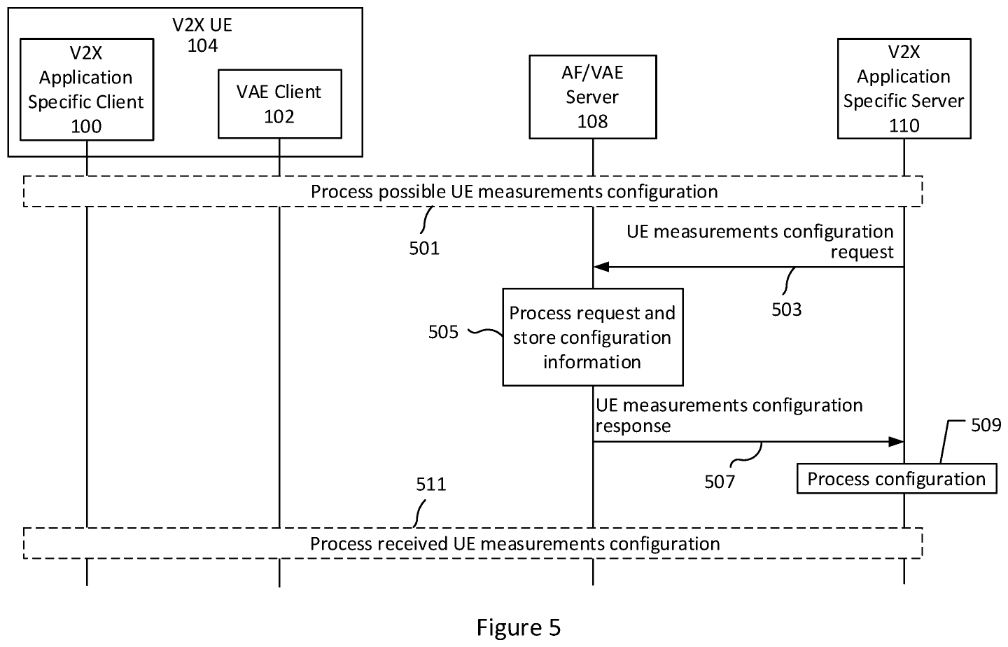

A procedure for UE measurements configuration at V2X application-specific server is illustrated in FIG. 5. The procedure is described below.

As a pre-condition, the V2X application-specific server 110 when discovering and registering to a VAE server 108, is made aware of the availability of UE measurements configuration at the VAE server 108. Further information can be obtained in addition to availability of UE measurements configuration at the VAE server 108. For example, availability of UE measurements at VAE server can be associated with the information that UE measurements configuration can be requested if the V2X application-specific server 108 is interested in receiving particular quality of service (QoS) notifications, e.g., QoS Sustainability Analytics or Extended QoS Notifications from a NG-RAN. Another example is that UE measurements configuration can be requested only in certain geographical areas and/or time windows. A further example is that UE measurements configuration can be requested only if associated to certain active or planned to be active applications/services.

In operation 501, the V2X application-specific server 110 interacts with the relevant V2X application-specific client 102 to e.g. gather information on supported UE measurements (e.g., available KPIs) or UE measurements configuration (e.g., supported measurement layers, measurement type). Within this interaction, the V2X application-specific server 108 and client 102 also exchange information of availability of UE measurements configuration at the VAE server 108 and associated information.

In operation 503, the V2X application-specific server 110 uses the V2X_Application_Specific_Server_UE_Measurements_Configuration API to send a UE measurements configuration request to the VAE server. This message is triggered, e.g., by considering the awareness of the support of UE measurements configuration by the VAE server 108 or by any other associated configuration. For instance, if the V2X application-specific server 110 wants to receive a certain QoS notification to which it is associated the support of UE measurements from the VAE server 108, or if in a certain geographical location, time windows, or if certain applications/services are active, etc. This message includes, but not limited to, the following information:
V2X application-specific server ID.
V2X application-specific client ID(s). If set, this indicates that the UE measurements are associated to the listed client(s).
UE measurement. A list of UE measurements the V2X application-specific server could provide. Potentially, each item of the list includes (but not limited to) KPI that could be measured, measurement side, measurement layer, measurement type, measurement window, measurement frequency.
V2X service ID(s). If included, it indicates the V2X service ID(s) for which the UE measurements could be available.
Application flow description (explicit or implicit): This information helps to identify, from a network perspective, the application specific traffic flow the UE measurement refers to.

In operation 505, the VAE server 108 processes the request received from the V2X application-specific server 110. The processing might include checking whether the request can be accepted, i.e., the VAE server 108 checks whether the reception of UE measurements is supported and whether UE measurements can be used at the VAE server 108. The processing might include, for a certain V2X service or for a certain application, checking which UE measurements should be provided and their associated geographical areas, time windows, measurement frequency, measurement filter information, etc. If the request is accepted, the processing includes also storing the associated configuration information of UE measurements from the V2X application-specific server.

The VAE server in operation 507 uses the V2X_Application_Specific_Server_UE_Measurements_Configuration API to send a UE measurements configuration response to the V2X application-specific server. This message includes, but not limited to, the following information:
V2X application-specific client ID. If sets, the response indicates that the VAE Server is interested in gathering UE measurements from the listed client(s).
UE measurement. A list of UE measurements the VAE Server is interested in, i.e., an indication of which UE measurements among those provided in the request the VAE server is interested in receiving. Potentially, each item of the list includes (but not limited to) KPI to be measured, measurement side, measurement layer, measurement type, measurement window, measurement frequency. In case of changes compared to the request, a new value of is included in the response (e.g., an updated measurement frequency).
V2X service ID(s). If included, it indicates that the VAE server is interested in receiving UE measurements referring to listed V2X service ID(s).
Application flow description (explicit or implicit). If included, it indicates that the VAE server is interested in receiving UE measurements referring to listed applications.
GEO ID. The geographical area to which the VAE Server registers to receive UE measurements (i.e., UE measurements should be provided if relevant to the indicated geographical area).
Time windows. A time interval indicating that the VAE server registers to receive UE measurements only in the indicated time window.
Measurements Filter Information. This field includes possible information to filter UE measurements, for instance thresholds (e.g., UE measurements are provided only if above/below a certain threshold).

Note that this message can be also used by the VAE server 108 for updating a previously provided UE measurements configuration, e.g., for changing list of UE measurements, measurement frequency, geographical areas, time windows, etc.

In operation 509, the V2X application-specific server 110 processes the response received from the VAE Server 108. The processing might include for instance checking if there is any update in the value of the parameters associated to UE measurements which were indicated in the request. The processing might include configuring the UE measurement reporting according to information included in the response such as GEO ID, time windows, measurement filter information. The response is used by the application to configure the subsequent reporting (e.g., what to report, when to trigger the report) of UE measurements.

If some UE measurements should be collected from client side, the V2X application-specific server 110 interacts with the relevant V2X application-specific client 102 in operation 311 to provide the UE measurement configuration included in the response.

Procedure for Cancellation of UE Measurements Configuration at V2X Application-Specific Server Triggered by VAE Server

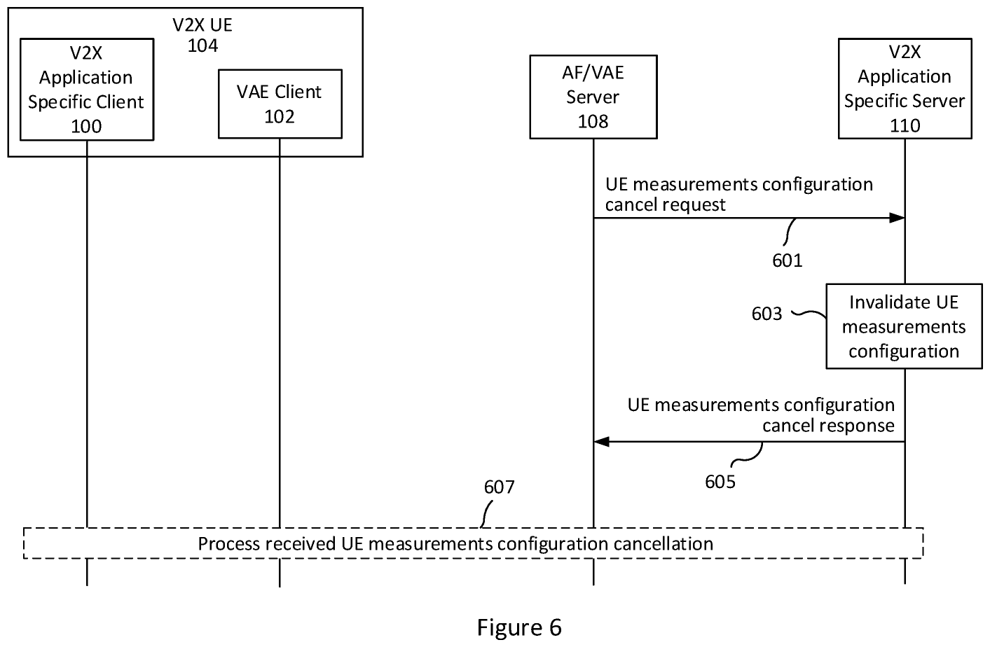

A procedure for cancellation of UE measurements configuration at the V2X application-specific server 110 triggered by the VAE server 108 is illustrated in FIG. 6. The procedure is described below.

The VAE Server 108 triggers the cancellation of previously configured UE measurements. The trigger can depend on several factors, including but not limited to VAE Server load, VAE Server stopping tasks to which UE measurements were associated, etc. In operation 601, the VAE server 108 uses the V2X_Application_Specific_Server_UE_Measurements_Configuration API to send a UE measurements configuration cancel request to the V2X application-specific server 110. This message includes, but not limited to, the following information:
V2X application-specific client ID(s). If set, this indicates that the UE measurements associated to the listed client(s) are requested to be invalidated.
V2X service ID(s). If included, it indicates that UE measurements associated to listed V2X service ID(s) are requested to be invalidated.

Note that in some embodiments, a UE measurements configuration cancel request from a VAE Server 108 to a V2X application-specific server 110 without any additional information should be considered as a request to invalidate all previously configured UE measurements associated to the intended V2X application-specific server 110.

In operation 603, the V2X application-specific server 110 invalidates the UE measurements as indicated in the request from the VAE Server. Any ongoing UE measurements reporting from the V2X application-specific server 110 to the VAE server 108 which matches the cancellation request is suspended.

In operation 605, the V2X application-specific server 110 uses the V2X_Application_Specific_Server_UE_Measurements_Configuration API to send a UE measurements configuration cancel response to the VAE Server 108.

If relevant, the V2X application-specific server 110 in operation 607 interacts with the relevant V2X application-specific client 100 to invalidate previously configured UE measurements which match the cancellation request.

Procedure for Cancellation of UE Measurements Configuration at V2X Application-Specific Server Triggered by V2X Application-Specific Server

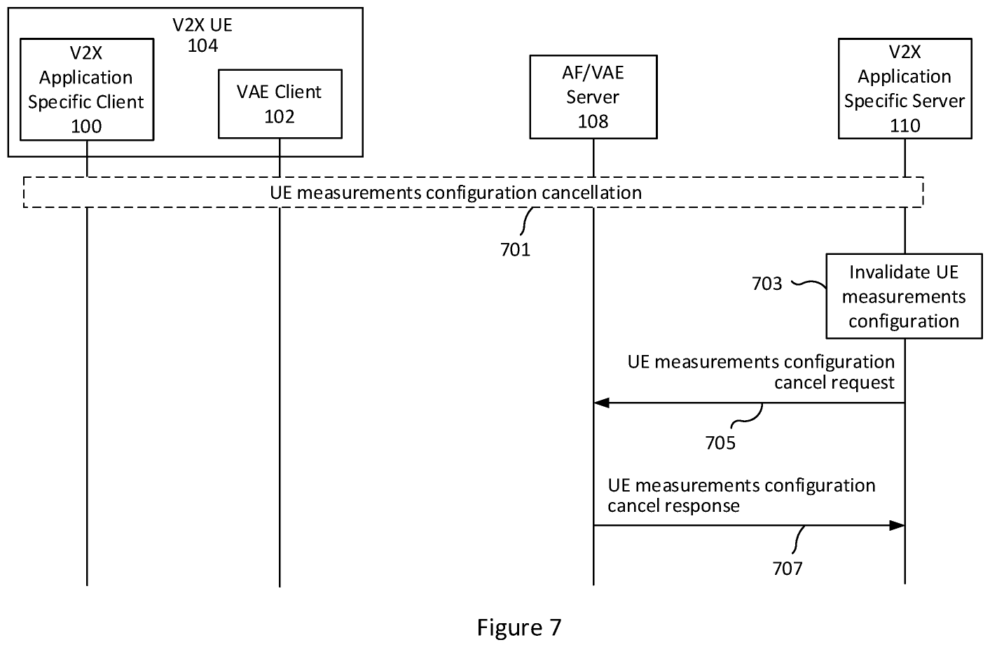

A procedure for cancellation of UE measurements configuration at the V2X application-specific server 110 triggered by the V2X application-specific server 110 is depicted in FIG. 7. The procedure is described below

If relevant, in operation 701, the V2X application-specific server 110 interacts with the relevant V2X application-specific client 100 to gather information to eventually trigger the cancellation of UE measurements configuration, and eventually to invalidate UE measurements configuration at the V2X application-specific client 100.

The V2X application-specific server 110 triggers the cancellation of previously configured UE measurements. The trigger can depend on several factors, including but not limited to the V2X application-specific server 110 stopping the traffic to which UE measurements were associated to, etc. The V2X application-specific server 110 invalidates the UE measurements in operation 703. Any ongoing UE measurements reporting from the V2X application-specific server to VAE Server which matches the cancellation is suspended.

In operation 705, the V2X application-specific server 110 uses the V2X_Application_Specific_Server_UE_Measurements_Configuration API to send a UE measurements configuration cancel request to the VAE server 108. This message includes, but not limited to, the following information:
V2X application-specific client ID(s). If set, this indicates that the UE measurements associated to the listed client(s) are requested to be invalidated.
V2X service ID(s). If included, it indicates that UE measurements associated to listed V2X service ID(s) are requested to be invalidated.

Note that a UE measurements configuration cancel request from a V2X application-specific server 110 to a VAE server 108 without any additional information should be considered as a request to invalidate all previously configured UE measurements associated to the intended V2X application-specific server 110.

In operation 707, the VAE server 108 uses the V2X_Application_Specific_Server_UE_Measurements_Configuration API to send a UE measurements configuration cancel response to the V2X application-specific server 110, to acknowledge the cancellation of UE measurement configuration.

Procedure for UE Measurements Configuration at V2X Application-Specific Client

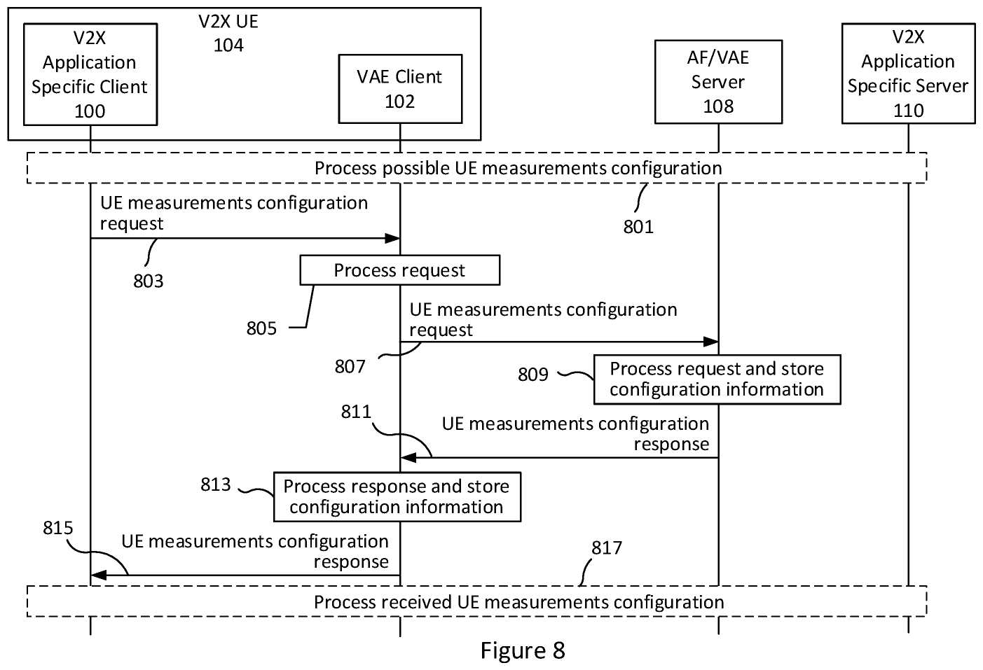

The procedure for UE measurements configuration at a V2X application-specific client 100 is depicted in FIG. 8. The procedure is described below.

The V2X application-specific server 110 interacts with the relevant V2X application-specific client 100 in operation 801 to e.g. gather information on supported UE measurements (e.g., available KPIs) or UE measurements configuration (e.g., supported measurement layers, measurement type). Regarding the awareness of UE measurements configuration by the V2X application-specific client 100 and its associated additional information (e.g., UE measurements configuration can be requested if the V2X application-specific client 100 is interested in receiving particular QoS notifications—e.g., QoS Sustainability Analytics or Extended QoS Notifications from NG-RAN—or if UE measurements configuration is related to specific geographical areas, time windows, applications, services, etc.), two options can be considered. In a first option, the interaction between V2X application-specific server 110 and V2X application-specific client 110 is also used to exchange information of availability of UE measurements configuration at the VAE server 108 and its associated additional information. In a second option, information of availability of UE measurements configuration at VAE server and its associated additional information are made available at the V2X application-specific client 100 by the VAE client 102 during the registration and discovery phases of associated VAE server 108.

In operation 803, the V2X application-specific client 100 uses the V2X_Application_Specific_Client_UE_Measurements_Configuration API to send a UE measurements configuration request to the VAE client 102. This request is triggered, e.g., by considering the awareness of the support of UE measurements configuration by the VAE server 108 or by any other associated configuration. For instance, the V2X application-specific client 100 or the V2X application-specific server 110 may want to receive a certain QoS notification to which it is associated the support of UE measurements from the VAE server 108. This request includes, but not limited to, the following information:
V2X application-specific server ID. If set, this indicates the V2X application-specific server the client is associated to.
V2X application-specific client ID(s).
UE measurement. A list of UE measurements the V2X application-specific server could provide. Potentially, each item of the list includes (but not limited to) KPI that could be measured, measurement side, measurement layer, measurement type, measurement window, measurement frequency.
V2X service ID(s). If included, it indicates the V2X service ID(s) for which the UE measurements could be available.
Application flow description (explicit or implicit): This information helps to identify, from a network perspective, the application specific traffic flow the UE measurement refers to.

The VAE client 102 processes the request received from the V2X application-specific client 100 in operation 805. The processing might include checking the relevant VAE layer to send the request to. The processing might include checking whether the request can be accepted, i.e., the VAE client 102 checks whether the reception of UE measurements is supported by the VAE server 108 it is associated to. The processing might include an update or translation of some of the parameters included in the request.

The VAE client 102 sends a UE measurements configuration request to the VAE server 108 in operation 807.

In operation 809, the VAE server 108 processes the request received from the VAE client 102. The processing might include checking whether the request can be accepted, i.e., the VAE server 108 checks whether the reception of UE measurements is supported and whether UE measurements can be used at the VAE server 108. The processing might include, for a certain V2X service or for a certain application, checking which UE measurements should be provided and their associated geographical areas, time windows, measurement frequency, measurement filter information, etc. If the request is accepted, the processing includes also storing the associated configuration information of UE measurements.

In operation 811, the VAE server 108 sends a UE measurements configuration response to the VAE client 102. This message includes, but not limited to, the following information:
V2X application-specific client ID(s). If sets, the response indicates that the VAE Server is interested in gathering UE measurements from the listed client(s).
UE measurement. A list of UE measurements the VAE Server is interested in, i.e., an indication of which UE measurements among those provided in the request the VAE server is interested in receiving. Potentially, each item of the list includes (but not limited to) KPI to be measured, measurement side, measurement layer, measurement type, measurement window, measurement frequency. In case of changes compared to the request, a new value of is included in the response (e.g., an updated measurement frequency).
V2X service ID(s). If included, it indicates that the VAE server is interested in receiving UE measurements referring to listed V2X service ID(s).
Application flow description (explicit or implicit). If included, it indicates that the VAE server is interested in receiving UE measurements referring to listed applications.
GEO ID. The geographical area to which the VAE Server registers to receive UE measurements (i.e., UE measurements should be provided if relevant to the indicated geographical area).
Time windows. A time interval indicating that the VAE server registers to receive UE measurements only in the indicated time window.
Measurements Filter Information. This field includes possible information to filter UE measurements, for instance thresholds (e.g., UE measurements are provided only if above/below a certain threshold).

Note that this response message can be also used by the VAE server 108 for updating a previously provided UE measurements configuration, e.g., for changing list of UE measurements, measurement frequency, geographical areas, time windows, etc.

The VAE client in operation 813 processes the response received from the VAE server. If the request is positive, the processing includes also storing the associated configuration information of UE measurements. The processing might include an update or translation of some of the parameters included in the response.

In operation 815, the VAE client 102 uses the V2X_Application_Specific_Client_UE_Measurements_Configuration API to send a UE measurements configuration response to the V2X application specific client 100.

The V2X application-specific client in operation 817 processes the response received from the VAE client 102. The processing might include for instance checking if there is any update in the value of the parameters associated to UE measurements which were indicated in the request. The processing might include configuring the UE measurement reporting according to information included in the response such as GEO ID, time windows, measurement filter information. The response is used by the application to configure the subsequent reporting (e.g., what to report, when to trigger the report) of UE measurements.

If relevant, the V2X application-specific client 100 interacts with the relevant V2X application-specific server 110 to provide the UE measurement configuration included in the response.

Procedure for Cancellation of UE Measurements Configuration at V2X Application-Specific Client Triggered by VAE Server

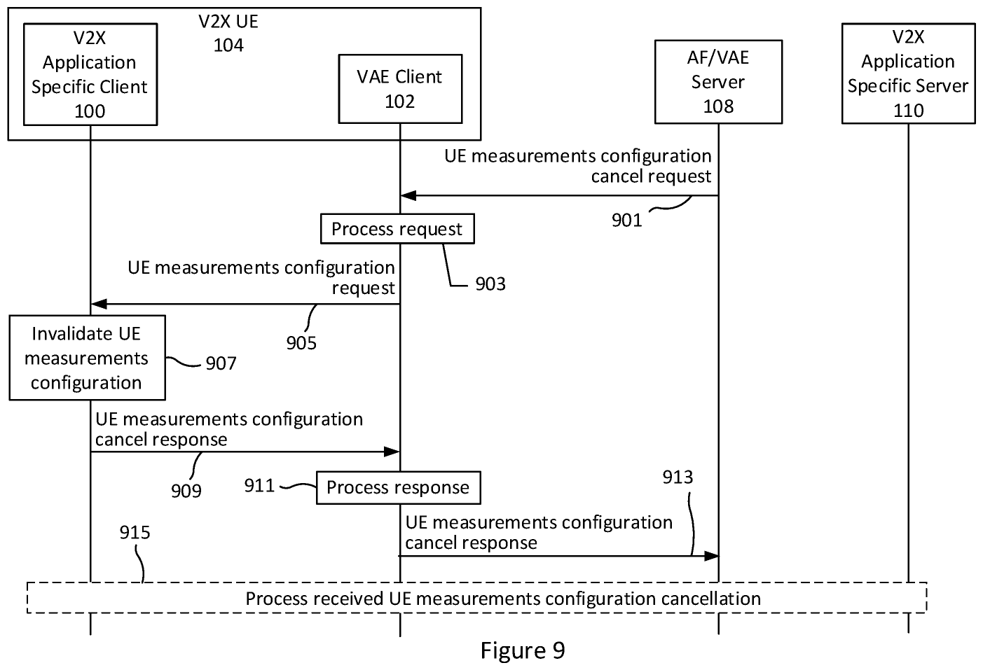

A procedure for cancellation of UE measurements configuration at V2X application-specific client triggered by VAE server is depicted in FIG. 9. The procedure is described below.

The VAE Server 108 triggers the cancellation of previously configured UE measurements. The trigger can depend on several factors, including but not limited to VAE Server load, VAE Server stopping tasks to which UE measurements were associated, etc. The VAE server 108 in operation 901 sends a UE measurements configuration cancel request to the VAE client 102. This message includes, but not limited to, the following information:
V2X application-specific client ID(s). If set, this indicates that the UE measurements associated to the listed client(s) are requested to be invalidated.
V2X service ID(s). If included, it indicates that UE measurements associated to listed V2X service ID(s) are requested to be invalidated.

Note that the UE measurements configuration cancel request from a VAE Server 108 to a VAE client 12 without any additional information should be considered as a request to invalidate all previously configured UE measurements associated to the VAE client 102.

In operation 903, the VAE client 102 processes the request received from the VAE server 108. The processing might include an update or translation of some of the parameters included in the request, as well as checking to which V2X application specific client(s) the request should be sent.

In operation 905, the VAE client 102 uses the V2X_Application_Specific_Client_UE_Measurements_Configuration API to send a UE measurements configuration cancel request to the relevant V2X application specific client(s) 100.

The V2X application-specific client 100 in operation 907 invalidates the UE measurements as indicated in the request from the VAE client 102. Any ongoing UE measurements reporting from the V2X application-specific client 100 to the VAE client 102 which matches the cancellation request is suspended.

In operation 909, the V2X application-specific client 100 uses the V2X_Application_Specific_Client_UE_Measurements_Configuration API to send a UE measurements configuration cancel response to the VAE Client 102.

The VAE client 102 in operation 911 processes the response received from the V2X application-specific client 100. The processing might include an update or translation of some of the parameters included in the response.

In operation 913, the VAE client 102 sends a UE measurements configuration cancel response to the VAE Server 108.

If relevant, the V2X application-specific client 100 in operation 915 interacts with the relevant V2X application-specific server 110 to invalidate previously configured UE measurements which match the cancellation request.

Procedure for Cancellation of UE Measurements Configuration

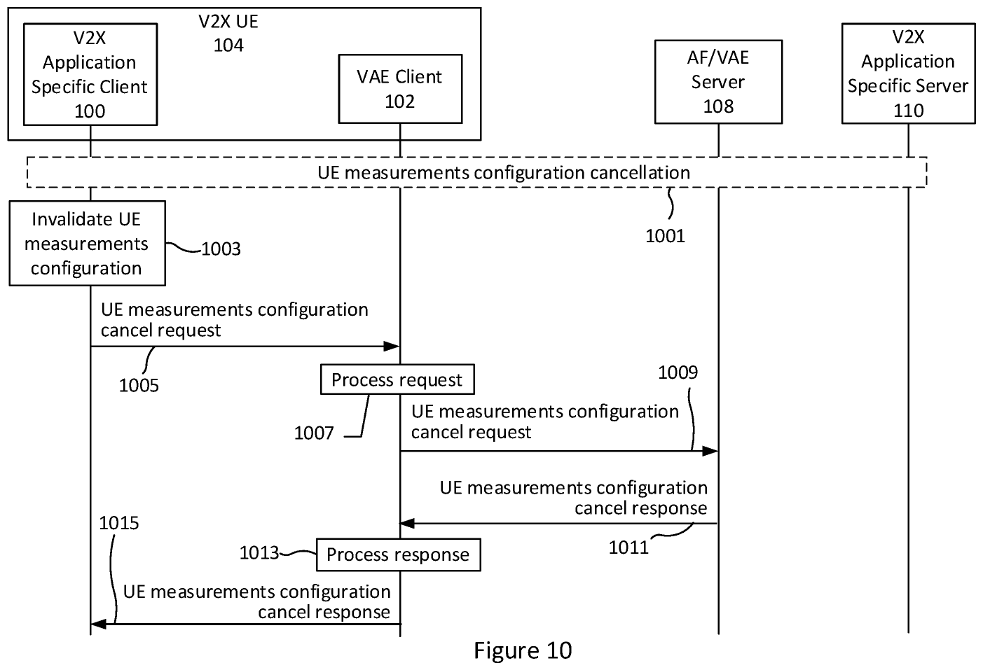

A procedure for cancellation of UE measurements configuration at V2X application-specific client triggered by V2X application-specific client is depicted in FIG. 10. The procedure is described below.

If relevant, in operation 1001, the V2X application-specific client 100 interacts with the relevant V2X application-specific server 110 to gather information to eventually trigger the cancellation of UE measurements configuration, and eventually to invalidate UE measurements configuration at the V2X application-specific server 108.

The V2X application-specific client 100 triggers the cancellation of previously configured UE measurements. The trigger can depend on several factors, including but not limited to the V2X application-specific client 100 stopping the traffic to which UE measurements were associated to, etc. The V2X application-specific client 100 invalidates the UE measurements in operation 1003. Any ongoing UE measurements reporting from the V2X application-specific client 100 to the VAE server 108 which matches the cancellation is suspended.

In operation 1005, the V2X application specific client 100 uses the V2X_Application_Specific_Client_UE_Measurements_Configuration API to send a UE measurements configuration cancel request to the VAE client 102. This request includes, but not limited to, the following information:
V2X application-specific client ID(s). If set, this indicates that the UE measurements associated to the listed client(s) are requested to be invalidated.
V2X service ID(s). If included, it indicates that UE measurements associated to listed V2X service ID(s) are requested to be invalidated.

Note that a UE measurements configuration cancel request from a V2X application specific client 100 to a VAE client 102 without any additional information should be considered as a request to invalidate all previously configured UE measurements associated to the V2X application specific client 100.

In operation 1007, the VAE client 102 processes the request received from the V2X application-specific client 100. The processing might include an update or translation of some of the parameters included in the request, as well as checking to which VAE server (s) 108 the request should be sent to.

In operation 1009, the VAE client 120 uses the V2X_Application_Specific_Client_UE_Measurements_Configuration API to send a UE measurements configuration cancel request to the VAE server 108.

The VAE server 108 in operation 1011 uses the V2X_Application_Specific_Client_UE_Measurements_Configuration API to send a UE measurements configuration cancel response to the VAE client 102, to acknowledge the cancellation of UE measurement configuration.

In operation 1013, the VAE client 102 processes the response received from the VAE server 108. The processing might include an update or translation of some of the parameters included in the response.

The VAE client 102 in operation 1015 uses the V2X_Application_Specific_Client_UE_Measurements_Configuration API to send a UE measurements configuration cancel response to the V2X application specific client 100.

In other various embodiments of inventive concepts, mechanisms are introduced to allow VAE server 108 to exploit the UE measurements received by the application layer.

VAE Server 108 Processing UE Measurements for Notifications to V2X Applications

The VAE server is extended in some embodiments of inventive concepts with a functionality allowing the VAE server 108 to process the information contained in the received UE measurements, where this processing might include joint utilization of UE measurements and other network information for generating notifications towards the V2X application layer.

The capabilities of VAE framework may be extended by adding the functionality at the VAE server 108 allowing the VAE server 108 to take as input a network or notification together with UE measurements, and to modify such network information or notification before this being delivered to a V2X application where such modification considers the collected UE measurements.

To enable the added functionality, the VAE server 108 may have already subscribed to receive network information/notification from network functions 106. The V2X application layer may have already subscribed to the VAE layer to receive network information/notifications. An example of a network notification is a notification on potential QoS change (or notification on QoS Sustainability Analytics) as defined in TS 23.287. Another example of a network notification is a notification on QoS Change based on Extended NG-RAN notification.

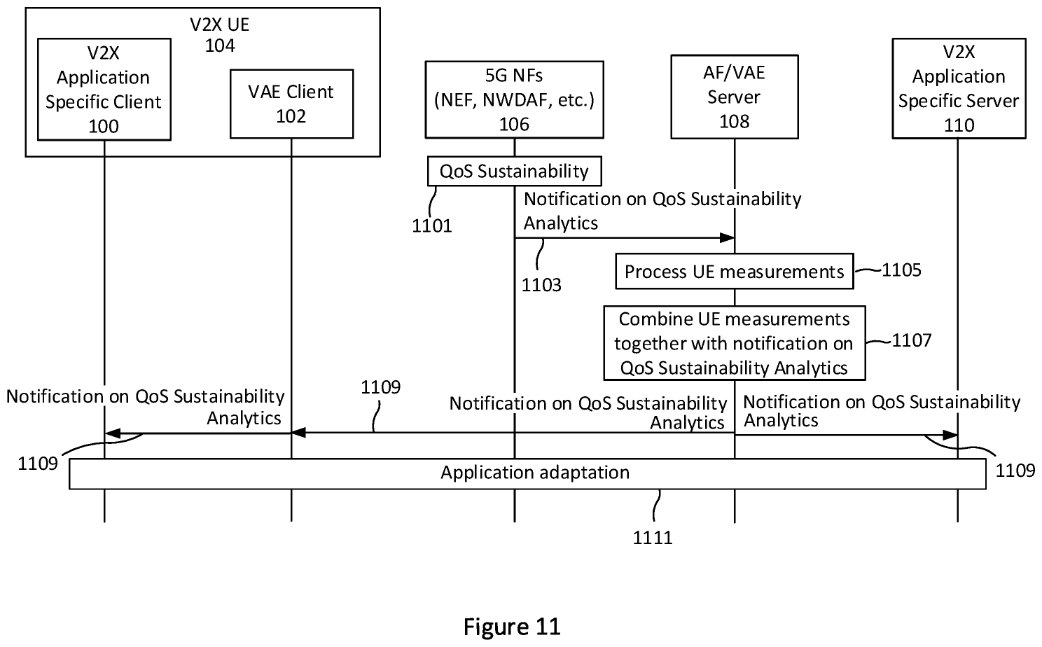

Turning to FIG. 11, in operation 1101, the NWDAF 106 generates a notification on QoS Sustainability Analytics, and this notification is provided to the VAE server 108 which acts as an AF towards the NWDAF (either directly or via the NEF).

In operation 1103, the VAE server 108 receives the UE measurements as described above with respect to FIGS. 3 and 4.

Upon reception of a notification on QoS Sustainability Analytics from the NWDAF/NEF 106, the VAE server 108 in some embodiments doesn't provide the notification directly to the V2X application-specific server 110 or to the VAE client 102. Instead, in operation 1105, the VAE server 108 performs an additional processing of the notification combining such notification with the available UE measurements. For instance, consider the case when the notification provides information such as “if UE latency is <30 ms, predicted data rate is 30 Mbps; if UE latency is >30 ms, predicted data rate is 10 Mbps”. Consider that the VAE has UE measurements information saying that UE latency is 20 ms. With this embodiment, the VAE server 108 in operation 1107 processes jointly the notification on QoS Sustainability Analytics and the UE measurements, in this particular example generating a new notification indicating that “predicted data rate is 30 Mbps” (because UE measurements indicate that UE latency is <30 ms). This step allows the VAE server 108 to provide more accurate notification towards the application layer.

Once the VAE server 108 has generated the new notification based on the UE measurements, the notification can be delivered to relevant consumers in operation 509 (e.g., V2X application-specific server 110 or V2X application-specific client 100 via VAE client 102). In operation 1111, application adaptation based on the received notification generated from the VAE server 108 may take place.

VAE Client 102 Processing UE Measurements for Notifications to V2X Applications

In some embodiments of inventive concepts, the VAE client 102 is extended with a functionality allowing the VAE client 102 to process the information contained in the received UE measurements, where this processing might include joint utilization of UE measurements and other network information for generating notifications towards V2X application layer

The capabilities are extended by adding the functionality at the VAE client 102 allowing the VAE client 102 to take as input a network or notification together with UE measurements, and to modify such network information or notification before this being delivered to V2X application where such modification considers the collected UE measurements.

To enable the added functionality, the VAE server 108 may have already subscribed to receive network information/notification from network functions 106. the VAE client 102 may have already subscribed to receive network information/notification from the VAE server 108. The V2X application layer may have already subscribed to VAE layer to receive network information/notifications. An example of network notification is a notification on potential QoS change (or notification on QoS Sustainability Analytics) as defined in TS 23.287.

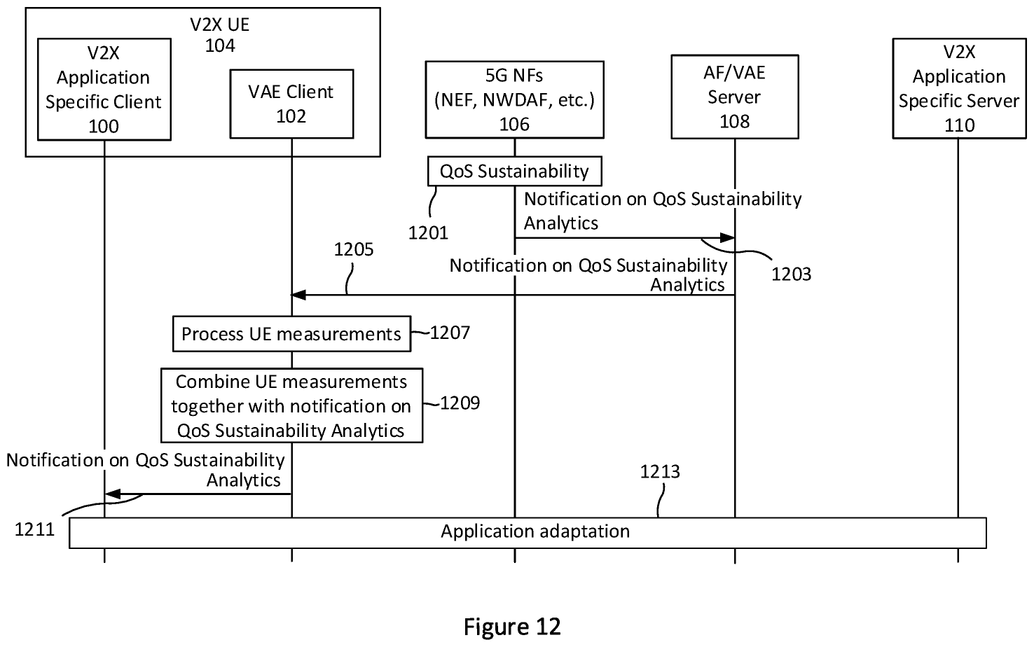

Turning to FIG. 12, in operation 1201, the NWDAF 106 generates a notification on QoS Sustainability Analytics, and in operation 1203, this notification is provided to the VAE server 108 which acts as an AF towards the NWDAF 106 (either directly or via the NEF).

The VAE server 108 provides the VAE client with the notification on QoS Sustainability Analytics in operation 1205.

The VAE client 102 receives the UE measurements as described above.

Upon reception of a notification on QoS Sustainability Analytics from the VAE server 108, the VAE client in some embodiments doesn't provide the notification directly to the V2X application-specific client 100. Instead, the VAE client 102 performs an additional processing of the notification in operation 1207 combining such notification with the available UE measurements in operation 1209. For example, consider the case when the notification provides information such as “if UE latency is <30 ms, predicted data rate is 30 Mbps; if UE latency is >30 ms, predicted data rate is 10 Mbps”. Consider that the VAE client 102 has UE measurements information saying that UE latency is 20 ms. With this embodiment, the VAE client processes jointly the notification on QoS Sustainability Analytics and the UE measurements, in this particular example generating a new notification indicating that “predicted data rate is 30 Mbps” (because UE measurements indicate that UE latency is <30 ms). This step allows the VAE Client to provide more accurate notification towards application layer.

Once the VAE client 102 has generated the new notification based on the UE measurements, the notification can be delivered to relevant consumers in operation 1211 (e.g., V2X application-specific client 100). Finally, application adaptation based on the received notification generated from VAE client 102 can take place in operation 1213.

A potential benefit of this approach illustrated in FIG. 12 is if cases where the network information/notification should be delivered to V2X application-specific client 100, it may be more convenient that UE measurements are not provided to VAE server 108 but rather processed directly at the VAE client 102 together with the network information/notification received from the VAE server 108.

Updating Parameters of Network Procedures with UE Measurements

In yet other embodiments of inventive concepts, the VAE server 108 is extended with a functionality allowing the VAE server 108 to update parameters of network procedures by adding as the information contained in the received UE measurements

The capabilities are extended by adding the functionality at the VAE server 108 allowing the VAE server 108 to take as input UE measurements, and to modify the parameters of network procedures considering these UE measurements.

To enable the added functionality, the VAE server 108 is able to interact with network functions for establishing certain procedures. As an example of network notification, we can consider the procedure for notification on potential QoS change (or notification on QoS Sustainability Analytics) as defined in TS 23.287. Note that, for the procedure for notification on QoS Sustainability Analytics, as for instance considered in TS 23.288, the VAE server provides the following information to NWDAF/NEF:
Analytics ID=“QoS Sustainability”
Analytics Filter Information
Optional maximum number of results
QoS requirements
5QI (standardized or pre-configured 5G QoS Identifier), and applicable additional QoS parameters and the corresponding values (conditional, i.e. it is needed for guaranteed bit rate GBR 5QIs to know the GFBR (guaranteed flow bit rate)); or the QoS Characteristics attributes PDB (packet delay budget), PER (packet error rate) and their values;
Location information
Analytics target period
S-NSSAI (optional) (single-network slice selection assistance information)
Reporting Threshold(s)

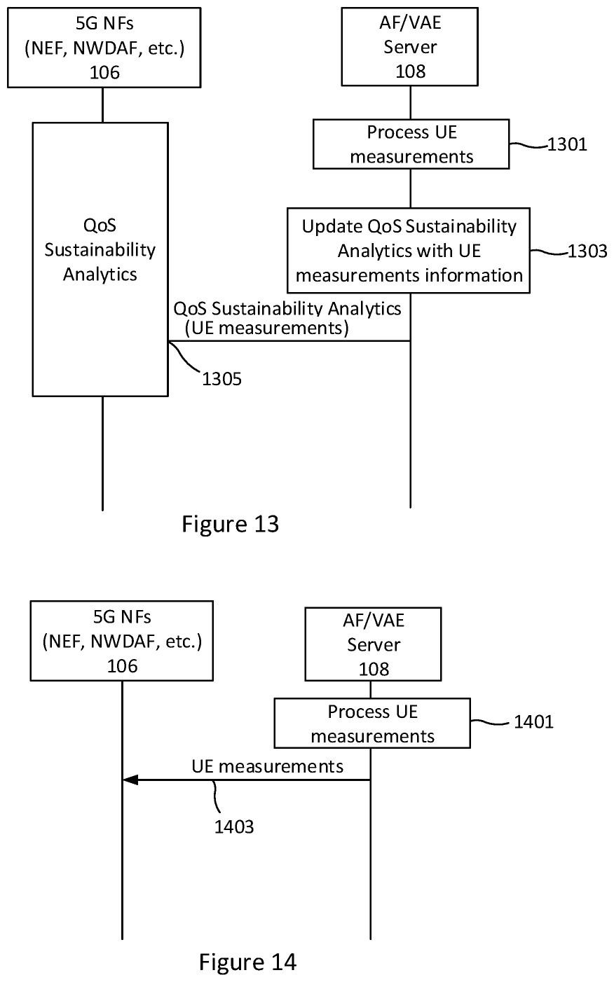

Turning to FIG. 13, the VAE server 108 receives the UE measurements as described above. In operation 1301, the VAE server 108 processes the UE measurements. With this embodiment, the VAE server 108 creates a field UE measurements which is used to extend the parameters included in the information exchange with NWDAF/NEF of the procedure for notification on QoS Sustainability Analytics. If relevant, the VAE server could also add further information, such as (but not limited to):
UE ID. Identification of UE(s) the measurements refer to.
V2X service ID. If included, it indicates the V2X service ID for which the UE measurements should refer to.
Application flow description (explicit or implicit): This information helps to identify, from a network perspective, the application specific traffic flow the UE measurement refers to. This is useful if UE measurements are collected from network layer. This may be an SNI or a 5-Tuple.
GEO ID. The geographical area to which the UE measurements information refer to.
Time windows. The time interval to which the UE measurements information refer

The field UE measurements can be attached to the information the procedure for notification on QoS Sustainability Analytics in the subscription phase as well as while the procedure is ongoing. Indeed, while the procedure QoS Sustainability Analytics, the VAE server 108 might receive new UE measurements from application layer, and in this case the VAE server 108 in operation 1303 provides an update of such information to NWDAF by performing in operation 1305 a procedure for notification on QoS Sustainability Analytics where the field UE measurements is updated according to newly received measurements from application layer.

The VAE server 108 can also add the field UE measurements to other messages exchanged with other network functions.

Providing UE Measurements to Relevant Network Functions

In further embodiments of inventive concepts, the VAE server 108 is extended with a functionality allowing the VAE server 108 to provide UE measurements plus any other information related to UE measurements to relevant network functions 106.

The capabilities are extended by adding the functionality at the VAE server 108 allowing the VAE server 108 to provide UE measurements to relevant network functions 106.

The VAE server 108 which acts as an AF is able to interact with network functions. Examples of network functions the VAE server may interact with are:
NEF, by using N33 reference point.
NWDAF, by using Nnwdaf service-based interface.
PCF, by using N5 reference point.

Turning to FIG. 14, the VAE server 108 receives the UE measurements as described above. In operation 1401, the VAE server 108 processes the UE measurements. With this embodiment, the processing could include further elaboration of received UE measurements. Examples of elaboration are extrapolating of CDF, average values, confidence values from received measurements. Another example is combining UE measurements from several UEs. A further example is to use the received UE measurements to generate additional information (e.g., take as inputs data rate and latency to generate a new measurement “QoS fulfillment” which is an output generated from the two inputs).

The VAE server 108 interacts with relevant network functions 106 to provide UE measurements information in operation 1403. When providing such information, the VAE server might include the following (but not limited to):
UE ID. Identification of UE(s) the measurements refer to.
V2X service ID. If included, it indicates the V2X service ID for which the UE measurements should refer to.
Application flow description (explicit or implicit): This information helps to identify, from a network perspective, the application specific traffic flow the UE measurement refers to. This is useful if UE measurements are collected from network layer. This may be an SNI or a 5-Tuple.
UE measurement. A list of UE measurements. Potentially, each item of the list includes (but not limited to) KPI to be measured, measurement side, measurement layer, measurement type, measurement window, measurement frequency.
GEO ID. The geographical area to which the UE measurements information refer to.
Time windows. The time interval to which the UE measurements information refer to.

The network functions which receive the UE measurements then can use such information for their own internal functionalities. Note that, in some embodiments, the VAE server 108 provides the information on UE measurements not as an additional field of an existing procedure, but as a separate information.

An example of utilization is the procedure for notification on QoS Sustainability Analytics as defined in TS 23.288. In this case, the NWDAF 106 can received UE measurements from the VAE server 108 and take into consideration these measurements for the process of generating QoS Sustainability Analytics.

The VAE server 108 can provide UE measurements also to other network functions. For instance, the VAE server can provide UE measurements to NEF, which then provides UE measurements to other additional network functions.

Procedure for Subscribing to Receive UE Measurements

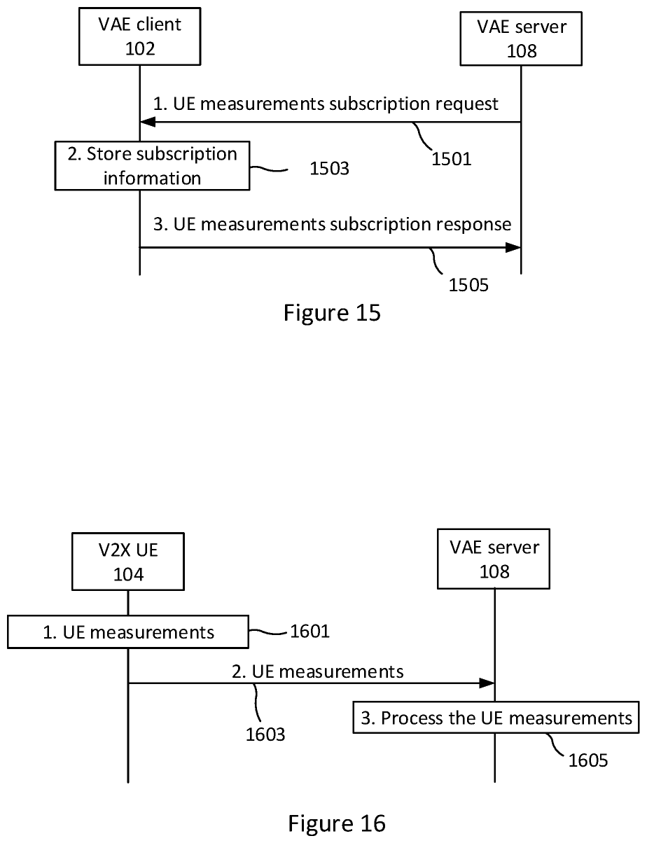

FIG. 15 illustrates the procedure where the VAE server 108 subscribes to receive UE measurements from the V2X UE in various embodiments of inventive concepts. FIG. 15 shows VAE client 102, but it should be considered that VAE server 108 is connected to the V2X UE 104 via the VAE client 102.

In operation 1501, the VAE server 108 sends a UE measurements subscription request to the V2X UE via the VAE client 102.

The V2X UE checks for the authorization of the VAE server to access the UE measurements and if allowed, stores the subscription information corresponding to the VAE server 108 in operation 1503.

The V2X UE sends a UE measurements subscription response to the VAE server 108 via VAE client 102 in operation 1505 including the result of the subscription (i.e. success or failure).

Procedure for Providing UE Measurements to VAE Server 108

FIG. 16 illustrates a procedure in some embodiments of inventive concepts where the V2X UE 104 sends UE measurements to the VAE server 108.

A pre-condition for the V2X UE to send measurements in that the VAE server 108 has subscribed for receiving UE measurements from the V2X UE 104.

The V2X UE 104 can also be considered as VAE client 102, i.e., V2X UE 104 provides UE measurements to VAE server 108 via VAE client 102.

Turning to FIG. 16, in operation 1601, the V2X UE 104 collects UE measurements from ongoing V2X communication services (e.g. latency, data rate, signal strength).

In operation 1603, the V2X UE 104 provides UE measurements to the VAE server 108.

In operation 1605, the VAE server 108 processes and stores the received UE measurements.

Procedure for UE Measurements Configuration

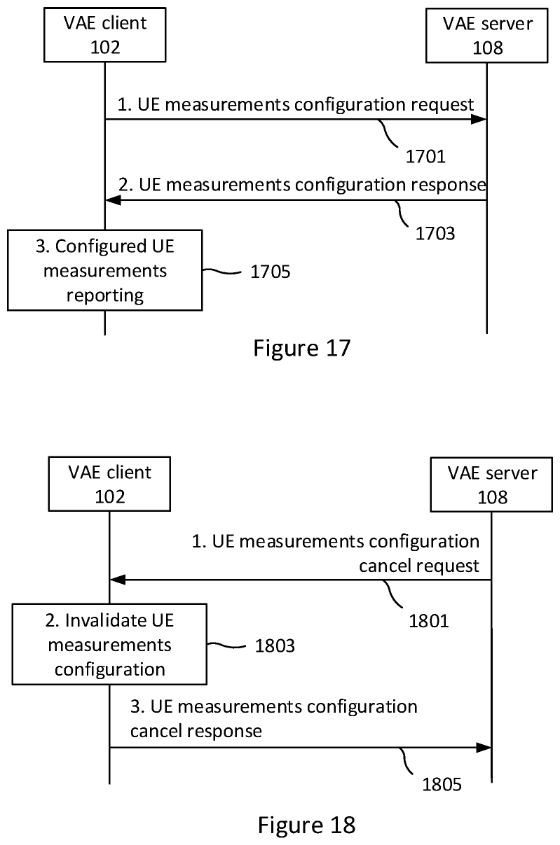

FIG. 17 illustrates the procedure where the VAE client 102 triggers a request of UE measurements configuration to the VAE server 108, which processes the request and provides a response of UE measurements configuration to VAE server.

FIG. 17 shows VAE client 102, but it should be considered that VAE server 108 is connected to the V2X UE 104 via the VAE client 102.

Pre-conditions: 1. The VAE server 108 is connected to the V2X UE 104 and is authorized to access the UE measurements. 2. The V2X UE 104 is aware that the UE measurements configuration is available at the VAE server 108, together with additional information regarding the triggering of UE measurement configuration.

In operation 1701, the VAE client 102 sends a UE measurements configuration request to the VAE server 108. The request includes an indication of which UE measurements the VAE client 102 supports.

NOTE: The trigger of UE measurements configuration request by the V2X UE 104 can depend on several factors, which can also be related to information available at V2X UE 104 regarding the support of UE measurements configuration at VAE server 108. Examples include: V2X UE 104 entering a certain geographical area, V2X UE 104 being in a certain time window, V2X UE 104 activating certain applications or services, V2X UE 104 requesting to receive QoS notifications from VAE server 108 for which the report of UE measurements is supported.

Editor's Note: Authorization (including user consent) of V2X UE measurements is FFS and in the purview of SA3

In operation 1703 the VAE server 108 sends a UE measurements configuration response to the VAE client 102. The response includes the result of the request (i.e. success or failure) as well as:
An indication of which UE measurements the VAE server 108 is interested to receive among those included in the request.
An indication of the conditions for triggering reporting (e.g., reporting triggered when the V2X UE 104 is in a certain area, reporting triggered during a certain time window, reporting triggered when the value of a certain UE measurement crosses an associated threshold).
An indication of how the measurement reporting should be performed (one-time reporting, periodic reporting, etc.)

In operation 1705, the VAE client 102 processes the received response and stores the UE measurement configuration indicated in the response. The received response configures the subsequent UE measurement reporting (triggering, etc.).

Procedure for UE Measurements Configuration Cancellation

In this procedure, the VAE server sends a UE measurements configuration cancellation which triggers an invalidation of previously configured UE measurement reporting.

Pre-conditions: 1. The VAE client 102 has already received a UE measurement configuration from the VAE server 108. 2. The VAE server 108 has registered for receiving ULE measurements from the V2X UE 104.

Turning to FIG. 18, in block 1801, the VAE server 108 sends a UE measurements configuration cancel request to the VAE client 102 to stop receiving UE measurements

In operation 1803, the VAE client 102 invalidates the UE measurements configuration and no longer reports UE measurements to the VAE server 108.

In operation 1805, the VAE client 102 sends the UE measurements configuration cancel response to the VAE server 108.

Various embodiments of the above described embodiments allow the application layer to send a UE measurement configuration request to the VAE layer, which then provides a response which configures the reporting of UE measurements from the application layer. Some embodiments of the procedures described follow the legacy approach for client-server interaction, where it is the client-side of the interaction which contacts the server-side. Various embodiments of the inventive concepts also provide the possibility to invalidate previously configured UE measurements reporting, either triggered by the VAE server or by the application layer.

Procedure for Monitoring and Control of QoS for eV2X Communications

In other embodiments of inventive concepts, the VAE server 108 includes an Application Function (AF) functionality, as defined in 3GPP TS 23.287. The VAE server 108 initially subscribes to the V2X application-specific server 110 and SEAL (service enable architecture layer for verticals) servers to receive V2X service-related information (e.g. UE IDs, location, group, configuration info etc.).

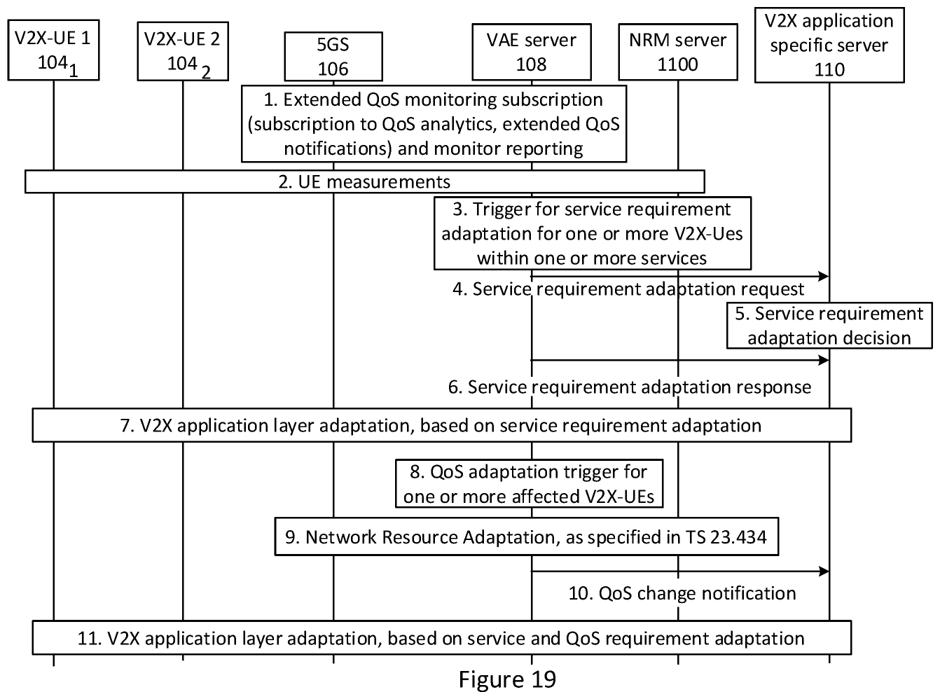

Turning to FIG. 19, in operation 1, the VAE server 108, which acts as an AF, subscribes to QoS monitoring service from 5GS 106 (e.g. PCF/NWDAF). This subscription may be active for a certain period of time or for a given geographical area. The monitoring may either include the request for QoS sustainability events as specified in 3GPP TS 23.288, or can include a QoS change notification requests as provided by SMF (session management function) and specified in 3GPP TS 23.287. The reporting may be configured by the application enabler layer for a given area, time, periodicity etc. taking into account the service requirement and other parameters (e.g. expected congestion in certain area, time of the day, road conditions). Based on the subscription, as specified in 3GPP TS 23.287, 5GS 106 provides the extended QoS monitoring report, over N33 interface. This report may come either from NWDAF or SMF via PCF/NEF.

In operation 2, the VAE server 108 subscribes to UE measurements from the V2X UEs (e.g. latency, data rate, signal strength). In operation 3, the VAE server 108, based on the monitoring events for one or multiple V2X-UEs within one service or across multiple services and/or UE measurement reports, may trigger a service requirement adaptation based on the actual or expected QoS change for one or more V2X services.

In operation 4, the VAE server 108 sends a service requirement adaptation request to a V2X application-specific server 110 to identify the action which is needed, based on the actual or expected QoS change. This could be the adaptation of the Level of Automation (LoA) for one or more V2X-UEs or V2X services.

In operations 5 and 6, the V2X application-specific server 110 decides whether to adapt the service requirement based on operation 3, and sends a response to the VAE server 108 with a positive or negative acknowledgment. Optionally, this may include the list of a sub-set of V2X-UEs within a service for which the requirement change should be applied.

In operation 7, if no QoS adaptation is required, the V2X application layer may adapt based on the adapted service requirements; and operations 7-10 are optional. In operation 8, if a QoS adaptation is required, the VAE server 108 triggers the adaptation of QoS for the affected V2X-UE(s) within the service or across multiple services in close vicinity.

In operation 9, the VAE server 108 performs network resource adaptation by interacting with the NRM server 1100 as specified in the 3GPP TS 23.434.

In operation 10, the VAE server 108 also notifies about the QoS adaptation to the V2X application-specific server 110. In operation 11, the V2X application layer adapts based on the adapted service and QoS requirements.

Various embodiments of the above described embodiments allow the application layer to provide network functions with UE measurements collected at application layer, either at the server side or the client side. The VAE layer is used to gather these measurements from the application layer. The mechanisms described above in the various embodiments allow the VAE layer to register to the application layer for receiving measurements, and mechanisms for the application layer to provide these measurements to the VAE layer. The VAE layer may exploit the measurements from the application layer in several ways, either by directly using these measurements at the VAE layer or by providing these measurements to relevant network functions.

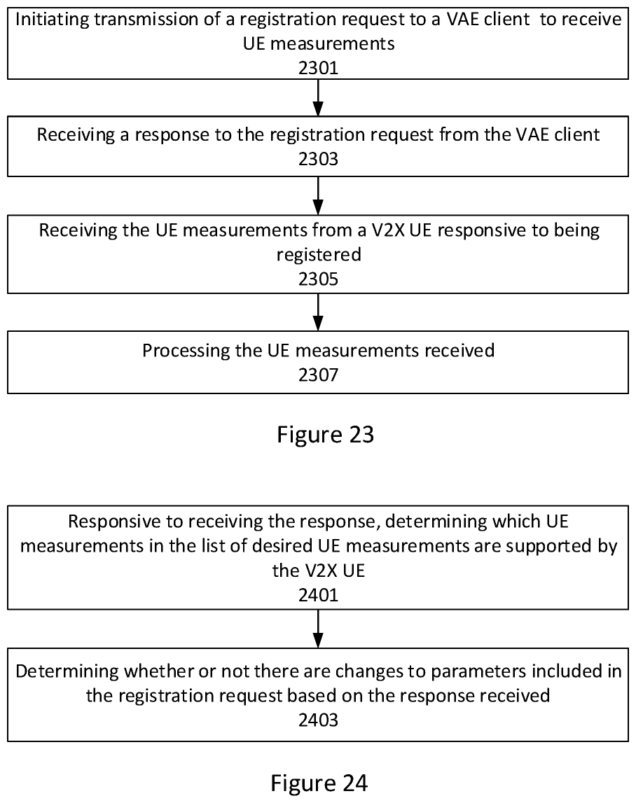

Operations of the VAE server 108 (implemented using the structure of the block diagram of FIG. 21) will now be discussed with reference to the flow chart of FIG. 23 according to some embodiments of inventive concepts. For example, modules may be stored in memory 2105 of FIG. 21, and these modules may provide instructions so that when the instructions of a module are executed by respective wireless device processing circuitry 2103, processing circuitry 2103 performs respective operations of the flow chart.

Turning to FIG. 23, in block 2301, the processing circuitry 2103 may initiate transmission of a registration request to VAE client 102 to receive UE measurements. The registration request may include one or more of a list of desired UE measurements the VAE server 108 is interested in receiving, one or more V2X application-specific client identifiers, one or more V2X application-specific server IDs, a V2X service ID, an application flow description, a GEO ID, one or more time windows, and measurements filter information. Details of the information included are described above.

The list of desired UE measurements may be one or more of: a timing interval of receiving the measurements, a key performance indicator, KPI, to be measured, a measurement side (e.g., client-side or server-side), a measurement layer, a measurement type, and a measurement window.

In block 2303, the processing circuitry 2103 may receive a response to the registration request from the VAE client 102. The processing circuitry 2103 may perform operations based on receiving the response to the registration request. For example, turning to FIG. 24, in block 2401, the processing circuitry 2103 may, responsive to receiving the response, determine which UE measurements in the list of desired UE measurements are supported by the V2X UE. In block 2403, the processing circuitry 2103 may determine whether or not there are changes to parameters included in the registration request based on the response received. For example, as described above, if a request indicated that a certain UE measurement should be provided every 5 seconds, the change in the response may indicate that the UE measurement can be provided every 10 seconds instead of every 5 seconds.

Returning to FIG. 23, in block 2305, the processing circuitry 2103 may receive the UE measurements from a V2X UE 104 responsive to be registered. The V2X UE 104 may be a VAE client 102.

In block 2307, the processing circuitry 2103 may process the UE measurements received. The processing of the UE measurements may include initiating transmission of the UE measurements to at least one recipient. The processing of the UE measurements may also include storing the UE measurements. In one embodiment, processing the UE measurements includes providing the UE measurements as part of information provided to a network function in a wireless network providing a notification of a monitored condition. For example, the processing circuitry 2103 may provide the UE measurements to one of the 5G network functions 106. In other embodiments, the processing circuitry 2103 may provide the UE measurements to at least one network function 106.

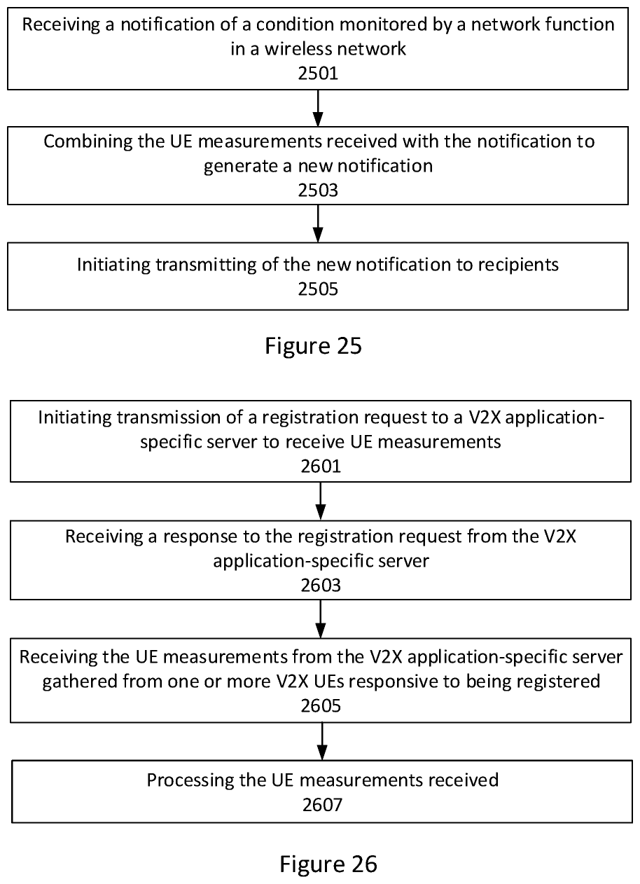

Turning to FIG. 25, in one embodiment of inventive concepts, the processing circuitry 2103 may, in block 2501 receive a notification of a condition monitored by a network function, such as one of the network functions 106, in a wireless network. In block 2503, the processing circuitry 2103 may combine the UE measurements received with the notification to generate a new notification. The combining of the UE measurements may include attaching the UE measurements to the notification to generate the new notification. In block 2505, the processing circuitry 2103 may initiate transmitting of the new notification to recipients.

Various operations from the flow chart of FIG. 23 may be optional with respect to some embodiments of VAE servers and related methods. Regarding methods of example embodiment 1 (set forth below), for example, operations of blocks 2307 of FIG. 23 may be optional.

Operations of the VAE server 108 (implemented using the structure of the block diagram of FIG. 21) will now be discussed with reference to the flow chart of FIG. 26 according to some other embodiments of inventive concepts.

Turning to FIG. 26, in block 2601, the processing circuitry 2103 may initiate transmission of a registration request to a V2X application-specific server 110 to receive UE measurements. The registration request may include one or more of a list of desired UE measurements the VAE server 108 is interested in receiving, one or more V2X application-specific client identifiers, one or more V2X application-specific server IDs, a V2X service ID, an application flow description, a GEO ID, one or more time windows, and measurements filter information. Details of the information included are described above.

The list of desired UE measurements may be one or more of: a timing interval of receiving the measurements, a key performance indicator, KPI, to be measured, a measurement side (e.g., client-side or server-side), a measurement layer, a measurement type, and a measurement window.

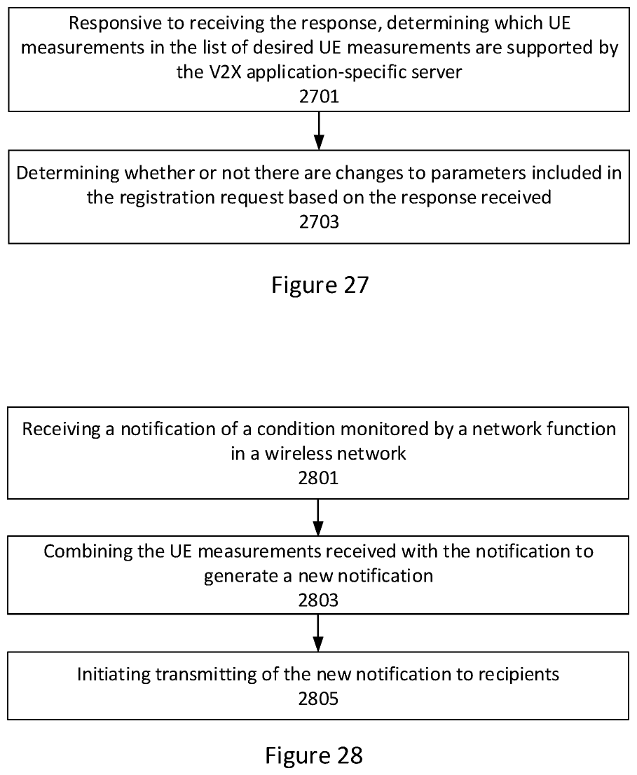

In block 2603, the processing circuitry 2103 may receive a response to the registration request from the V2X application-specific server 110. The processing circuitry 2103 may perform operations based on receiving the response to the registration request. For example, turning to FIG. 27, in block 2701, the processing circuitry 2103 may, responsive to receiving the response, determine which UE measurements in the list of desired UE measurements are supported by the V2X application-specific server 110. In block 2703, the processing circuitry 2103 may determine whether or not there are changes to parameters included in the registration request based on the response received. For example, as described above, if a request indicated that a certain UE measurement should be provided every 5 seconds, the change in the response may indicate that the UE measurement can be provided every 10 seconds instead of every 5 seconds.

Returning to FIG. 26, in block 2605, the processing circuitry 2103 may receive the UE measurements from the V2X application-specific server 110 gathered from one or more V2X UEs responsive to be registered. The one or more V2X UEs may be one or more V2X application-specific clients 100.

In block 2607, the processing circuitry 2103 may process the UE measurements received. The processing of the UE measurements may include initiating transmission of the UE measurements to at least one recipient. The processing of the UE measurements may also include storing the UE measurements. In one embodiment, processing the UE measurements includes providing the UE measurements as part of information provided to a network function in a wireless network providing a notification of a monitored condition. For example, the processing circuitry 2103 may provide the UE measurements to one of the 5G network functions 106. In other embodiments, the processing circuitry 2103 may provide the UE measurements to at least one network function 106.

Turning to FIG. 28, in one embodiment of inventive concepts of processing the UE measurements, the processing circuitry 2103 in block 2801 may receive a notification of a condition monitored by a network function, such as one of the network functions 106, in a wireless network. In block 2803, the processing circuitry 2103 may combine the UE measurements received with the notification to generate a new notification. The combining of the UE measurements may include attaching the UE measurements to the notification to generate the new notification. In block 2805, the processing circuitry 2103 may initiate transmitting of the new notification to recipients.

Various operations from the flow chart of FIG. 26 may be optional with respect to some embodiments of VAE servers and related methods. Regarding methods of example embodiment 1 (set forth below), for example, operations of blocks 2607 of FIG. 26 may be optional.

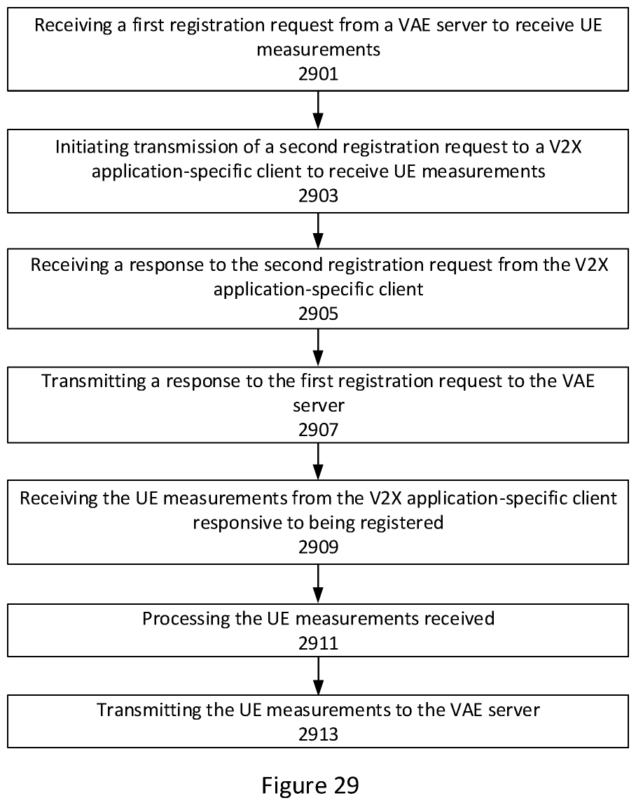

Operations of the VAE client 102 of the V2X UE 104 (implemented using the structure of the block diagram of FIG. 12) will now be discussed with reference to the flow chart of FIG. 29 according to some embodiments of inventive concepts. For example, modules may be stored in memory 2005 of FIG. 20, and these modules may provide instructions so that when the instructions of a module are executed by respective V2X UE processing circuitry 2003, processing circuitry 2003 performs respective operations of the flow chart.

Turning to FIG. 29, in block 2901, the processing circuitry 2003 may receive a first registration request from a VAE server 108 to receive UE measurements. The first registration request may include a list of desired UE measurements the VAE server 108 is interested in receiving, one or more V2X application-specific client identifiers, one or more V2X application-specific server identifiers, a V2X service identifier, an application flow description, a GEO ID, one more time windows, and measurements filter information.

The list of desired UE measurements may include one or more of a timing interval of receiving the UE measurements, a key performance indicator, KPI, to be measured, a measurement side (e.g., client-side or server-side), a measurement layer, a measurement type, and a measurement window.

In block 2903, the processing circuitry 2003 may initiate transmission of a second registration request to a V2X application-specific client 100 to receive UE measurements. The second registration request may include the same or similar information to the information in the first registration request.

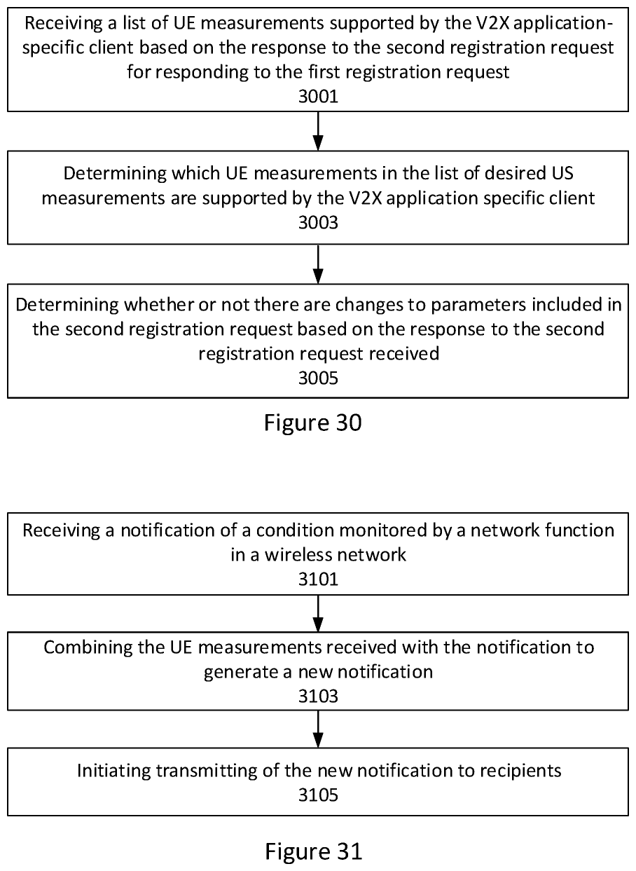

In block 2905, the processing circuitry 2003 may receive a response to the second registration request from the V2X application-specific client. The processing circuitry 2003 may perform operations based on receiving the response to the registration request. For example, turning to FIG. 30, in block 3001, the processing circuitry 2003 may receive a list of UE measurements supported by the V2X application-specific client 100 based on the response to the second registration request for responding to the first registration request. In block 3003, the processing circuitry 2003 may determine which UE measurements in a list of desired US measurements are supported by the V2X application-specific client 100. In block 3005, the processing circuitry may determine whether or not there are changes to parameters included in the second registration request based on the responses to the second registration request received.

Returning to FIG. 29, in block 2907, the processing circuitry 2003 may transmit a response to the first registration request to the VAE server 108. The response to the first registration request may include the information on which UE measurements are supported by the V2X application-specific client 100.

In block 2909, the processing circuitry 2003 may receive the UE measurements from the V2X application-specific client 100 responsive to being registered. In block 2911, the processing circuitry 2003 may process the UE measurements received. The processing of the UE measurements may include initiating transmission of the UE measurements to at least one recipient. The processing of the UE measurements may also include storing the UE measurements. In one embodiment, processing the UE measurements includes providing the UE measurements as part of information provided to a network function in a wireless network providing a notification of a monitored condition. For example, the processing circuitry 2003 may provide the UE measurements to one of the 5G network functions 106. In other embodiments, the processing circuitry 2103 may provide the UE measurements to at least one network function 106.

Turning to FIG. 31, in one embodiment of inventive concepts of processing the UE measurements, the processing circuitry 2003 in block 3101 may receive a notification of a condition monitored by a network function, such as one of the network functions 106, in a wireless network. In block 3103, the processing circuitry 2003 may combine the UE measurements received with the notification to generate a new notification. The combining of the UE measurements may include attaching the UE measurements to the notification to generate the new notification. In block 3105, the processing circuitry 2003 may initiate transmitting of the new notification to recipients.

Returning to FIG. 29, in block 2913, the processing circuitry 2003 may transmit the UE measurements to the VAE server 108.

Various operations from the V2X UEs and VAE clients and related methods may be optional. Regarding methods of example embodiment 43 (set forth below), for example, operations of blocks 2903, 2905, 2909, and 2911 of FIG. 29 may be optional.

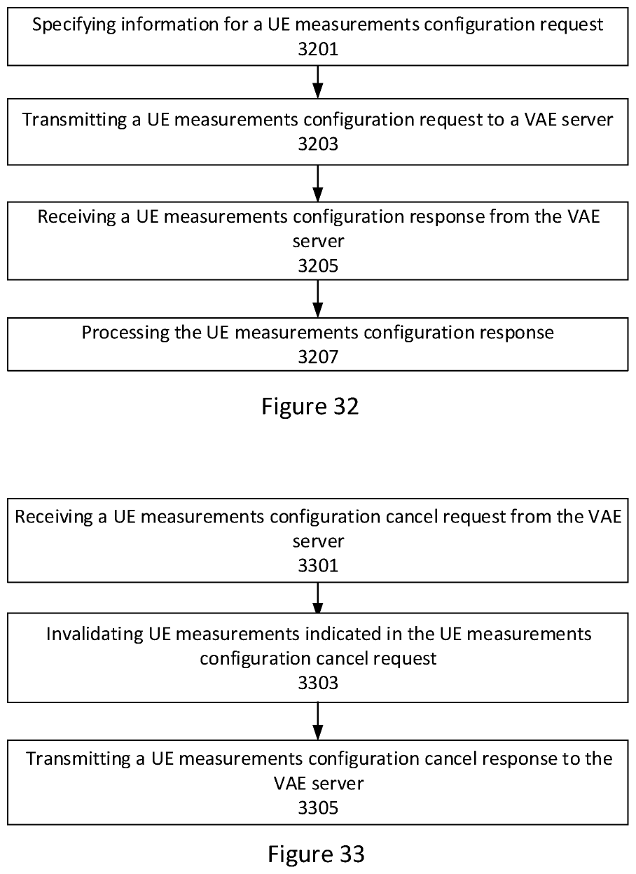

Operations of the V2X application-specific server 110 (implemented using the structure of the block diagram of FIG. 22) will now be discussed with reference to the flow chart of FIG. 32 according to some embodiments of inventive concepts. For example, modules may be stored in memory 2205 of FIG. 22, and these modules may provide instructions so that when the instructions of a module are executed by V2X application-specific server processing circuitry 2203, processing circuitry 2203 performs respective operations of the flow chart.

Turning to FIG. 32, in block 3201, the processing circuitry 2203 may specify information for a UE measurements configuration request. The information can be one or more of a list of UE measurements the V2X application-specific server 110 can provide to the VAE server 108 that are generated at the V2X application-specific server 110 or from a V2X application-specific client 100, one or more V2X application-specific client identifiers (IDs), a V2X application-specific server ID of the V2X application-specific server, one or more V2X service ID, and an application flow description.

In block 3203, the processing circuitry 2203 transmits a user equipment, UE, measurements configuration request to a vehicle-to everything, V2X, application enabler, VAE, server 108. The transmitting of the UE measurements configuration request may be transmitted responsive to a trigger occurring. The trigger can be at least one of: obtaining awareness of support of UE measurements configuration by the VAE server 108; determining that receiving a QoS notification by the V2X application-specific server 110 is associated with support of UE measurements; determining that specific applications or services are active; determining that the V2X application-specific client 100 is at a specific geographic location; and determining that the V2X application-specific client 100 is within a specified time window.

In block 3205, the processing circuitry 2203 receives a UE measurements configuration response from the VAE server 108. The UE measurements configuration response may include one or more of: an indication that the UE measurements configuration request has not been accepted, a list of desired UE measurements providing UE measurements the VAE server 108 is interested in receiving, one or more V2X application-specific client identifiers, a V2X service ID, an application flow description, a GEO ID, one or more time windows, and measurements filter information. Details of the information included are described above.

In block 3207, the processing circuitry 2203 may process the UE measurements received. The processing of the UE measurements may include configuring UE measurement reporting according to the information in the UE measurements configuration response. Configuring the UE measurement reporting may include providing a V2X application-specific client a UE measurement configuration based on the UE measurements configuration response.

Turning to FIG. 33, in some embodiments, the VAE server 108 may no longer need the UE measurements. In block 3301, the processing circuitry 2203 may receive a UE measurements configuration cancel request from the VAE server 108. The UE measurements configuration cancel request may include XXXXX

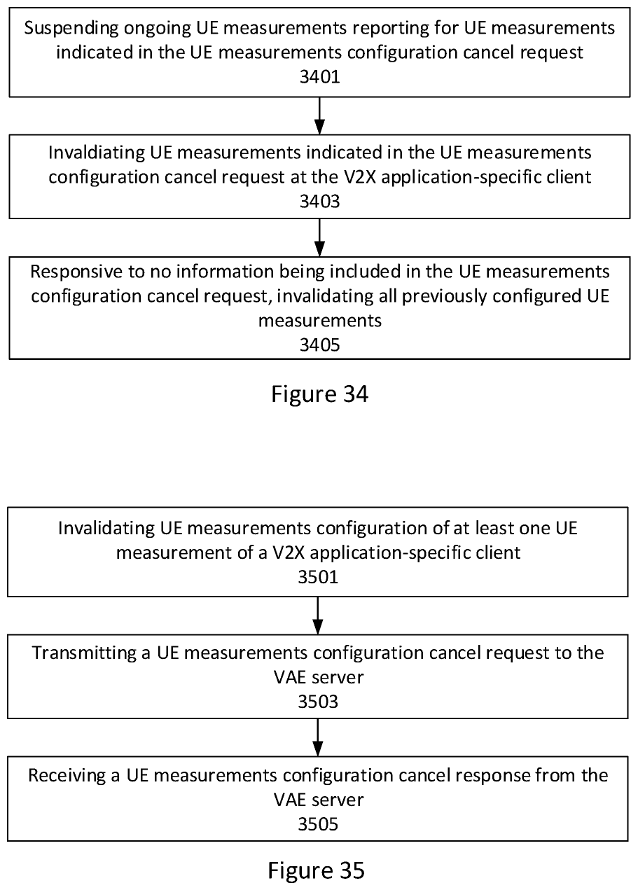

In block 3303, the processing circuitry 2203 invalidates UE measurements indicated in the UE measurements configuration cancel request. Turning to FIG. 34, responsive to UE measurements being indicated in the UE measurements configuration cancel request, the processing circuitry 2203 can suspend ongoing UE measurements reporting for UE measurements indicated in the UE measurements configuration cancel request in block 3401 and invalidate UE measurements indicated in the UE measurements configuration cancel request at the V2X application-specific client 100 in block 3403. In block 3405, the processing circuitry 2203 in block 3405, can, responsive to no information being included in the UE measurements configuration cancel request, invalidate all previously configured UE measurements.

Returning to FIG. 33, in block 3305, the processing circuitry 2203 can transmit a UE measurements configuration cancel response to the VAE server 108.

Turning to FIG. 35, in various embodiments of inventive concepts, the V2X application-specific server 110 may decide to invalidate UE measurements. For example, in block 3501, the processing circuitry 2203 can invalidate UE measurements configuration of at least one UE measurement of a V2X application-specific client 100. The invalidating may be responsive to a trigger condition occurring. The trigger condition may be at least one of the V2X application-specific server 110 stopping traffic to which UE measurements were associated to, and changes in traffic configuration of an application prioritizing other traffic such that the V2X application-specific client 100 or the V2X application-specific server 110 cannot send UE measurements.

In block 3503, the processing circuitry 2203 can transmit a UE measurements configuration cancel request to the VAE server 108. The processing circuitry 2203 in some embodiments invalidates all previously configured UE measurements whereas in other embodiments, the processing circuitry 2203 invalidates fewer than all previously configured UE measurements such as UE measurements associated with stopped traffic. Responsive to invalidating UE measurements configuration of all previously configured UE measurements; the UE measurements configuration cancel request is transmitted with no information regarding UE measurements configuration. When fewer than all UE measurements are invalidated, the UE measurements configuration cancel request comprises at least one of a V2X application-specific client ID and a V2X service ID.

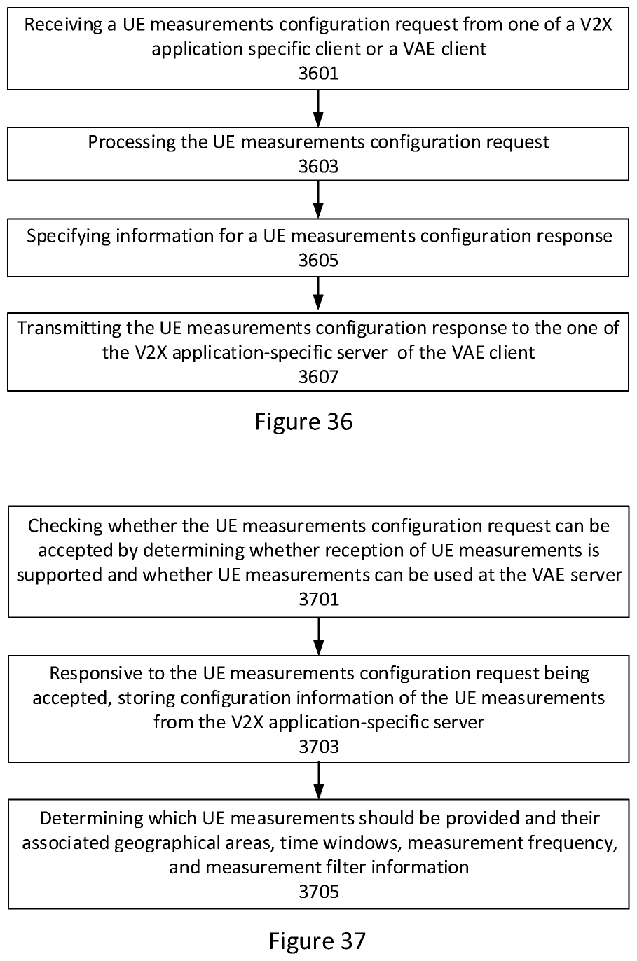

Operations of the VAE server 108 (implemented using the structure of the block diagram of FIG. 21) will now be discussed with reference to the flow chart of FIG. 36 according to some embodiments of inventive concepts. For example, modules may be stored in memory 2105 of FIG. 21, and these modules may provide instructions so that when the instructions of a module are executed by respective VAE server processing circuitry 2103, processing circuitry 2103 performs respective operations of the flow chart.

Turning to FIG. 36, in block 3601, the processing circuitry 2103 receives a user equipment, UE, measurements configuration request from one of a vehicle-to everything, V2X, application-specific server 110 or a VAE client 102. The UE measurements configuration request may include one or more of: a list of UE measurements the one of the V2X application-specific server 110 or the VAE client 102 can provide to the VAE server 108 that are generated at the V2X application-specific server 110 or from a V2X application-specific client 100, one or more V2X application-specific client identifiers, IDs, a V2X application-specific server ID of the V2X application-specific server, one or more V2X service IDs, and an application flow description.

In block 3603, the processing circuitry 2103 processes the UE measurements configuration request. Turing to FIG. 37, in various embodiments, the processing of the UE measurements configuration request includes at least one of checking, in block 3701, whether the UE measurements configuration request can be accepted by determining whether reception of UE measurements is supported and whether UE measurements can be used at the VAE server 108. Responsive to the UE measurements configuration request being accepted, the processing circuitry 2103 in block 3703 stores configuration information of the UE measurements from the V2X application-specific server 110.

Returning to FIG. 36, in block 3605, the processing circuitry 2103 may specify information for a UE measurements configuration response. The information can include one or more of an indication that the UE measurements configuration request has not been accepted, a list of UE measurements the VAE server 108 is interested in receiving, one or more V2X application-specific client identifiers (IDs), one or more V2X service IDs, an application flow description, a geo ID, one or more time windows, and measurements filter information. The one or more V2X application-specific client identifiers (IDs), one or more V2X service IDs, an application flow description, a geo ID, one or more time windows, and measurements filter information have been described above.

In block 3607, the processing circuitry 2103 transmits the UE measurements configuration response to the one of the V2X application-specific server 110 or the VAE client 102.

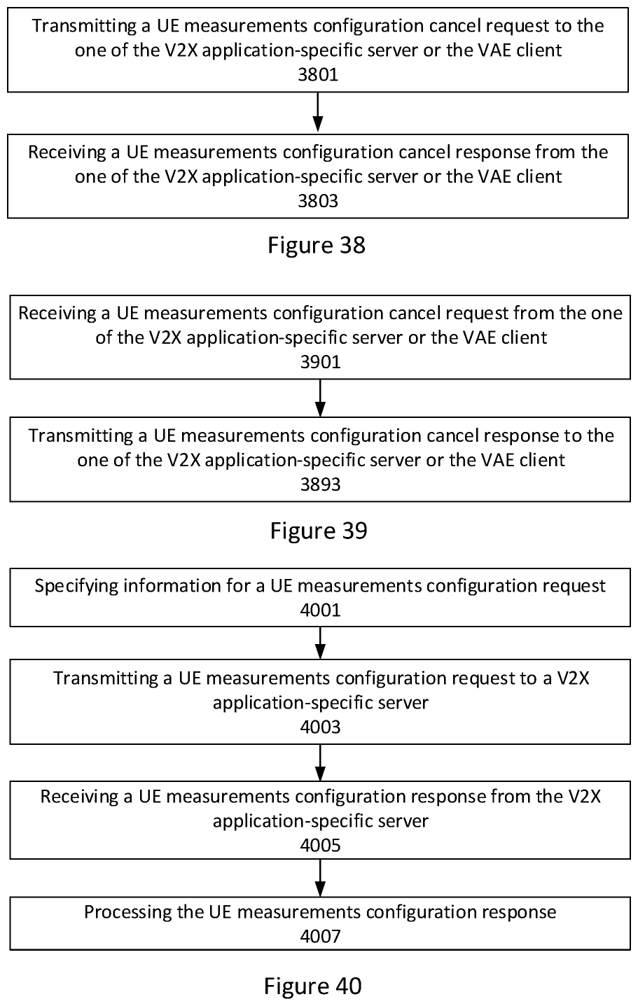

In some embodiments of inventive concepts, the VAE server 108 may no longer need UE measurements. Turning to FIG. 38, the processing circuitry 2103 in block 3801 transmits a UE measurements configuration cancel request to the one of the V2X application-specific server 110 or the VAE client 102. Transmitting the UE measurements configuration cancel request may be transmitted responsive to a trigger occurring. The trigger can include the VAE server 108 stopping tasks to which the UE measurements were associated with or a load of the VAE server 108 being above a threshold level or at the threshold level.

In block 3803, the processing circuitry 2103 receives a UE measurements configuration cancel response from the one of the V2X application-specific server 110 or the VAE client 102.

In other embodiments of inventive concepts, the VAE client 102 or the V2X application-specific server may no longer be able to provide UE measurements or have stopped traffic to which UE measurements are associated with. Turning to FIG. 39, the processing circuitry 2103 may receive a UE measurements configuration cancel request from the one of the V2X application-specific server 110 or the VAE client 102.

The UE measurements configuration cancel request may include at least one of a V2X application-specific client ID and a V2X service ID. This indicates which UE measurements have been canceled. The processing circuitry may cancel the UE measurements associated with the at least one of the V2X application-specific client ID and the V2X service ID. Responsive to no information being included in the UE measurements configuration cancel request, the processing circuitry 2103 may cancel all previously configured UE measurements associated with the one of the V2X application-specific server 110 or the VAE client 102.

The VAE client 108 in various embodiments of inventive concepts can request UE measurements. Turning to FIG. 40, in block 4001, the processing circuitry 2103 may specify information for a UE measurements configuration request. The information can be a list of UE measurements the VAE server 108 is interested in receiving, one or more V2X application-specific client identifiers (IDs), one or more V2X service IDs, an application flow description, a geo ID. one or more time windows, and measurements filter information.

In block 4003, the processing circuitry 2103 transmits a user equipment, UE, measurements configuration request to a vehicle-to everything, V2X, application-specific server 110.

In block 4005, the processing circuitry 2203 receives a UE measurements configuration response from the V2X application-specific server 110. The UE measurements configuration response may include one or more of: an indication that the UE measurements configuration request has not been accepted, a list of UE measurements the V2X application-specific server 110 can provide to the VAE server 108 that are generated at the V2X application-specific server 110 or from a V2X application-specific client 100, one or more V2X application-specific client identifiers, a V2X service ID, an application flow description, a GEO ID, one or more time windows, and measurements filter information. The indication that the UE measurements configuration request has not been accepted may be due to the V2X application-specific client not being able to provide the UE measurements specified. Details of the information included are described above.

In block 4007, the processing circuitry 2103 may process the UE measurements configuration response.

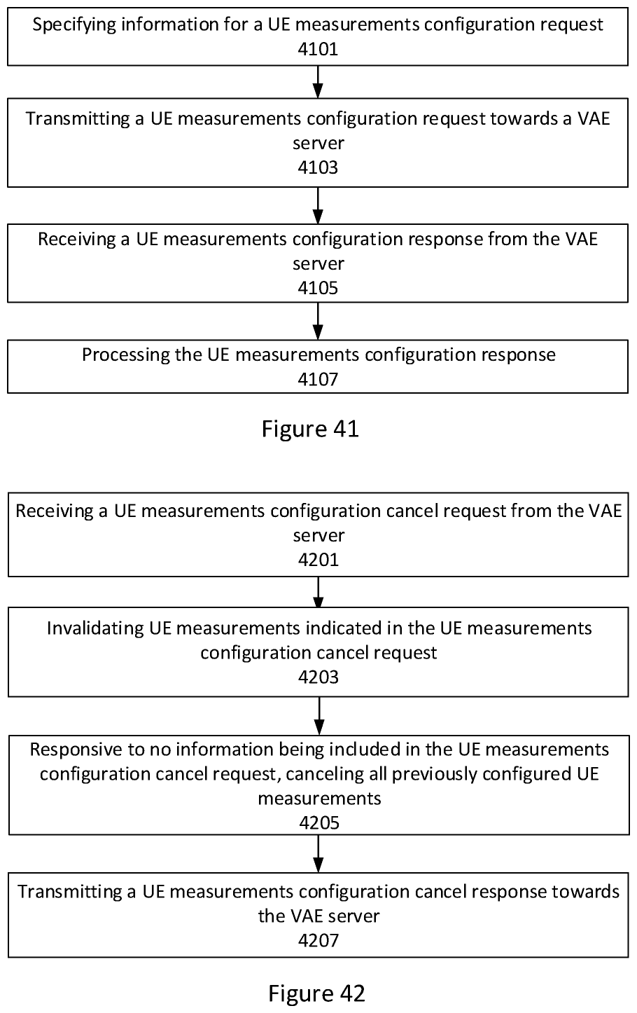

Operations of the V2X application-specific client 100 (implemented using the structure of the block diagram of FIG. 20) will now be discussed with reference to the flow chart of FIG. 41 according to some embodiments of inventive concepts. For example, modules may be stored in memory 2005 of FIG. 21, and these modules may provide instructions so that when the instructions of a module are executed by processing circuitry 2003, processing circuitry 2003 performs respective operations of the flow chart.

Turning to FIG. 41, in block 4101, the processing circuitry 2003 may specify information for a UE measurements configuration request. The information can be one or more of a list of UE measurements the V2X application-specific client 100 can provide to the VAE server 108, one or more V2X application-specific client identifiers (IDs), a V2X application-specific server ID of the V2X application-specific server, one or more V2X service ID, and an application flow description.

In block 4103, the processing circuitry 2003 transmits a user equipment, UE, measurements configuration request towards a vehicle-to everything, V2X, application enabler, VAE, server 108. The V2X application-specific client (100) communicates with the VAE server (108) via a VAE client (102). The transmitting of the UE measurements configuration request may be transmitted responsive to a trigger occurring. The trigger can be at least one of: obtaining awareness of support of UE measurements configuration by the VAE server 108; determining that receiving a QoS notification by the V2X application-specific server 110 is associated with support of UE measurements; determining that specific applications or services are active; determining that the V2X application-specific client 100 is at a specific geographic location; and determining that the V2X application-specific client 100 is within a specified time window.

In block 4105, the processing circuitry 2003 receives a UE measurements configuration response from the VAE server 108. The UE measurements configuration response may include one or more of: an indication that the UE measurements configuration request has not been accepted, a list of desired UE measurements providing UE measurements the VAE server 108 is interested in receiving, one or more V2X application-specific client identifiers, a V2X service ID, an application flow description, a GEO ID, one or more time windows, and measurements filter information. Details of the information included are described above.

In block 4107, the processing circuitry 2003 may process the UE measurements received. The processing of the UE measurements may include configuring UE measurement reporting according to the information in the UE measurements configuration response.

Turning to FIG. 42, in some embodiments, the VAE server 108 may no longer need the UE measurements. In block 4201, the processing circuitry 2003 may receive a UE measurements configuration cancel request from the VAE server 108. The UE measurements configuration cancel request may include at least one of a V2X application-specific client ID and a V2X service ID.

In block 4203, the processing circuitry 2003 invalidates UE measurements indicated in the UE measurements configuration cancel request. Responsive to UE measurements being indicated in the UE measurements configuration cancel request, the processing circuitry 2003 can suspend ongoing UE measurements reporting for UE measurements indicated in the UE measurements configuration cancel request and invalidate UE measurements indicated in the UE measurements configuration cancel request at the V2X application-specific client 100. In block 4205, the processing circuitry 2003, can, responsive to no information being included in the UE measurements configuration cancel request, invalidate all previously configured UE measurements.

In block 4207, the processing circuitry 2003 can transmit a UE measurements configuration cancel response towards the VAE server 108.

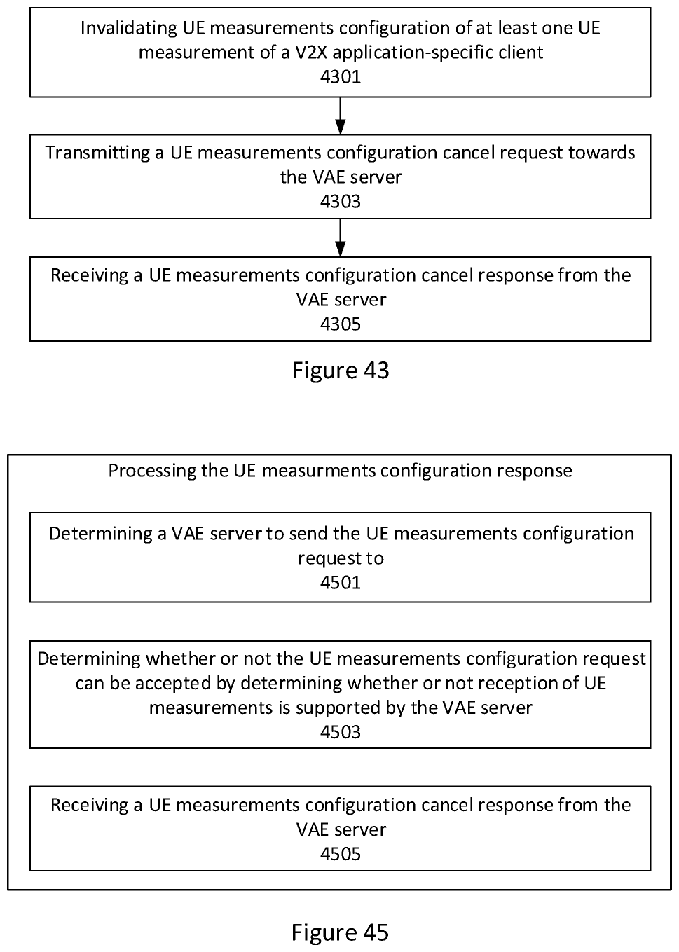

Turning to FIG. 43, in various embodiments of inventive concepts, the V2X application-specific client 100 may decide to invalidate UE measurements. For example, in block 4301, the processing circuitry 2003 can invalidate UE measurements configuration of at least one UE measurement of a V2X application-specific client 100. The invalidating may be responsive to a trigger condition occurring. The trigger condition may be at least one of the V2X application-specific server 110 stopping traffic to which UE measurements were associated to, and changes in traffic configuration of an application prioritizing other traffic such that the V2X application-specific client 100 or the V2X application-specific server 110 cannot send UE measurements.

In block 4303, the processing circuitry 2003 can transmit a UE measurements configuration cancel request towards the VAE server 108. The processing circuitry 2003 in some embodiments invalidates all previously configured UE measurements whereas in other embodiments, the processing circuitry 2003 invalidates fewer than all previously configured UE measurements such as UE measurements associated with stopped traffic. Responsive to invalidating UE measurements configuration of all previously configured UE measurements; the UE measurements configuration cancel request is transmitted with no information regarding UE measurements configuration. When fewer than all UE measurements are invalidated, the UE measurements configuration cancel request comprises at least one of a V2X application-specific client ID and a V2X service ID.

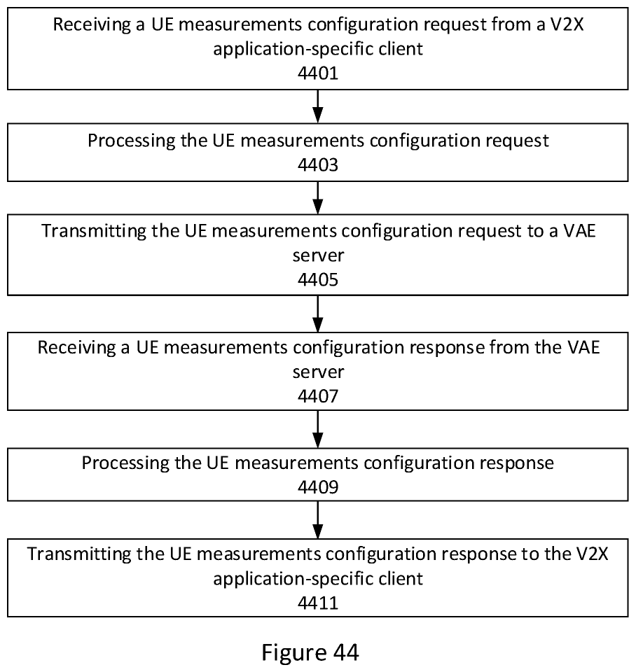

Operations of the VAE client 102 (implemented using the structure of the block diagram of FIG. 20) will now be discussed with reference to the flow chart of FIG. 44 according to some embodiments of inventive concepts. For example, modules may be stored in memory 2005 of FIG. 21, and these modules may provide instructions so that when the instructions of a module are executed by processing circuitry 2003, processing circuitry 2003 performs respective operations of the flow chart.

Turning to FIG. 44, in block 4401, the processing circuitry 2003 may receive a user equipment, UE, measurements configuration request from a vehicle-to everything, V2X, application-specific client 100. There may be information in the UE measurements configuration request, which can be one or more of a list of UE measurements the V2X application-specific client 100 can provide to the VAE server 108, one or more V2X application-specific client identifiers (IDs), a V2X application-specific server ID of the V2X application-specific server, one or more V2X service ID, and an application flow description.

In block 4403, the processing circuitry 2003 may process the UE measurements configuration request. Turning to FIG. 45, the processing of the UE measurements configuration request can include at least one of: determining in block 4501 a VAE server 108 to send the UE measurements configuration request to, determining in block 4503 whether or not the UE measurements configuration request can be accepted by determining whether or not reception of UE measurements is supported by the VAE server 108, and updating or translating parameters included in the UE measurements configuration request in block 4505.

Responsive to determining that the UE measurements configuration cannot be accepted, the processing circuitry 2003 may transmit a response to the V2X application-specific client indicating failure of the UE measurements configuration request.

Returning to FIG. 44, in block 4405, the processing circuitry 2003 transmits the UE measurements configuration request to the VAE, server 108.

In block 4407, the processing circuitry 2003 receives a UE measurements configuration response from the VAE server 108. The UE measurements configuration response may include one or more of: an indication that the UE measurements configuration request has not been accepted, a list of desired UE measurements providing UE measurements the VAE server 108 is interested in receiving, one or more V2X application-specific client identifiers, a V2X service ID, an application flow description, a GEO ID, one or more time windows, and measurements filter information. Details of the information included are described above.

In block 4409, the processing circuitry 2003 may process the UE measurements configuration response received. The processing of the UE measurements configuration response may include updating or translating parameters included in the UE measurements configuration response. In block 4411, the processing circuitry 2003 transmits the UE measurements configuration request (processed by the VAE client 102) to the V2X application-specific client 100. In other embodiments of inventive concepts, the processing of the UE measurements configuration response may include responsive to the UE measurements configuration response indicating an acceptance of the UE measurements configuration request, storing configuration information of the UE measurements indicated in the UE measurement configuration response reporting based on the information in the UE measurements configuration response.

The processing circuitry 2003 performs a similar process when receiving a UE measurements configuration request from a VAE server 108. In other words, the processing circuitry 2003 receives the UE measurements configuration request from the VAE server 108, processes the UE measurements configuration request, and transmits the UE measurements configuration request processed by the processing circuitry 2003 to the V2X application-specific client 100. The processing circuitry 2003 receives the UE measurements configuration response from the V2X application-specific client 100, processes the UE measurements configuration response, and transmits the UE measurements configuration response processed by the processing circuitry 2003 to the VAE server 108.

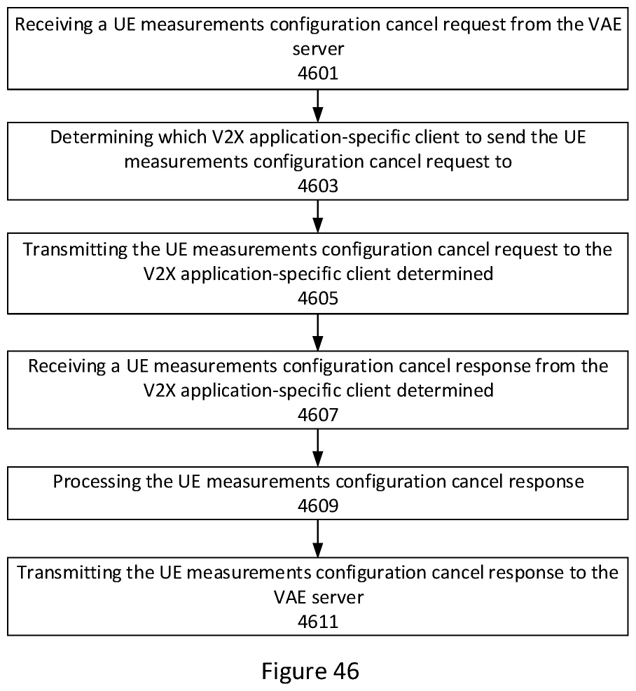

Turning to FIG. 46, in some embodiments, the VAE server 108 may no longer need the UE measurements. In block 4601, the processing circuitry 2003 may receive a UE measurements configuration cancel request from the VAE server 108. The UE measurements configuration cancel request may include at least one of a V2X application-specific client ID and a V2X service ID.

In block 4603, the processing circuitry 2003 determines which V2X application-specific client to send the UE measurements configuration cancel request. In block 4605, the processing circuitry 2003 can transmit a UE measurements configuration cancel response to the V2X application-specific client specified.

In block 4607, the processing circuitry 2003 receives a UE measurements configuration cancel response from the V2X application-specific client 100 determined. In block 4609, the processing circuitry processes the UE measurements configuration cancel response. The processing may include updating or translating parameters included in the UE measurements configuration cancel response. In block 4611, the processing circuitry 2003 transmits the UE measurements configuration cancel response (processed by the VAE client 102) to the VAE server 108.

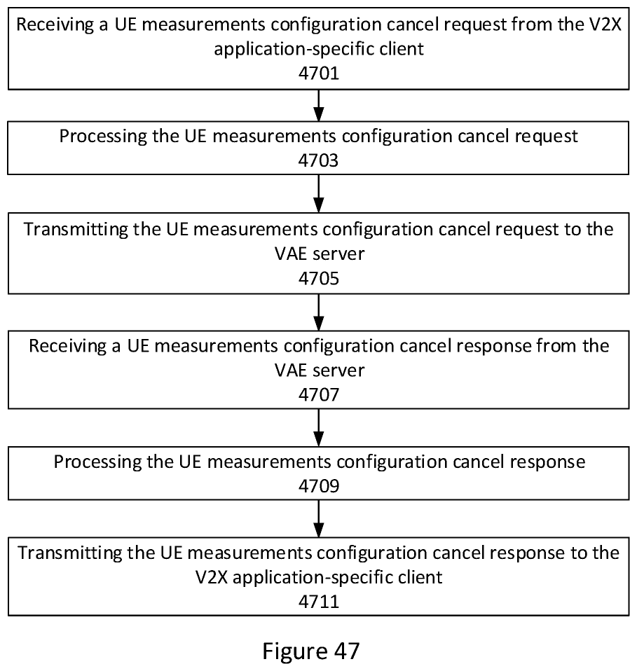

Turning to FIG. 47, in various embodiments of inventive concepts, the V2X application-specific client 100 may decide to invalidate UE measurements and transmit the UE measurements configuration cancel request towards the VAE server 108. In block 4701, the processing circuitry 2003 receives the UE measurements configuration cancel request from the V2X application-specific client. In block 4703, the processing circuitry 2003 processes the UE measurements configuration cancel request. The processing may include updating or translating parameters included in the UE measurements configuration cancel request.

In block 4705, the processing circuitry 2003 transmits the UE measurements configuration cancel request (processed by the VAE client 102) to the VAE server 108. In block 4707, the processing circuitry 2003 receives a UE measurements configuration cancel response from the VAE server 108.

In block 4709, the processing circuitry 2003 processes the UE measurements configuration cancel response. The processing may include updating or translating parameters included in the UE measurements configuration cancel response.

In block 4711, the processing circuitry 2003 transmits the UE measurements configuration cancel response (processed by the VAE client 102) to the V2X application-specific client 100.

Example embodiments are discussed below.

1. A method performed by a vehicle-to everything, V2X, application enabler, VAE, server (108) for receiving user equipment, UE, measurements, the method comprising:

initiating (1501) transmission of a registration request to a VAE client (102) to receive UE measurements;

receiving (1503) a response to the registration request from the VAE client (102); and

receiving (1505) the UE measurements from a V2X UE (104) responsive to being registered.

2. The method of Embodiment 1 wherein the V2X UE (104) comprises a VAE client (102).
3. The method of any of Embodiments 1-2, further comprising specifying, for the registration request one or more of:

a list of desired UE measurements comprising UE measurements the VAE server (108) is interested in receiving;

one or more V2X application-specific client identifiers, IDs;

one or more V2X application-specific server IDs;

a V2X service ID;

an application flow description;

a geo ID;

one or more time windows; and

measurements filter information.

4. The method of Embodiment 3, wherein the list of desired UE measurements comprises one or more of:

a timing interval of receiving the UE measurements

a key performance indicator, KPI, to be measured;

a measurement side;

a measurement layer;

a measurement type; and

a measurement window.

5. The method of any of Embodiments 3-4 further comprising:
responsive to receiving the response, determining (1601) which UE measurements in the list of desired UE measurements are supported by the VAE client (102).
6. The method of any of Embodiments 1-5, further comprising:
determining (1603) whether or not there are changes to parameters included in the registration request based on the response received.
7. The method of any of Embodiments 1-6, further comprising:
processing (2307) the UE measurements received.
8. The method of Embodiment 7, wherein processing the UE measurements further comprises:
initiating transmission of the UE measurements to at least one recipient.
9. The method of any of Embodiments 7-8, wherein processing the UE measurements further comprises:
storing the UE measurements.
10. The method of any of Embodiments 7-9 wherein processing the UE measurements further comprises:

receiving (1701) a notification of a condition monitored by a network function in a wireless network;

combining (1703) the UE measurements received with the notification to generate a new notification; and

initiating (1705) transmitting of the new notification to recipients.

11. The method of Embodiment 10 wherein combining the UE measurements comprises:
attaching the UE measurements to the notification.
12. The method of Embodiment 7 wherein processing the UE measurements further comprises:

providing the UE measurements as part of information provided to a network function in a wireless network providing a notification of a monitored condition.

13. The method of any of Embodiments 1-12 further comprising providing the UE measurements to at least one network function (106).
14. A vehicle-to everything, V2X, application enabler, VAE, server (108) comprising:

processing circuitry (2103); and

memory (2105) coupled with the processing circuitry (2103), wherein the memory includes instructions that when executed by the processing circuitry (2103) causes the VAE server (108) to perform operations comprising:
initiating (1501) transmission of a registration request to a VAE client (102) to receive user equipment, UE, measurements;
receiving (1503) a response to the registration request from the VAE client (102); and
receiving (1505) the UE measurements from a V2X UE (104) responsive to being registered.
   15. The VAE server (108) of Embodiment 14 wherein the memory includes instructions that when executed by the processing circuitry (2103) causes the VAE server (108) to perform operations according to any of Embodiments 2-13.
   16. A vehicle-to everything, V2X, application enabler, VAE, server (108) adapted to perform operations comprising:

initiating (1501) transmission of a registration request to a VAE client (102) to receive UE measurements;

receiving (1503) a response to the registration request from the VAE client (102); and

receiving (1505) the UE measurements from a V2X UE (104) responsive to being registered.

17. The VAE server (108) of Embodiment 16, wherein VAE server (108) is further adapted to perform operations according to any of Embodiments 2-13.
18. A computer program comprising program code to be executed by processing circuitry (2103) of a vehicle-to everything, V2X, application enabler, VAE, server (108), whereby execution of the program code causes the VAE server (108) to perform operations comprising:

initiating (1501) transmission of a registration request to a VAE client (102) to receive UE measurements;

receiving (1503) a response to the registration request from the VAE client (102); and

receiving (1505) the UE measurements from a V2X UE (104) responsive to being registered.

19. The computer program of Embodiment 18 wherein execution of the program code causes the VAE server (108) to perform operations according to any of Embodiments 2-13.
20. A computer program product comprising a non-transitory storage medium including program code to be executed by processing circuitry (2103) of a vehicle-to everything, V2X, application enabler, VAE, server (108), whereby execution of the program code causes the VAE server (108) to perform operations comprising:

initiating (1501) transmission of a registration request to a VAE client (102) to receive UE measurements;

receiving (1503) a response to the registration request from the VAE client (102); and

receiving (1505) the UE measurements from a V2X UE (104) responsive to being registered.

21. The computer program of Embodiment 20, wherein execution of the program code causes the VAE server (108) to perform operations according to any of Embodiments 2-13.
22. A method performed by a vehicle-to everything, V2X, application enabler, VAE, server (108) for receiving user equipment, UE, measurements, the method comprising: initiating (1801) transmission of a registration request to a V2X application-specific server (110) to receive UE measurements;

receiving (1803) a response to the registration request from the V2X application-specific server (110); and

receiving (1805) the UE measurements from the V2X application-specific server (110) gathered from one or more V2X UEs (104) responsive to being registered.

23. The method of Embodiment 22 wherein each of the one or more V2X UEs (104) comprises a V2X application-specific client (100).
24. The method of any of Embodiments 22-23, further comprising specifying, for the registration request one or more of:

a list of desired UE measurements comprising UE measurements the VAE server (108) is interested in receiving;

one or more V2X application-specific client identifiers, IDs;

one or more V2X application-specific server IDs;

a V2X service ID;

an application flow description;

a geo ID;

one or more time windows; and

measurements filter information.

25. The method of Embodiment 24, wherein the list of desired UE measurements comprises one or more of:

a timing interval of receiving the UE measurements;

a key performance indicator, KPI, to be measured;

a measurement side;

a measurement layer;

a measurement type; and

a measurement window.

26. The method of any of Embodiments 22-25 wherein the response includes whether or not the registration request was successful, the method further comprising:

responsive to the response indicating the registration request was successful, determining (1901) which UE measurements in the list of desired UE measurements are supported by the V2X application-specific server (110).

27. The method of any of Embodiments 22-26, further comprising:

determining (1903) whether or not there are changes to parameters included in the registration request based on the response received.

28. The method of any of Embodiments 22-27, further comprising:

processing (1807) the UE measurements received.

29. The method of Embodiment 28, wherein processing the UE measurements further comprises:

initiating transmission of the UE measurements to at least one recipient.

30. The method of any of Embodiments 28-29, wherein processing the UE measurements further comprises:

storing the UE measurements.

31. The method of any of Embodiments 28-30 wherein processing the UE measurements further comprises:

receiving (2001) a notification of a condition monitored by a network function in a wireless network;

combining (2003) the UE measurements received with the notification to generate a new notification; and

initiating (2005) transmitting of the new notification to at least one recipient.

32. The method of Embodiment 31 wherein combining the UE measurements comprises:

attaching the UE measurements to the notification.

33. The method of any of Embodiments 22-32 further comprising providing the UE measurements to at least one network function (106).
34. The method of Embodiment 28 wherein processing the UE measurements further comprises:

providing the UE measurements as part of information provided to a network function in a wireless network providing a notification of a monitored condition.

35. A vehicle-to everything, V2X, application enabler, VAE, server (108) comprising:

processing circuitry (2103); and

memory (2105) coupled with the processing circuitry (2103), wherein the memory includes instructions that when executed by the processing circuitry (2103) causes the VAE server (108) to perform operations comprising:
initiating (1801) transmission of a registration request to a V2X application-specific server (110) to receive UE measurements;
receiving (1803) a response to the registration request from the V2X application-specific server (110); and
receiving (1805) the UE measurements from the V2X application-specific server (110) gathered from one or more V2X UEs (104) responsive to being registered.
   36. The VAE server (108) of Embodiment 35 wherein the memory includes instructions that when executed by the processing circuitry (2103) causes the VAE server (108) to perform operations according to any of Embodiments 22-34.
   37. A vehicle-to everything, V2X, application enabler, VAE, server (108) adapted to perform operations comprising:

initiating (1801) transmission of a registration request to a V2X application-specific server (110) to receive UE measurements;

receiving (1803) a response to the registration request from the V2X application-specific server (110); and

receiving (1805) the UE measurements from the V2X application-specific server (110) gathered from one or more V2X UEs (104) responsive to being registered.

38. The VAE server (108) of Embodiment 37 wherein VAE server (108) is further adapted to perform operations according to any of Embodiments 22-34.
39. A computer program comprising program code to be executed by processing circuitry (2103) of a vehicle-to everything, V2X, application enabler, VAE, server (108), whereby execution of the program code causes the VAE server (108) to perform operations comprising:

initiating (1801) transmission of a registration request to a V2X application-specific server (110) to receive UE measurements;

receiving (1803) a response to the registration request from the V2X application-specific server (110); and

receiving (1805) the UE measurements from the V2X application-specific server (110) gathered from one or more V2X UEs (104) responsive to being registered.

40. The computer program of Embodiment 39 wherein the program code causes the VAE server (108) to perform operations according to any of Embodiments 22-34.
41. A computer program product comprising a non-transitory storage medium including program code to be executed by processing circuitry (2103) of a vehicle-to everything, V2X, application enabler, VAE, server (108), whereby execution of the program code causes the VAE server (108) to perform operations comprising:

initiating (1801) transmission of a registration request to a V2X application-specific server (110) to receive UE measurements;

receiving (1803) a response to the registration request from the V2X application-specific server (110); and

receiving (1805) the UE measurements from the V2X application-specific server (110) gathered from one or more V2X UEs (104) responsive to being registered.

42. The computer program product of Embodiment 41 wherein the program code causes the VAE server (108) to perform operations according to any of Embodiments 22-34.
43. A method performed by a vehicle-to everything, V2X, application enabler, VAE, client (102) for providing user equipment, UE, measurements, the method comprising:

receiving (2101) a first registration request from a VAE server (108) to receive UE measurements;

transmitting (2107) a response to the first registration request to the VAE server (108); and

transmitting (2113) the UE measurements to the VAE server (108).

44. The method of Embodiment 43, further comprising:

initiating (2103) transmission of a second registration request to a V2X application-specific client (100) to receive UE measurements;

receiving (2105) a response to the second registration request from the V2X application-specific client (100); and

receiving (2109) the UE measurements from the V2X application-specific client (100) responsive to being registered.

45. The method of Embodiment 44, further comprising, specifying for the second registration request one or more of:

a list of desired UE measurements comprising UE measurements the VAE server (108) is interested in receiving;

one or more V2X application-specific client identifiers, IDs;

one or more V2X application-specific server IDs;

a V2X service ID;

an application flow description;

a geo ID;

one or more time windows; and

measurements filter information.

46. The method of Embodiment 45, wherein the list of desired UE measurements comprises one or more of:

a timing interval of receiving the UE measurements;

a key performance indicator, KPI, to be measured;

a measurement side;

a measurement layer;

a measurement type; and

a measurement window.

47. The method of any of Embodiments 43-46, further comprising:

receiving (2201) a list of UE measurements supported by the V2X application-specific client (100) based on the response to the second registration request for responding to the first registration request; and

determining (2203) which UE measurements in the list of desired UE measurements are supported by the V2X application-specific client (100).

48. The method of Embodiment 47, further comprising:

determining (2205) whether or not there are changes to parameters included in the second registration request based on the response to the second registration request received.

49. The method of any of Embodiments 43-48, further comprising:

processing (2111) the UE measurements received.

50. The method of Embodiment 49, wherein processing the UE measurements further comprises:

initiating transmission of the UE measurements to at least one recipient.

51. The method of any of Embodiments 49-50, wherein processing the UE measurements further comprises:

storing the UE measurements.

52. The method of any of Embodiments 49-51 wherein processing the UE measurements further comprises:

receiving (2301) a notification of a condition monitored by a network function in a wireless network;

combining (2303) the UE measurements received with the notification to generate a new notification; and

initiating (2305) transmitting of the new notification to recipients.

53. The method of Embodiment 52 wherein combining the UE measurements comprises:

attaching the UE measurements to the notification.

54. The method of Embodiment 49 wherein processing the UE measurements further comprises:

providing the UE measurements as part of information provided to a network function in a wireless network providing a notification of a monitored condition.

55. A vehicle-to everything, V2X, application enabler, VAE, client (102) comprising:

processing circuitry (2003); and

memory (2005) coupled with the processing circuitry (2003), wherein the memory includes instructions that when executed by the processing circuitry (2003) causes the VAE client (102) to perform operations comprising:
receiving (2101) a first registration request from a VAE server (108) to receive UE measurements;
transmitting (2107) a response to the first registration request to the VAE server (108); and
transmitting (2113) the UE measurements to the VAE server (108).
   56. The VAE client (102) of Embodiment 56 wherein the memory includes instructions that when executed by the processing circuitry (2003) causes the VAE client (102) to perform operations according to any of Embodiments 44-54.
   57. A vehicle-to everything, V2X, application enabler, VAE, client (102) adapted to perform operations comprising:

receiving (2101) a first registration request from a VAE server (108) to receive UE measurements;

transmitting (2107) a response to the first registration request to the VAE server (108); and

transmitting (2113) the UE measurements to the VAE server (108).

58. The VAE client (102) of Embodiment 57 wherein the VAE client (102) is further adapted to perform operations according to any of Embodiments 44-54.
59. A computer program comprising program code to be executed by processing circuitry (2003) of a vehicle-to everything, V2X, application enabler, VAE, client (102), whereby execution of the program code causes the VAE client (102) to perform operations comprising:

receiving (2101) a first registration request from a VAE server (108) to receive UE measurements;

transmitting (2107) a response to the first registration request to the VAE server (108); and

transmitting (2113) the UE measurements to the VAE server (108).

60. The computer program of Embodiment 59 wherein the program code causes the VAE client (102) to perform operations according to any of Embodiments 44-54.
61. A computer program product comprising a non-transitory storage medium including program code to be executed by processing circuitry (2003) of a vehicle-to everything, V2X, application enabler, VAE, client (102), whereby execution of the program code causes the VAE client (102) to perform operations comprising:

receiving (2101) a first registration request from a VAE server (108) to receive UE measurements;

transmitting (2107) a response to the first registration request to the VAE server (108); and

transmitting (2113) the UE measurements to the VAE server (108).

62. The computer program product of Embodiment 61 wherein the program code causes the VAE client (102) to perform operations according to any of Embodiments 44-54.
63. A method performed by a vehicle-to everything, V2X, application-specific server (110), the method comprising:

transmitting (3203) a user equipment, UE, measurements configuration request to a vehicle-to everything, V2X, application enabler, VAE, server (108);

receiving (3205) a UE measurements configuration response from the VAE server (108); and

processing (3207) the UE measurements configuration response.

64. The method of Embodiment 63, further comprising specifying (3201) information for the UE measurements configuration request, wherein the information comprises one or more of:

a list of UE measurements the V2X application-specific server (110) can provide to the VAE server (108) that are generated at the V2X application-specific server (110) or from a V2X application-specific client (100);

one or more V2X application-specific client identifiers, IDs;

a V2X application-specific server ID of the V2X application-specific server;

one or more V2X service IDs; and

an application flow description.

65. The method of any of Embodiments 63-64 wherein transmitting the UE measurements configuration request comprises transmitting the UE measurements configuration request responsive to a trigger occurring.
66. The method of Embodiment 65 wherein the trigger comprises at least one of:

obtaining awareness of support of UE measurements configuration by the VAE server 108;

determining that receiving a QoS notification by the V2X application-specific server (110) is associated with support of UE measurements;

determining that specific applications or services are active;

determining that the V2X application-specific client (100) is at a specific geographic location; and

determining that the V2X application-specific client (100) is within a specified time window.

67. The method of any of Embodiments 63-66 wherein the UE measurements configuration response comprises information including one or more of:

an indication that the UE measurements configuration request has not been accepted;

a list of desired UE measurements comprising UE measurements the VAE server (108) is interested in receiving;

one or more V2X application-specific client identifiers, IDs;

a V2X service ID;

an application flow description;

a geo ID;

one or more time windows; and

measurements filter information.

68. The method of any of Embodiments 63-67 wherein processing the UE measurements configuration response comprises configuring UE measurement reporting according to the information in the UE measurements configuration response.
69. The method of Embodiment 68 wherein configuring the UE measurement reporting comprises providing a V2X application-specific client a UE measurement configuration based on the UE measurements configuration response.
70. The method of any of Embodiments 63-67 further comprising:

receiving (3301) a UE measurements configuration cancel request from the VAE server (108);

invalidating (3303) UE measurements indicated in the UE measurements configuration cancel request; and

transmitting (3305) a UE measurements configuration cancel response to the VAE server (108).

71. The method of Embodiment 70, wherein invalidating the UE measurements comprises:

responsive to UE measurements being indicated in the UE measurements configuration cancel request:
suspending (3401) ongoing UE measurements reporting for UE measurements indicated in the UE measurements configuration cancel request; and
invalidating (3403) UE measurements indicated in the UE measurements configuration cancel request at the V2X application-specific client (100).
   72. The method of Embodiment 70, wherein invalidating the UE measurements comprises:

responsive to no information being included in the UE measurements configuration cancel request, invalidating (3405) all previously configured UE measurements.

73. The method of any of Embodiments 63-72 further comprising:

invalidating (3501) UE measurements configuration of at least one UE measurement of a V2X application-specific client (100);

transmitting (3503) a UE measurements configuration cancel request to the VAE server (108); and

receiving (3505) a UE measurements configuration cancel response from the VAE server (108).

74. The method of Embodiment 73 wherein the UE measurements configuration cancel request comprises at least one of a V2X application-specific client ID and a V2X service ID.
75. The method of Embodiment 73 wherein responsive to invalidating UE measurements configuration of all previously configured UE measurements; transmitting the UE measurements configuration cancel request with no information regarding UE measurements configuration.
76. The method of any of Embodiments 73-75 wherein invalidating the UE measurements configuration of the at least one UE measurement comprises invalidating the UE measurements configuration of the at least one UE measurement responsive to a trigger condition occurring.
77. The method of Embodiment 76 wherein the trigger condition comprises at least one of:

the V2X application-specific server (110) stopping traffic to which UE measurements were associated to; and

changes in traffic configuration of an application prioritizing other traffic such that the V2X application-specific client or the V2X application-specific server cannot send UE measurements.

78. A vehicle-to everything, V2X, application-specific server (110) comprising:

processing circuitry (2203); and

memory (2205) coupled with the processing circuitry (2203), wherein the memory includes instructions that when executed by the processing circuitry (2203) causes the V2X application-specific server (110) to perform operations comprising:
transmitting (3203) a user equipment, UE, measurements configuration request to a vehicle-to everything, V2X, application enabler, VAE, server (108);
receiving (3205) a UE measurements configuration response from the VAE server (108); and
processing (3207) the UE measurements configuration response.
   79. The V2X application-specific server of Embodiment 72 wherein the memory comprises further instructions that when executed by the processing circuitry (2203) causes the V2X application-specific server (110) to perform operations according to any of Embodiments 63-77.
   80. A vehicle-to everything, V2X, application-specific server (110) adapted to perform operations comprising:

transmitting (3203) a user equipment, UE, measurements configuration request to a vehicle-to everything, V2X, application enabler, VAE, server (108);

receiving (3205) a UE measurements configuration response from the VAE server (108); and

processing (3207) the UE measurements configuration response.

81. The V2X application-specific server of Embodiment 80 wherein the V2X, application-specific server (110) is further adapted to perform operations according to any of Embodiments 64-77.
82. A computer program comprising program code to be executed by processing circuitry (2203) of a vehicle-to everything, V2X, application-specific server (110), whereby execution of the program code causes the V2X application-specific server (110) to perform operations comprising:

transmitting (3203) a user equipment, UE, measurements configuration request to a vehicle-to everything, V2X, application enabler, VAE, server (108);

receiving (3205) a UE measurements configuration response from the VAE server (108); and

processing (3207) the UE measurements configuration response.

83. The computer program of Embodiment 82 wherein the program code causes the V2X application-specific server (110) to perform operations according to any of Embodiments 63-71.
84. A computer program product comprising a non-transitory storage medium including program code to be executed by processing circuitry (2203) of a vehicle-to everything, V2X, application-specific server (110), whereby execution of the program code causes the V2X application-specific server (110) to perform operations comprising:

transmitting (3203) a user equipment, UE, measurements configuration request to a vehicle-to everything, V2X, application enabler, VAE, server (108);

receiving (3205) a UE measurements configuration response from the VAE server (108); and

processing (3207) the UE measurements configuration response.

85. The computer program of Embodiment 84 wherein the program code causes the V2X application-specific server (110) to perform operations according to any of Embodiments 64-77.
86. A method performed by a vehicle-to everything, V2X, application enabler, VAE, server (108), the method comprising:

receiving (3601) a user equipment, UE, measurements configuration request from one of a vehicle-to everything, V2X, application-specific server (110) or a VAE client (102);

processing (3603) the UE measurements configuration request; and

transmitting (3607) a UE measurements configuration response to the one of the V2X application-specific server (110) or the VAE client (102).

87. The method of Embodiment 86, further comprising specifying (3605) information for the UE measurements configuration response, the information comprising one or more of:

an indication that the UE measurements configuration request has not been accepted;

a list of UE measurements the VAE server (108) is interested in receiving;

one or more V2X application-specific client identifiers, IDs;

one or more V2X service IDs;

an application flow description;

a geo ID;

one or more time windows; and

measurements filter information.

88. The method of any of Embodiments 86-87 wherein the UE measurements configuration request comprises information including one or more of:

a list of UE measurements the one of the V2X application-specific server (110) or the VAE client (102) can provide to the VAE server (108) that are generated at the V2X application-specific server (110) or from a V2X application-specific client (100);

one or more V2X application-specific client identifiers, IDs;

a V2X application-specific server ID of the V2X application-specific server;

one or more V2X service IDs; and

an application flow description.

89. The method of any of Embodiments 86-88 wherein processing the UE measurements configuration request comprises determining at least one of:

checking (3701) whether the UE measurements configuration request can be accepted by determining whether reception of UE measurements is supported and whether UE measurements can be used at the VAE server (108); and

determining (3705) which UE measurements should be provided and their associated geographical areas, time windows, measurement frequency, and measurement filter information.

90. The method of any of Embodiments 86-89 further comprising:

responsive to the UE measurements configuration request being accepted, storing (3703) configuration information of the UE measurements from the V2X application-specific server (110).

91. The method of any of Embodiments 86-90 further comprising:

transmitting (3801) a UE measurements configuration cancel request to the one of the V2X application-specific server (110) or the VAE client (102); and

receiving (3803) a UE measurements configuration cancel response from the one of the V2X application-specific server (110) or the VAE client (102).

92. The method of Embodiment 91 wherein transmitting the UE measurement configuration cancel request comprises transmitting the UE measurement configuration cancel request responsive to a trigger occurring.
93. The method of Embodiment 92 wherein the trigger comprises at least one of:

the VAE server (108) stopping tasks to which the UE measurements were associated with; and

a load of the VAE server (108) being above a threshold level or at the threshold level.

94. The method of any of Embodiments 86-90 further comprising:

receiving (3901) a UE measurements configuration cancel request from the one of the V2X application-specific server (110) or the VAE client (102) and

transmitting (3903) a UE measurements configuration cancel response to the one of the V2X application-specific server (110) or the VAE client (102).

95. The method of Embodiment 94 wherein the UE measurements configuration cancel request comprises at least one of a V2X application-specific client ID and a V2X service ID.
96. The method of Embodiment 94 wherein responsive to no information being included in the UE measurements configuration cancel request, canceling all previously configured UE measurements associated with the one of the V2X application-specific server (110) or the VAE client (102).
97. The method of any of Embodiments 86-96, further comprising:

transmitting (4003) a user equipment, UE, measurements configuration request to a vehicle-to everything, V2X, application-specific server (110);

receiving (4005) a UE measurements configuration response from the V2X application-specific server (110); and

processing (4007) the UE measurements configuration response.

98. The method of Embodiment 97 further comprising specifying (4001) information for the UE measurements configuration request, the information comprising one or more of:

a list of UE measurements the VAE server (108) is interested in receiving;

one or more V2X application-specific client identifiers, IDs;

one or more V2X service IDs;

an application flow description;

a geo ID;

one or more time windows; and

measurements filter information.

99. The method of any of Embodiments 97-98, wherein the UE measurements configuration response comprises information including one or more of:

an indication that the UE measurements configuration request has not been accepted;

a list of UE measurements the V2X application-specific server (110) can provide to the VAE server (108) that are generated at the V2X application-specific server (110) or from a V2X application-specific client (100);

one or more V2X application-specific client identifiers, IDs;

a V2X application-specific server ID of the V2X application-specific server;

one or more V2X service IDs; and

an application flow description.

100. A vehicle-to everything, V2X, application enabler, VAE, server (108) comprising:

processing circuitry (2103); and

memory (2105) coupled with the processing circuitry (2103), wherein the memory includes instructions that when executed by the processing circuitry (2103) causes the VAE server (108) to perform operations comprising:
receiving (3501) a user equipment, UE, measurements configuration request from one of a vehicle-to everything, V2X, application-specific server (110) or a VAE client (102);
processing (3503) the UE measurements configuration request; and
transmitting (3507) a UE measurements configuration response to the one of the V2X application-specific server (110) or the VAE client (102).
   101. The VAE server (108) of Embodiment 100 wherein the memory comprises further instructions that when executed by the processing circuitry (2103) causes the VAE server (108) to perform operations according to any of Embodiments 87-99.
   102. A vehicle-to everything, V2X, application enabler, VAE, server (108) adapted to perform operations comprising:

receiving (3601) a user equipment, UE, measurements configuration request from one of a vehicle-to everything, V2X, application-specific server (110) or a VAE client (102);

processing (3603) the UE measurements configuration request; and

transmitting (3607) a UE measurements configuration response to the one of the V2X application-specific server (110) or the VAE client (102).

103. The VAE server (108) of Embodiment 102 wherein the V2X, application-specific server (110) is further adapted to perform operations according to any of Embodiments 87-99.
104. A computer program comprising program code to be executed by processing circuitry (2103) of a vehicle-to everything, V2X, application enabler, VAE, server (108), whereby execution of the program code causes the VAE server (108) to perform operations comprising:

receiving (3601) a user equipment, UE, measurements configuration request from one of a vehicle-to everything, V2X, application-specific server (110) or a VAE client (102);

processing (3603) the UE measurements configuration request; and

transmitting (3607) a UE measurements configuration response to the one of the V2X application-specific server (110) or the VAE client (102).

105. The computer program of Embodiment 104 wherein the program code causes the VAE server (108) to perform operations according to any of Embodiments 87-99.
106. A computer program product comprising a non-transitory storage medium including program code to be executed by processing circuitry (2103) of a vehicle-to everything, V2X, application enabler, VAE, server (108), whereby execution of the program code causes the VAE server (108) to perform operations comprising:

receiving (3601) a user equipment, UE, measurements configuration request from one of a vehicle-to everything, V2X, application-specific server (110) or a VAE client (102);

processing (3603) the UE measurements configuration request; and

transmitting (3607) a UE measurements configuration response to the one of the V2X application-specific server (110) or the VAE client (102).

107. The computer program of Embodiment 106 wherein the program code causes the VAE, server (108) to perform operations according to any of Embodiments 87-99.
108. A method performed by a vehicle-to everything, V2X, application-specific client (100), the method comprising:

transmitting (4103) a user equipment, UE, measurements configuration request towards a vehicle-to everything, V2X, application enabler, VAE, server;

receiving (4105) a UE measurements configuration response from the VAE server; and

processing (4107) the UE measurements configuration response.

109. The method of Embodiment 108 wherein transmitting the UE measurements configuration request comprises transmitting the UE measurements configuration request responsive to a trigger occurring.
110. The method of Embodiment 109 wherein the trigger comprises at least one of:

obtaining awareness of support of UE measurements configuration by the VAE server 108;

determining that receiving a QoS notification by the V2X application-specific server (110) is associated with support of UE measurements;

determining that specific applications or services are active;

determining that the V2X application-specific client (100) is at a specific geographic location; and

determining that the V2X application-specific client (100) is within a specified time window.

111. The method of any of Embodiments 108-110, further comprising specifying (4101) information for the UE measurements configuration request, the information comprising one or more of:

a list of UE measurements the V2X application-specific client (100) can provide to the VAE server (108);

one or more V2X application-specific client identifiers, IDs;

a V2X application-specific server ID of the V2X application-specific server;

one or more V2X service IDs; and

an application flow description.

112. The method of any of Embodiments 108-111 wherein the UE measurements configuration response comprises information including one or more of:

an indication that the UE measurements configuration request has not been accepted;

a list of desired UE measurements comprising UE measurements the VAE server (108) is interested in receiving;

one or more V2X application-specific client identifiers, IDs;

a V2X service ID;

an application flow description;

a geo ID;

one or more time windows; and

measurements filter information.

113. The method of any of Embodiments 108-112 wherein processing the UE measurements configuration response comprises configuring UE measurement reporting according to the information in the UE measurements configuration response.
114. The method of any of Embodiments 108-113 further comprising:

receiving (4201) a UE measurements configuration cancel request from the VAE server (108);

invalidating (4203) UE measurements indicated in the UE measurements configuration cancel request; and

transmitting (4207) a UE measurements configuration cancel response towards the VAE server (108).

115. The method of Embodiment 114, wherein invalidating the UE measurements comprises suspending ongoing UE measurements reporting for UE measurements indicated in the UE measurements configuration cancel request.
116. The method of Embodiment 114 wherein responsive to no information being included in the UE measurements configuration cancel request, canceling (4205) all previously configured UE measurements.
117. The method of any of Embodiments 108-113 further comprising:

invalidating (4301) UE measurements configuration of at least one UE measurement;

transmitting (4303) a UE measurements configuration cancel request towards the VAE server (108); and

receiving (4305) a UE measurements configuration cancel response from the VAE server (108).

118. The method of Embodiment 117 wherein the UE measurements configuration cancel request comprises at least one of a V2X application-specific client ID and a V2X service ID.
119. The method of Embodiment 117 wherein responsive to the at least one UE measurement being all UE measurements, providing no information on UE measurements to cancel in the UE measurements configuration cancel request.
120. The method of any of Embodiments 117-119 wherein invalidating the UE measurement configuration comprises invalidating the UE measurements configuration responsive to a trigger occurring.
121. The method of Embodiment 120 wherein the trigger comprises at least one of:

the V2X application-specific client (100) stopping traffic to which the UE measurements were associated with; and

changes in traffic configuration of an application prioritizing other traffic such that the V2X application-specific client or the V2X application-specific server cannot send UE measurements.

122. The method of any of Embodiments 108-121 wherein the V2X application-specific client (100) communicates with the VAE server (108) via a VAE client (102).
123. A vehicle-to everything, V2X, application-specific client (100) comprising:

processing circuitry (2003); and

memory (2005) coupled with the processing circuitry (2003), wherein the memory includes instructions that when executed by the processing circuitry (2003) causes the V2X application-specific client (100) to perform operations comprising:
transmitting (4003) a user equipment, UE, measurements configuration request towards a vehicle-to everything, V2X, application enabler, VAE, server;
receiving (4005) a UE measurements configuration response from the VAE server; and
processing (4007) the UE measurements configuration response.
   124. The V2X application-specific client (100) of Embodiment 123 wherein the memory comprises further instructions that when executed by the processing circuitry (2003) causes the V2X application-specific client (100) to perform operations according to any of Embodiments 109-122.
   125. A vehicle-to everything, V2X, application-specific client (100) adapted to perform operations comprising:

transmitting (4103) a user equipment, UE, measurements configuration request towards a vehicle-to everything, V2X, application enabler, VAE, server;

receiving (4105) a UE measurements configuration response from the VAE server; and

processing (4107) the UE measurements configuration response.

126. The V2X application-specific client (100) of Embodiment 125 wherein the V2X application-specific client (100) is further adapted to perform operations according to any of Embodiments 109-122.
127. A computer program comprising program code to be executed by processing circuitry (2003) of a vehicle-to everything, V2X, application-specific client (100), whereby execution of the program code causes the V2X application-specific client (100) to perform operations comprising:

transmitting (4103) a user equipment, UE, measurements configuration request towards a vehicle-to everything, V2X, application enabler, VAE, server;

receiving (4105) a UE measurements configuration response from the VAE server; and

processing (4107) the UE measurements configuration response.

128. The computer program of Embodiment 127 wherein the program code causes the V2X application-specific client (100) to perform operations according to any of Embodiments 109-122.
129. A computer program product comprising a non-transitory storage medium including program code to be executed by processing circuitry (2003) of a vehicle-to everything, V2X, application-specific client (100), whereby execution of the program code causes the V2X application-specific client (100) to perform operations comprising:

transmitting (4103) a user equipment, UE, measurements configuration request towards a vehicle-to everything, V2X, application enabler, VAE, server;

receiving (4105) a UE measurements configuration response from the VAE server; and

processing (4107) the UE measurements configuration response.

130. The computer program of Embodiment 129 wherein the program code causes the V2X application-specific client (100) to perform operations according to any of Embodiments 109-122.
131. A method performed by a vehicle-to everything, V2X, application enabler, VAE, client (102), the method comprising:

receiving (4401) a user equipment, UE, measurements configuration request from a vehicle-to everything, V2X, application-specific client (100);

processing (4403) the UE measurements configuration request;

transmitting (4405) the UE measurements configuration request to a vehicle-to everything, V2X, application enabler, VAE, server (108);

receiving (4407) a UE measurements configuration response from the VAE server;

processing (4409) the UE measurements configuration response; and

transmitting (4411) the UE measurements configuration request to the V2X application-specific client (100).

132. The method of Embodiment 131, wherein processing the UE measurements configuration request comprises at least one of:

determining (4501) a VAE server (108) to send the UE measurements configuration request to;

determining (4503) whether or not the UE measurements configuration request can be accepted by determining whether or not reception of UE measurements is supported by the VAE server (108); and

updating (4505) or translating parameters included in the UE measurements configuration request.

133. The method of any of Embodiments 131-132 wherein processing the UE measurements configuration response comprises:

responsive to the UE measurements configuration response indicating an acceptance of the UE measurements configuration request, storing configuration information of the UE measurements indicated in the UE measurement configuration response reporting based on the information in the UE measurements configuration response.

134. The method of any of Embodiments 131-132 further comprising:

responsive to determining that the UE measurements configuration cannot be accepted, transmitting a response to the V2X application-specific client indicating failure of the UE measurements configuration request.

135. The method of any of Embodiments 131-133 further comprising:

receiving (4601) a UE measurements configuration cancel request from the VAE server (108);

determining (4603) which V2X application-specific client (100) to send the UE measurements configuration cancel request;

transmitting (4605) the UE measurements configuration cancel request to the V2X application-specific client (100) determined;

receiving (4607) a UE measurements configuration cancel response from the V2X application-specific client (100) determined;

processing (4609) the UE measurements configuration cancel response; and transmitting (4611) the UE measurements configuration cancel response to the VAE server (108).

136. The method of any of Embodiments 131-133 further comprising:

receiving (4701) a UE measurements configuration cancel request from the V2X application-specific client (100);

processing (4703) the UE measurements configuration cancel request;

transmitting (4705) the UE measurements configuration cancel request to the VAE server (108);

receiving (4707) a UE measurements configuration cancel response from the VAE server (108);

processing (4709) the UE measurements configuration cancel response; and

transmitting (4711) the UE measurements configuration cancel response to the V2X application-specific client (100).

137. A vehicle-to everything, V2X, application enabler, VAE, client (102) comprising:

processing circuitry (2003); and

memory (2005) coupled with the processing circuitry (2003), wherein the memory includes instructions that when executed by the processing circuitry (2003) causes the VAE client (102) to perform operations comprising:
receiving (4401) a user equipment, UE, measurements configuration request from a vehicle-to everything, V2X, application-specific client (100);
processing (4403) the UE measurements configuration request;
transmitting (4405) the UE measurements configuration request to a vehicle-to everything, V2X, application enabler, VAE, server (108);
receiving (4307) a UE measurements configuration response from the VAE server;
processing (4409) the UE measurements configuration response; and
transmitting (4411) the UE measurements configuration request to the V2X application-specific client (100).
   138. The VAE client (102) of Embodiment 137 wherein the memory comprises further instructions that when executed by the processing circuitry (2003) causes the VAE client (102) to perform operations according to any of Embodiments 132-136.
   139. A vehicle-to everything, V2X, application enabler, VAE, client (102) adapted to perform operations comprising:

receiving (4401) a user equipment, UE, measurements configuration request from a vehicle-to everything, V2X, application-specific client (100);

processing (4403) the UE measurements configuration request;

transmitting (4405) the UE measurements configuration request to a vehicle-to everything, V2X, application enabler, VAE, server (108);

receiving (4407) a UE measurements configuration response from the VAE server;

processing (4409) the UE measurements configuration response; and

transmitting (4411) the UE measurements configuration request to the V2X application-specific client (100).

140. The VAE client (102) of Embodiment 139 wherein the VAE client (102) is further adapted to perform operations according to any of Embodiments 132-136.
141. A computer program comprising program code to be executed by processing circuitry (2003) of a vehicle-to everything, V2X, application enabler, VAE, client (102), whereby execution of the program code causes the VAE client (102) to perform operations comprising:

receiving (4401) a user equipment, UE, measurements configuration request from a vehicle-to everything, V2X, application-specific client (100);

processing (4403) the UE measurements configuration request;

transmitting (4405) the UE measurements configuration request to a vehicle-to everything, V2X, application enabler, VAE, server (108);

receiving (4407) a UE measurements configuration response from the VAE server;

processing (4409) the UE measurements configuration response; and

transmitting (4411) the UE measurements configuration request to the V2X application-specific client (100).

142. The computer program of Embodiment 141 wherein the program code causes the VAE client (102) to perform operations according to any of Embodiments 132-136.
143. A computer program product comprising a non-transitory storage medium including program code to be executed by processing circuitry (2003) of a vehicle-to everything, V2X, application enabler, VAE, client (102), whereby execution of the program code causes the VAE client (102) to perform operations comprising:

receiving (4301) a user equipment, UE, measurements configuration request from a vehicle-to everything, V2X, application-specific client (100);

processing (4403) the UE measurements configuration request;

transmitting (4405) the UE measurements configuration request to a vehicle-to everything, V2X, application enabler, VAE, server (108);

receiving (4407) a UE measurements configuration response from the VAE server;

processing (4409) the UE measurements configuration response; and

transmitting (4411) the UE measurements configuration request to the V2X application-specific client (100).

144. The computer program of Embodiment 143 wherein the program code causes the VAE client (102) to perform operations according to any of Embodiments 132-136. Explanations are provided below for various abbreviations/acronyms used in the present disclosure.

| Abbreviation | Explanation |
|---|---|
| 3GPP | 3rd Generation Partnership Project |
| 5GAA | 5G Automotive Association |
| 5GS | 5G System |
| 5QI | 5G QoS Identifier |
| AF | Application Function |
| BS | Base Station |
| CN | Core Network |
| CDF | Cumulative Distribution Function |
| eNB | E-UTRAN NodeB |
| GBR | Guaranteed Bit Rate |
| GEO ID | Geographic Identifier |
| GFBR | Guaranteed Flow Bit Rate |
| gNB | Base station in NRGSM Global System for Mobile |
| | Communications |
| KPI | Key Performance Indicator |
| LAN | Local Area Network |
| LTE | Long Term Evolution |
| NEF | Network Exposure Function |
| NG | Next Generation |
| NR | New Radio |
| NWDAF | Network Data Analytics Function |
| OAM | Operations, Administration and Maintenance |
| PCF | Policy Control Function |
| PDCP | Packet Data Convergence Protocol |
| PDB | Packet Delay Budget |
| PER | Packet Error Rate |
| PSTN | Public Switched Telephone Networks |
| QoS | Quality of Service |
| RAN | Radio Access Network |
| RNC | Radio Network Controller |
| SNI | Server Name Indication |
| SMF | Session Management Function |
| SON | Self Optimized Network |
| S-NSSAI | Single-Network Slice Selection Assistance Information |
| V2X | Vehicle to everything |
| VAE | V2X application enabler |
| UE | User Equipment |
| UMTS | Universal Mobile Telecommunications System |
| UTRAN | Universal Terrestrial Radio Access Network |
| WCDMA | Wide CDMA |
| WAN | Wide-Area Network |
| WiMax | Worldwide Interoperability for Microwave Access |

References are identified below.

3GPP TS 23.287, Architecture enhancements for 5G System (5GS) to support Vehicle-to-Everything (V2X) services, V16.1.0, 12-2019

3GPP TS 23.288, Architecture enhancements for 5G System (5GS) to support network data analytics services, V16.2.0, 12-2019

“Making 5G Proactive and Predictive for the Automotive Industry,” white paper by the 5GAA Automotive Association, V1.0, 9 Dec. 2019.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 48 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 48. For simplicity, the wireless network of FIG. 48 only depicts network 4808, network nodes 4860 and 4860b, and WDs 4810, 4810b, and 4810c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4860 and wireless device (WD) 4810 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4808 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4860 and WD 4810 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 48, network node 4860 includes processing circuitry 4870, device readable medium 4880, interface 4890, auxiliary equipment 4884, power source 4886, power circuitry 4887, and antenna 4862. Although network node 4860 illustrated in the example wireless network of FIG. 48 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4860 are depicted as single boxes located within a larger box, or nested within multiple boxes, in practice, a network node may comprise multiple different physical components that make up a single illustrated component (e.g., device readable medium 4880 may comprise multiple separate hard drives as well as multiple RAM modules).

Similarly, network node 4860 may be composed of multiple physically separate components (e.g., a NodeB component and a RNC component, or a BTS component and a BSC component, etc.), which may each have their own respective components. In certain scenarios in which network node 4860 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4860 may be configured to support multiple radio access technologies (RATs). In such embodiments, some components may be duplicated (e.g., separate device readable medium 4880 for the different RATs) and some components may be reused (e.g., the same antenna 4862 may be shared by the RATs). Network node 4860 may also include multiple sets of the various illustrated components for different wireless technologies integrated into network node 4860, such as, for example, GSM, WCDMA, LTE, NR, WiFi, or Bluetooth wireless technologies. These wireless technologies may be integrated into the same or different chip or set of chips and other components within network node 4860.

Processing circuitry 4870 is configured to perform any determining, calculating, or similar operations (e.g., certain obtaining operations) described herein as being provided by a network node. These operations performed by processing circuitry 4870 may include processing information obtained by processing circuitry 4870 by, for example, converting the obtained information into other information, comparing the obtained information or converted information to information stored in the network node, and/or performing one or more operations based on the obtained information or converted information, and as a result of said processing making a determination.

Processing circuitry 4870 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4860 components, such as device readable medium 4880, network node 4860 functionality. For example, processing circuitry 4870 may execute instructions stored in device readable medium 4880 or in memory within processing circuitry 4870. Such functionality may include providing any of the various wireless features, functions, or benefits discussed herein. In some embodiments, processing circuitry 4870 may include a system on a chip (SOC).

In some embodiments, processing circuitry 4870 may include one or more of radio frequency (RF) transceiver circuitry 4872 and baseband processing circuitry 4874. In some embodiments, radio frequency (RF) transceiver circuitry 4872 and baseband processing circuitry 4874 may be on separate chips (or sets of chips), boards, or units, such as radio units and digital units. In alternative embodiments, part or all of RF transceiver circuitry 4872 and baseband processing circuitry 4874 may be on the same chip or set of chips, boards, or units

In certain embodiments, some or all of the functionality described herein as being provided by a network node, base station, eNB or other such network device may be performed by processing circuitry 4870 executing instructions stored on device readable medium 4880 or memory within processing circuitry 4870. In alternative embodiments, some or all of the functionality may be provided by processing circuitry 4870 without executing instructions stored on a separate or discrete device readable medium, such as in a hard-wired manner. In any of those embodiments, whether executing instructions stored on a device readable storage medium or not, processing circuitry 4870 can be configured to perform the described functionality. The benefits provided by such functionality are not limited to processing circuitry 4870 alone or to other components of network node 4860, but are enjoyed by network node 4860 as a whole, and/or by end users and the wireless network generally.

Device readable medium 4880 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4870. Device readable medium 4880 may store any suitable instructions, data or information, including a computer program, software, an application including one or more of logic, rules, code, tables, etc. and/or other instructions capable of being executed by processing circuitry 4870 and, utilized by network node 4860. Device readable medium 4880 may be used to store any calculations made by processing circuitry 4870 and/or any data received via interface 4890. In some embodiments, processing circuitry 4870 and device readable medium 4880 may be considered to be integrated.

Interface 4890 is used in the wired or wireless communication of signalling and/or data between network node 4860, network 4808, and/or WDs 4810. As illustrated, interface 4890 comprises port(s)/terminal(s) 4894 to send and receive data, for example to and from network 4808 over a wired connection. Interface 4890 also includes radio front end circuitry 4892 that may be coupled to, or in certain embodiments a part of, antenna 4862. Radio front end circuitry 4892 comprises filters 4898 and amplifiers 4896. Radio front end circuitry 4892 may be connected to antenna 4862 and processing circuitry 4870. Radio front end circuitry may be configured to condition signals communicated between antenna 4862 and processing circuitry 4870. Radio front end circuitry 4892 may receive digital data that is to be sent out to other network nodes or WDs via a wireless connection. Radio front end circuitry 4892 may convert the digital data into a radio signal having the appropriate channel and bandwidth parameters using a combination of filters 4898 and/or amplifiers 4896. The radio signal may then be transmitted via antenna 4862. Similarly, when receiving data, antenna 4862 may collect radio signals which are then converted into digital data by radio front end circuitry 4892. The digital data may be passed to processing circuitry 4870. In other embodiments, the interface may comprise different components and/or different combinations of components.

In certain alternative embodiments, network node 4860 may not include separate radio front end circuitry 4892, instead, processing circuitry 4870 may comprise radio front end circuitry and may be connected to antenna 4862 without separate radio front end circuitry 4892. Similarly, in some embodiments, all or some of RF transceiver circuitry 4872 may be considered a part of interface 4890. In still other embodiments, interface 4890 may include one or more ports or terminals 4894, radio front end circuitry 4892, and RF transceiver circuitry 4872, as part of a radio unit (not shown), and interface 4890 may communicate with baseband processing circuitry 4874, which is part of a digital unit (not shown).

Antenna 4862 may include one or more antennas, or antenna arrays, configured to send and/or receive wireless signals. Antenna 4862 may be coupled to radio front end circuitry 4890 and may be any type of antenna capable of transmitting and receiving data and/or signals wirelessly. In some embodiments, antenna 4862 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 4862 may be separate from network node 4860 and may be connectable to network node 4860 through an interface or port.

Antenna 4862, interface 4890, and/or processing circuitry 4870 may be configured to perform any receiving operations and/or certain obtaining operations described herein as being performed by a network node. Any information, data and/or signals may be received from a wireless device, another network node and/or any other network equipment. Similarly, antenna 4862, interface 4890, and/or processing circuitry 4870 may be configured to perform any transmitting operations described herein as being performed by a network node. Any information, data and/or signals may be transmitted to a wireless device, another network node and/or any other network equipment.

Power circuitry 4887 may comprise, or be coupled to, power management circuitry and is configured to supply the components of network node 4860 with power for performing the functionality described herein. Power circuitry 4887 may receive power from power source 4886. Power source 4886 and/or power circuitry 4887 may be configured to provide power to the various components of network node 4860 in a form suitable for the respective components (e.g., at a voltage and current level needed for each respective component). Power source 4886 may either be included in, or external to, power circuitry 4887 and/or network node 4860. For example, network node 4860 may be connectable to an external power source (e.g., an electricity outlet) via an input circuitry or interface such as an electrical cable, whereby the external power source supplies power to power circuitry 4887. As a further example, power source 4886 may comprise a source of power in the form of a battery or battery pack which is connected to, or integrated in, power circuitry 4887. The battery may provide backup power should the external power source fail. Other types of power sources, such as photovoltaic devices, may also be used.

Alternative embodiments of network node 4860 may include additional components beyond those shown in FIG. 48 that may be responsible for providing certain aspects of the network node's functionality, including any of the functionality described herein and/or any functionality necessary to support the subject matter described herein. For example, network node 4860 may include user interface equipment to allow input of information into network node 4860 and to allow output of information from network node 4860. This may allow a user to perform diagnostic, maintenance, repair, and other administrative functions for network node 4860.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4810 includes antenna 4811, interface 4814, processing circuitry 4820, device readable medium 4830, user interface equipment 4832, auxiliary equipment 4834, power source 4836 and power circuitry 4837. WD 4810 may include multiple sets of one or more of the illustrated components for different wireless technologies supported by WD 4810, such as, for example, GSM, WCDMA, LTE, NR, WiFi, WiMAX, or Bluetooth wireless technologies, just to mention a few. These wireless technologies may be integrated into the same or different chips or set of chips as other components within WD 4810.

Antenna 4811 may include one or more antennas or antenna arrays, configured to send and/or receive wireless signals, and is connected to interface 4814. In certain alternative embodiments, antenna 4811 may be separate from WD 4810 and be connectable to WD 4810 through an interface or port. Antenna 4811, interface 4814, and/or processing circuitry 4820 may be configured to perform any receiving or transmitting operations described herein as being performed by a WD. Any information, data and/or signals may be received from a network node and/or another WD. In some embodiments, radio front end circuitry and/or antenna 4811 may be considered an interface.

As illustrated, interface 4814 comprises radio front end circuitry 4812 and antenna 4811. Radio front end circuitry 4812 comprise one or more filters 4818 and amplifiers 4816. Radio front end circuitry 4814 is connected to antenna 4811 and processing circuitry 4820, and is configured to condition signals communicated between antenna 4811 and processing circuitry 4820. Radio front end circuitry 4812 may be coupled to or a part of antenna 4811. In some embodiments, WD 4810 may not include separate radio front end circuitry 4812; rather, processing circuitry 4820 may comprise radio front end circuitry and may be connected to antenna 4811. Similarly, in some embodiments, some or all of RF transceiver circuitry 4822 may be considered a part of interface 4814. Radio front end circuitry 4812 may receive digital data that is to be sent out to other network nodes or WDs via a wireless connection. Radio front end circuitry 4812 may convert the digital data into a radio signal having the appropriate channel and bandwidth parameters using a combination of filters 4818 and/or amplifiers 4816. The radio signal may then be transmitted via antenna 4811. Similarly, when receiving data, antenna 4811 may collect radio signals which are then converted into digital data by radio front end circuitry 4812. The digital data may be passed to processing circuitry 4820. In other embodiments, the interface may comprise different components and/or different combinations of components.

Processing circuitry 4820 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4810 components, such as device readable medium 4830, WD 4810 functionality. Such functionality may include providing any of the various wireless features or benefits discussed herein. For example, processing circuitry 4820 may execute instructions stored in device readable medium 4830 or in memory within processing circuitry 4820 to provide the functionality disclosed herein.

As illustrated, processing circuitry 4820 includes one or more of RF transceiver circuitry 4822, baseband processing circuitry 4824, and application processing circuitry 4826. In other embodiments, the processing circuitry may comprise different components and/or different combinations of components. In certain embodiments processing circuitry 4820 of WD 4810 may comprise a SOC. In some embodiments, RF transceiver circuitry 4822, baseband processing circuitry 4824, and application processing circuitry 4826 may be on separate chips or sets of chips. In alternative embodiments, part or all of baseband processing circuitry 4824 and application processing circuitry 4826 may be combined into one chip or set of chips, and RF transceiver circuitry 4822 may be on a separate chip or set of chips. In still alternative embodiments, part or all of RF transceiver circuitry 4822 and baseband processing circuitry 4824 may be on the same chip or set of chips, and application processing circuitry 4826 may be on a separate chip or set of chips. In yet other alternative embodiments, part or all of RF transceiver circuitry 4822, baseband processing circuitry 4824, and application processing circuitry 4826 may be combined in the same chip or set of chips. In some embodiments, RF transceiver circuitry 4822 may be a part of interface 4814. RF transceiver circuitry 4822 may condition RF signals for processing circuitry 4820.

In certain embodiments, some or all of the functionality described herein as being performed by a WD may be provided by processing circuitry 4820 executing instructions stored on device readable medium 4830, which in certain embodiments may be a computer-readable storage medium. In alternative embodiments, some or all of the functionality may be provided by processing circuitry 4820 without executing instructions stored on a separate or discrete device readable storage medium, such as in a hard-wired manner. In any of those particular embodiments, whether executing instructions stored on a device readable storage medium or not, processing circuitry 4820 can be configured to perform the described functionality. The benefits provided by such functionality are not limited to processing circuitry 4820 alone or to other components of WD 4810, but are enjoyed by WD 4810 as a whole, and/or by end users and the wireless network generally.

Processing circuitry 4820 may be configured to perform any determining, calculating, or similar operations (e.g., certain obtaining operations) described herein as being performed by a WD. These operations, as performed by processing circuitry 4820, may include processing information obtained by processing circuitry 4820 by, for example, converting the obtained information into other information, comparing the obtained information or converted information to information stored by WD 4810, and/or performing one or more operations based on the obtained information or converted information, and as a result of said processing making a determination.

Device readable medium 4830 may be operable to store a computer program, software, an application including one or more of logic, rules, code, tables, etc. and/or other instructions capable of being executed by processing circuitry 4820. Device readable medium 4830 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4820. In some embodiments, processing circuitry 4820 and device readable medium 4830 may be considered to be integrated.

User interface equipment 4832 may provide components that allow for a human user to interact with WD 4810. Such interaction may be of many forms, such as visual, audial, tactile, etc. User interface equipment 4832 may be operable to produce output to the user and to allow the user to provide input to WD 4810. The type of interaction may vary depending on the type of user interface equipment 4832 installed in WD 4810. For example, if WD 4810 is a smart phone, the interaction may be via a touch screen; if WD 4810 is a smart meter, the interaction may be through a screen that provides usage (e.g., the number of gallons used) or a speaker that provides an audible alert (e.g., if smoke is detected). User interface equipment 4832 may include input interfaces, devices and circuits, and output interfaces, devices and circuits. User interface equipment 4832 is configured to allow input of information into WD 4810, and is connected to processing circuitry 4820 to allow processing circuitry 4820 to process the input information. User interface equipment 4832 may include, for example, a microphone, a proximity or other sensor, keys/buttons, a touch display, one or more cameras, a USB port, or other input circuitry. User interface equipment 4832 is also configured to allow output of information from WD 4810, and to allow processing circuitry 4820 to output information from WD 4810. User interface equipment 4832 may include, for example, a speaker, a display, vibrating circuitry, a USB port, a headphone interface, or other output circuitry. Using one or more input and output interfaces, devices, and circuits, of user interface equipment 4832, WD 4810 may communicate with end users and/or the wireless network, and allow them to benefit from the functionality described herein.

Auxiliary equipment 4834 is operable to provide more specific functionality which may not be generally performed by WDs. This may comprise specialized sensors for doing measurements for various purposes, interfaces for additional types of communication such as wired communications etc. The inclusion and type of components of auxiliary equipment 4834 may vary depending on the embodiment and/or scenario.

Power source 4836 may, in some embodiments, be in the form of a battery or battery pack. Other types of power sources, such as an external power source (e.g., an electricity outlet), photovoltaic devices or power cells, may also be used. WD 4810 may further comprise power circuitry 4837 for delivering power from power source 4836 to the various parts of WD 4810 which need power from power source 4836 to carry out any functionality described or indicated herein. Power circuitry 4837 may in certain embodiments comprise power management circuitry. Power circuitry 4837 may additionally or alternatively be operable to receive power from an external power source; in which case WD 4810 may be connectable to the external power source (such as an electricity outlet) via input circuitry or an interface such as an electrical power cable. Power circuitry 4837 may also in certain embodiments be operable to deliver power from an external power source to power source 4836. This may be, for example, for the charging of power source 4836. Power circuitry 4837 may perform any formatting, converting, or other modification to the power from power source 4836 to make the power suitable for the respective components of WD 4810 to which power is supplied.

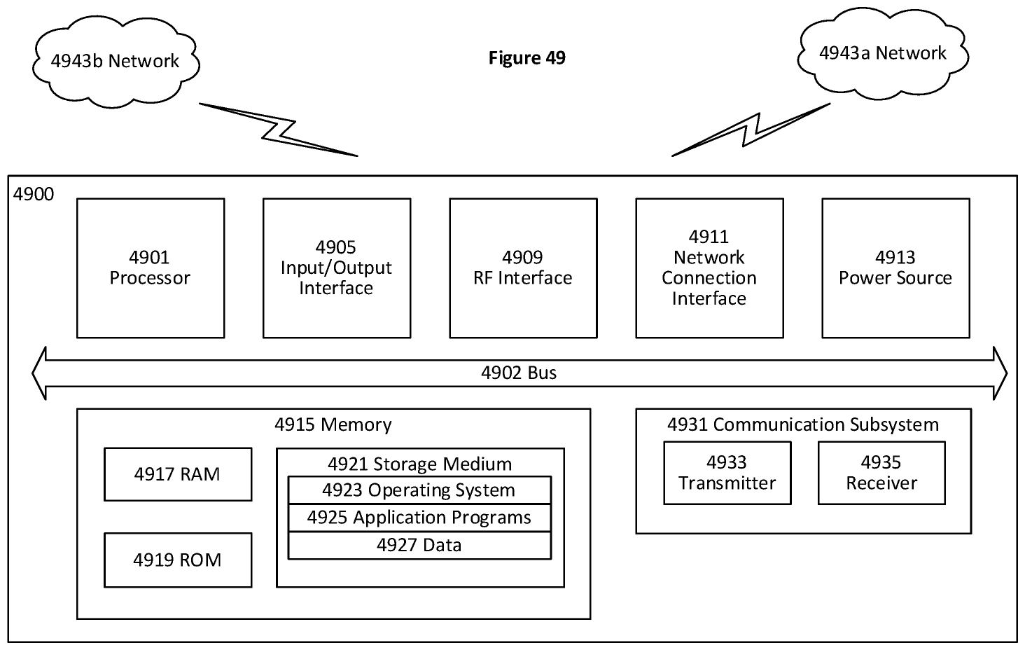

FIG. 49 illustrates a user Equipment in accordance with some embodiments.

FIG. 49 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 4900 may be any UE identified by the 3rd Generation Partnership Project (3GPP), including a NB-IoT UE, a machine type communication (MTC) UE, and/or an enhanced MTC (eMTC) UE. UE 4900, as illustrated in FIG. 49, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 49 is a UE, the components discussed herein are equally applicable to a WD, and vice-versa.

In FIG. 49, UE 4900 includes processing circuitry 4901 that is operatively coupled to input/output interface 4905, radio frequency (RF) interface 4909, network connection interface 4911, memory 4915 including random access memory (RAM) 4917, read-only memory (ROM) 4919, and storage medium 4921 or the like, communication subsystem 4931, power source 4933, and/or any other component, or any combination thereof. Storage medium 4921 includes operating system 4923, application program 4925, and data 4927. In other embodiments, storage medium 4921 may include other similar types of information. Certain UEs may utilize all of the components shown in FIG. 49, or only a subset of the components. The level of integration between the components may vary from one UE to another UE. Further, certain UEs may contain multiple instances of a component, such as multiple processors, memories, transceivers, transmitters, receivers, etc.

In FIG. 49, processing circuitry 4901 may be configured to process computer instructions and data. Processing circuitry 4901 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4901 may include two central processing units (CPUs). Data may be information in a form suitable for use by a computer.

In the depicted embodiment, input/output interface 4905 may be configured to provide a communication interface to an input device, output device, or input and output device. UE 4900 may be configured to use an output device via input/output interface 4905. An output device may use the same type of interface port as an input device. For example, a USB port may be used to provide input to and output from UE 4900. The output device may be a speaker, a sound card, a video card, a display, a monitor, a printer, an actuator, an emitter, a smartcard, another output device, or any combination thereof. UE 4900 may be configured to use an input device via input/output interface 4905 to allow a user to capture information into UE 4900. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 49, RF interface 4909 may be configured to provide a communication interface to RF components such as a transmitter, a receiver, and an antenna. Network connection interface 4911 may be configured to provide a communication interface to network 4943a. Network 4943a may encompass wired and/or wireless networks such as a local-area network (LAN), a wide-area network (WAN), a computer network, a wireless network, a telecommunications network, another like network or any combination thereof. For example, network 4943a may comprise a Wi-Fi network. Network connection interface 4911 may be configured to include a receiver and a transmitter interface used to communicate with one or more other devices over a communication network according to one or more communication protocols, such as Ethernet, TCP/IP, SONET, ATM, or the like. Network connection interface 4911 may implement receiver and transmitter functionality appropriate to the communication network links (e.g., optical, electrical, and the like). The transmitter and receiver functions may share circuit components, software or firmware, or alternatively may be implemented separately.

RAM 4917 may be configured to interface via bus 4902 to processing circuitry 4901 to provide storage or caching of data or computer instructions during the execution of software programs such as the operating system, application programs, and device drivers. ROM 4919 may be configured to provide computer instructions or data to processing circuitry 4901. For example, ROM 4919 may be configured to store invariant low-level system code or data for basic system functions such as basic input and output (I/O), startup, or reception of keystrokes from a keyboard that are stored in a non-volatile memory. Storage medium 4921 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4921 may be configured to include operating system 4923, application program 4925 such as a web browser application, a widget or gadget engine or another application, and data file 4927. Storage medium 4921 may store, for use by UE 4900, any of a variety of various operating systems or combinations of operating systems.

Storage medium 4921 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4921 may allow UE 4900 to access computer-executable instructions, application programs or the like, stored on transitory or non-transitory memory media, to off-load data, or to upload data. An article of manufacture, such as one utilizing a communication system may be tangibly embodied in storage medium 4921, which may comprise a device readable medium.

In FIG. 49, processing circuitry 4901 may be configured to communicate with network 4943b using communication subsystem 4931. Network 4943a and network 4943b may be the same network or networks or different network or networks. Communication subsystem 4931 may be configured to include one or more transceivers used to communicate with network 4943b. For example, communication subsystem 4931 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4933 and/or receiver 4935 to implement transmitter or receiver functionality, respectively, appropriate to the RAN links (e.g., frequency allocations and the like). Further, transmitter 4933 and receiver 4935 of each transceiver may share circuit components, software or firmware, or alternatively may be implemented separately.

In the illustrated embodiment, the communication functions of communication subsystem 4931 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4931 may include cellular communication, Wi-Fi communication, Bluetooth communication, and GPS communication. Network 4943b may encompass wired and/or wireless networks such as a local-area network (LAN), a wide-area network (WAN), a computer network, a wireless network, a telecommunications network, another like network or any combination thereof. For example, network 4943b may be a cellular network, a Wi-Fi network, and/or a near-field network. Power source 4913 may be configured to provide alternating current (AC) or direct current (DC) power to components of UE 4900.

The features, benefits and/or functions described herein may be implemented in one of the components of UE 4900 or partitioned across multiple components of UE 4900. Further, the features, benefits, and/or functions described herein may be implemented in any combination of hardware, software or firmware. In one example, communication subsystem 4931 may be configured to include any of the components described herein. Further, processing circuitry 4901 may be configured to communicate with any of such components over bus 4902. In another example, any of such components may be represented by program instructions stored in memory that when executed by processing circuitry 4901 perform the corresponding functions described herein. In another example, the functionality of any of such components may be partitioned between processing circuitry 4901 and communication subsystem 4931. In another example, the non-computationally intensive functions of any of such components may be implemented in software or firmware and the computationally intensive functions may be implemented in hardware.

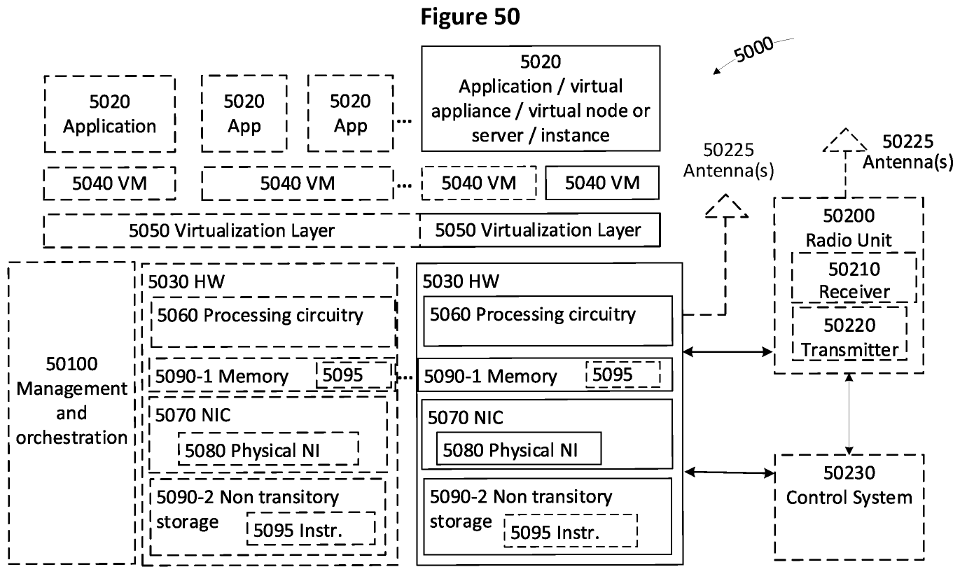

FIG. 50 illustrates a virtualization environment in accordance with some embodiments.

FIG. 50 is a schematic block diagram illustrating a virtualization environment 5000 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 5000 hosted by one or more of hardware nodes 5030. Further, in embodiments in which the virtual node is not a radio access node or does not require radio connectivity (e.g., a core network node), then the network node may be entirely virtualized.

The functions may be implemented by one or more applications 5020 (which may alternatively be called software instances, virtual appliances, network functions, virtual nodes, virtual network functions, etc.) operative to implement some of the features, functions, and/or benefits of some of the embodiments disclosed herein. Applications 5020 are run in virtualization environment 5000 which provides hardware 5030 comprising processing circuitry 5060 and memory 5090. Memory 5090 contains instructions 5095 executable by processing circuitry 5060 whereby application 5020 is operative to provide one or more of the features, benefits, and/or functions disclosed herein.

Virtualization environment 5000, comprises general-purpose or special-purpose network hardware devices 5030 comprising a set of one or more processors or processing circuitry 5060, which may be commercial off-the-shelf (COTS) processors, dedicated Application Specific Integrated Circuits (ASICs), or any other type of processing circuitry including digital or analog hardware components or special purpose processors. Each hardware device may comprise memory 5090-1 which may be non-persistent memory for temporarily storing instructions 5095 or software executed by processing circuitry 5060. Each hardware device may comprise one or more network interface controllers (NICs) 5070, also known as network interface cards, which include physical network interface 5080. Each hardware device may also include non-transitory, persistent, machine-readable storage media 5090-2 having stored therein software 5095 and/or instructions executable by processing circuitry 5060. Software 5095 may include any type of software including software for instantiating one or more virtualization layers 5050 (also referred to as hypervisors), software to execute virtual machines 5040 as well as software allowing it to execute functions, features and/or benefits described in relation with some embodiments described herein.

Virtual machines 5040 comprise virtual processing, virtual memory, virtual networking or interface and virtual storage, and may be run by a corresponding virtualization layer 5050 or hypervisor. Different embodiments of the instance of virtual appliance 5020 may be implemented on one or more of virtual machines 5040, and the implementations may be made in different ways.

During operation, processing circuitry 5060 executes software 5095 to instantiate the hypervisor or virtualization layer 5050, which may sometimes be referred to as a virtual machine monitor (VMM). Virtualization layer 5050 may present a virtual operating platform that appears like networking hardware to virtual machine 5040.

As shown in FIG. 50, hardware 5030 may be a standalone network node with generic or specific components. Hardware 5030 may comprise antenna 50225 and may implement some functions via virtualization. Alternatively, hardware 5030 may be part of a larger cluster of hardware (e.g. such as in a data center or customer premise equipment (CPE)) where many hardware nodes work together and are managed via management and orchestration (MANO) 50100, which, among others, oversees lifecycle management of applications 5020.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 5040 may be a software implementation of a physical machine that runs programs as if they were executing on a physical, non-virtualized machine. Each of virtual machines 5040, and that part of hardware 5030 that executes that virtual machine, be it hardware dedicated to that virtual machine and/or hardware shared by that virtual machine with others of the virtual machines 5040, forms a separate virtual network elements (VNE).

Still in the context of NFV, Virtual Network Function (VNF) is responsible for handling specific network functions that run in one or more virtual machines 5040 on top of hardware networking infrastructure 5030 and corresponds to application 5020 in FIG. 50.

In some embodiments, one or more radio units 50200 that each include one or more transmitters 50220 and one or more receivers 50210 may be coupled to one or more antennas 50225. Radio units 50200 may communicate directly with hardware nodes 5030 via one or more appropriate network interfaces and may be used in combination with the virtual components to provide a virtual node with radio capabilities, such as a radio access node or a base station.

In some embodiments, some signalling can be effected with the use of control system 50230 which may alternatively be used for communication between the hardware nodes 5030 and radio units 50200.

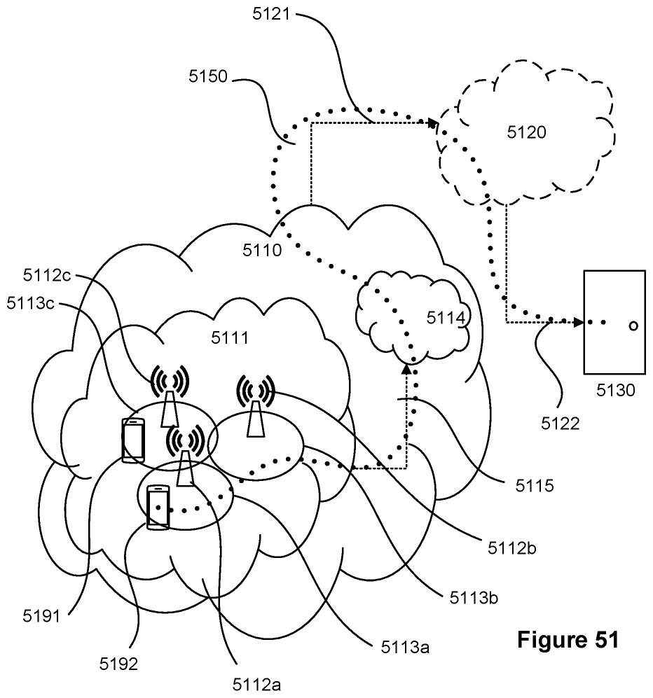

FIG. 51 illustrates a telecommunication network connected via an intermediate network to a host computer in accordance with some embodiments.

With reference to FIG. 51, in accordance with an embodiment, a communication system includes telecommunication network 5110, such as a 3GPP-type cellular network, which comprises access network 5111, such as a radio access network, and core network 5114. Access network 5111 comprises a plurality of base stations 5112a, 5112b, 5112c, such as NBs, eNBs, gNBs or other types of wireless access points, each defining a corresponding coverage area 5113a, 5113b, 5113c. Each base station 5112a, 5112b, 5112c is connectable to core network 5114 over a wired or wireless connection 5115. A first UE 5191 located in coverage area 5113c is configured to wirelessly connect to, or be paged by, the corresponding base station 5112c. A second UE 5192 in coverage area 5113a is wirelessly connectable to the corresponding base station 5112a. While a plurality of UEs 5191, 5192 are illustrated in this example, the disclosed embodiments are equally applicable to a situation where a sole UE is in the coverage area or where a sole UE is connecting to the corresponding base station 5112.

Telecommunication network 5110 is itself connected to host computer 5130, which may be embodied in the hardware and/or software of a standalone server, a cloud-implemented server, a distributed server or as processing resources in a server farm. Host computer 5130 may be under the ownership or control of a service provider, or may be operated by the service provider or on behalf of the service provider. Connections 5121 and 5122 between telecommunication network 5110 and host computer 5130 may extend directly from core network 5114 to host computer 5130 or may go via an optional intermediate network 5120. Intermediate network 5120 may be one of, or a combination of more than one of, a public, private or hosted network; intermediate network 5120, if any, may be a backbone network or the Internet; in particular, intermediate network 5120 may comprise two or more sub-networks (not shown).

The communication system of FIG. 51 as a whole enables connectivity between the connected UEs 5191, 5192 and host computer 5130. The connectivity may be described as an over-the-top (OTT) connection 5151. Host computer 5130 and the connected UEs 5191, 5192 are configured to communicate data and/or signaling via OTT connection 5151, using access network 5111, core network 5114, any intermediate network 5120 and possible further infrastructure (not shown) as intermediaries. OTT connection 5151 may be transparent in the sense that the participating communication devices through which OTT connection 5151 passes are unaware of routing of uplink and downlink communications. For example, base station 5012 may not or need not be informed about the past routing of an incoming downlink communication with data originating from host computer 5130 to be forwarded (e.g., handed over) to a connected UE 5191. Similarly, base station 5112 need not be aware of the future routing of an outgoing uplink communication originating from the UE 5191 towards the host computer 5130.

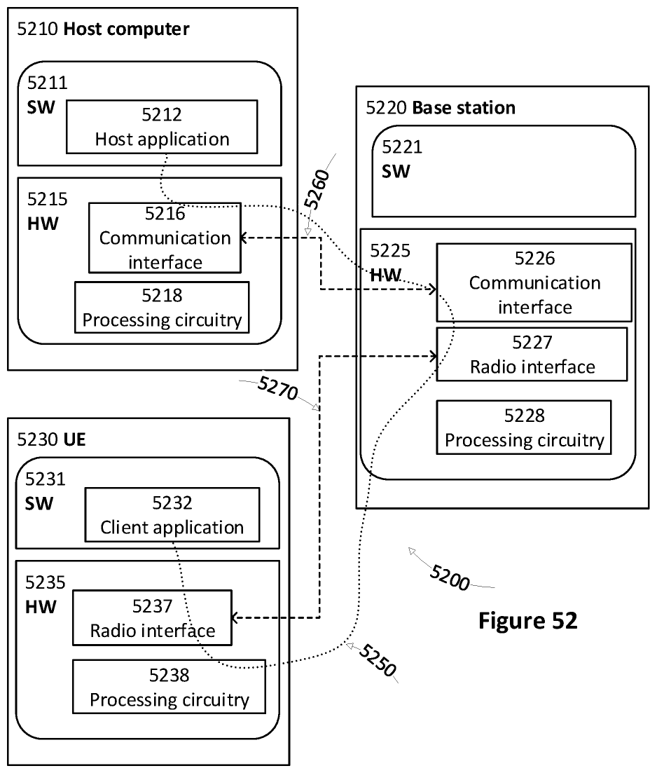

FIG. 52 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 52. In communication system 5200, host computer 5210 comprises hardware 5215 including communication interface 5216 configured to set up and maintain a wired or wireless connection with an interface of a different communication device of communication system 5200. Host computer 5210 further comprises processing circuitry 5218, which may have storage and/or processing capabilities. In particular, processing circuitry 5218 may comprise one or more programmable processors, application-specific integrated circuits, field programmable gate arrays or combinations of these (not shown) adapted to execute instructions. Host computer 5210 further comprises software 5211, which is stored in or accessible by host computer 5210 and executable by processing circuitry 5218. Software 5211 includes host application 5212. Host application 5212 may be operable to provide a service to a remote user, such as UE 5230 connecting via OTT connection 5250 terminating at UE 5230 and host computer 5210. In providing the service to the remote user, host application 5212 may provide user data which is transmitted using OTT connection 5250.

Communication system 5200 further includes base station 5220 provided in a telecommunication system and comprising hardware 5225 enabling it to communicate with host computer 5210 and with UE 5230. Hardware 5225 may include communication interface 5226 for setting up and maintaining a wired or wireless connection with an interface of a different communication device of communication system 5200, as well as radio interface 5227 for setting up and maintaining at least wireless connection 5270 with UE 5230 located in a coverage area (not shown in FIG. 52) served by base station 5220. Communication interface 5226 may be configured to facilitate connection 5260 to host computer 5210. Connection 5260 may be direct or it may pass through a core network (not shown in FIG. 52) of the telecommunication system and/or through one or more intermediate networks outside the telecommunication system. In the embodiment shown, hardware 5225 of base station 5220 further includes processing circuitry 5228, which may comprise one or more programmable processors, application-specific integrated circuits, field programmable gate arrays or combinations of these (not shown) adapted to execute instructions. Base station 5220 further has software 5221 stored internally or accessible via an external connection.

Communication system 5200 further includes UE 5230 already referred to. Its hardware 5235 may include radio interface 5237 configured to set up and maintain wireless connection 5270 with a base station serving a coverage area in which UE 5230 is currently located. Hardware 5235 of UE 5230 further includes processing circuitry 5238, which may comprise one or more programmable processors, application-specific integrated circuits, field programmable gate arrays or combinations of these (not shown) adapted to execute instructions. UE 5230 further comprises software 5231, which is stored in or accessible by UE 5230 and executable by processing circuitry 5238. Software 5231 includes client application 5232. Client application 5232 may be operable to provide a service to a human or non-human user via UE 5230, with the support of host computer 5210. In host computer 5210, an executing host application 5212 may communicate with the executing client application 5232 via OTT connection 5250 terminating at UE 5230 and host computer 5210. In providing the service to the user, client application 5232 may receive request data from host application 5212 and provide user data in response to the request data. OTT connection 5250 may transfer both the request data and the user data. Client application 5232 may interact with the user to generate the user data that it provides.

It is noted that host computer 5210, base station 5220 and UE 5230 illustrated in FIG. 52 may be similar or identical to host computer 5030, one of base stations 5012a, 5012b, 5012c and one of UEs 5091, 5092 of FIG. 51, respectively. This is to say, the inner workings of these entities may be as shown in FIG. 52 and independently, the surrounding network topology may be that of FIG. 51.

In FIG. 52, OTT connection 5250 has been drawn abstractly to illustrate the communication between host computer 5210 and UE 5230 via base station 5220, without explicit reference to any intermediary devices and the precise routing of messages via these devices. Network infrastructure may determine the routing, which it may be configured to hide from UE 5230 or from the service provider operating host computer 5210, or both. While OTT connection 5250 is active, the network infrastructure may further take decisions by which it dynamically changes the routing (e.g., on the basis of load balancing consideration or reconfiguration of the network).

Wireless connection 5270 between UE 5230 and base station 5220 is in accordance with the teachings of the embodiments described throughout this disclosure. One or more of the various embodiments may improve the performance of OTT services provided to UE 5230 using OTT connection 5250, in which wireless connection 5270 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 5250 between host computer 5210 and UE 5230, in response to variations in the measurement results. The measurement procedure and/or the network functionality for reconfiguring OTT connection 5250 may be implemented in software 5211 and hardware 5215 of host computer 5210 or in software 5231 and hardware 5235 of UE 5230, or both. In embodiments, sensors (not shown) may be deployed in or in association with communication devices through which OTT connection 5250 passes; the sensors may participate in the measurement procedure by supplying values of the monitored quantities exemplified above, or supplying values of other physical quantities from which software 5211, 5231 may compute or estimate the monitored quantities. The reconfiguring of OTT connection 5250 may include message format, retransmission settings, preferred routing etc.; the reconfiguring need not affect base station 5220, and it may be unknown or imperceptible to base station 5220. Such procedures and functionalities may be known and practiced in the art. In certain embodiments, measurements may involve proprietary UE signaling facilitating host computer 5210's measurements of throughput, propagation times, latency and the like. The measurements may be implemented in that software 5211 and 5231 causes messages to be transmitted, in particular empty or ‘dummy’ messages, using OTT connection 5250 while it monitors propagation times, errors etc.

FIG. 53 illustrates methods implemented in a communication system including a host computer, a base station and a user equipment in accordance with some embodiments

FIG. 53 is a flowchart illustrating a method implemented in a communication system, in accordance with one embodiment. The communication system includes a host computer, a base station and a UE which may be those described with reference to FIGS. 51 and 52. For simplicity of the present disclosure, only drawing references to FIG. 53 will be included in this section. In step 5310, the host computer provides user data. In substep 5311 (which may be optional) of step 5310, the host computer provides the user data by executing a host application. In step 5320, the host computer initiates a transmission carrying the user data to the UE. In step 5330 (which may be optional), the base station transmits to the UE the user data which was carried in the transmission that the host computer initiated, in accordance with the teachings of the embodiments described throughout this disclosure. In step 5340 (which may also be optional), the UE executes a client application associated with the host application executed by the host computer.

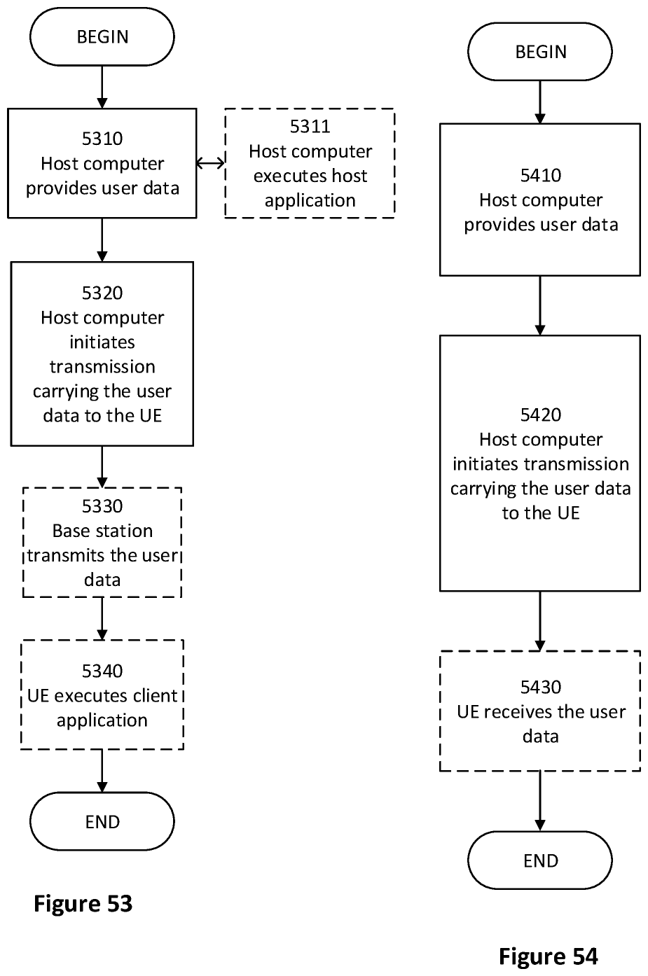

FIG. 54 illustrates methods implemented in a communication system including a host computer, a base station and a user equipment in accordance with some embodiments.

FIG. 54 is a flowchart illustrating a method implemented in a communication system, in accordance with one embodiment. The communication system includes a host computer, a base station and a UE which may be those described with reference to FIGS. 51 and 52. For simplicity of the present disclosure, only drawing references to FIG. 54 will be included in this section. In step 5410 of the method, the host computer provides user data. In an optional substep (not shown) the host computer provides the user data by executing a host application. In step 5420, the host computer initiates a transmission carrying the user data to the UE. The transmission may pass via the base station, in accordance with the teachings of the embodiments described throughout this disclosure. In step 5430 (which may be optional), the UE receives the user data carried in the transmission.

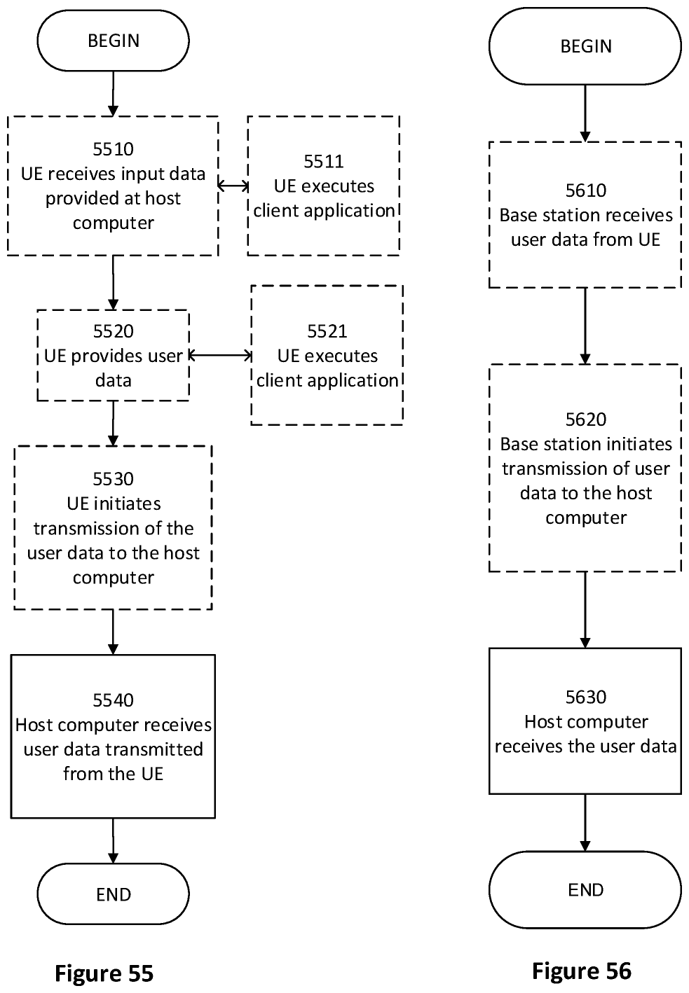

FIG. 55 illustrates methods implemented in a communication system including a host computer, a base station and a user equipment in accordance with some embodiments

FIG. 55 is a flowchart illustrating a method implemented in a communication system, in accordance with one embodiment. The communication system includes a host computer, a base station and a UE which may be those described with reference to FIGS. 51 and 52. For simplicity of the present disclosure, only drawing references to FIG. 55 will be included in this section. In step S510 (which may be optional), the UE receives input data provided by the host computer. Additionally or alternatively, in step 5530, the UE provides user data. In substep 5531 (which may be optional) of step 5530, the UE provides the user data by executing a client application. In substep 5511 (which may be optional) of step 5510, the UE executes a client application which provides the user data in reaction to the received input data provided by the host computer. In providing the user data, the executed client application may further consider user input received from the user. Regardless of the specific manner in which the user data was provided, the UE initiates, in substep 5530 (which may be optional), transmission of the user data to the host computer. In step 5540 of the method, the host computer receives the user data transmitted from the UE, in accordance with the teachings of the embodiments described throughout this disclosure.

FIG. 56 illustrates methods implemented in a communication system including a host computer, a base station and a user equipment in accordance with some embodiments

FIG. 56 is a flowchart illustrating a method implemented in a communication system, in accordance with one embodiment. The communication system includes a host computer, a base station and a UE which may be those described with reference to FIGS. 51 and 52. For simplicity of the present disclosure, only drawing references to FIG. 56 will be included in this section. In step 5610 (which may be optional), in accordance with the teachings of the embodiments described throughout this disclosure, the base station receives user data from the UE. In step 5620 (which may be optional), the base station initiates transmission of the received user data to the host computer. In step 5630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method performed by a vehicle-to everything, V2X, application enabler, VAE, client, the method comprising:
receiving a user equipment, UE, measurements configuration request from a vehicle-to everything, V2X, application-specific client;
processing the UE measurements configuration request;
transmitting the UE measurements configuration request to a vehicle-to everything, V2X, application enabler, VAE, server;
receiving a UE measurements configuration response from the VAE server;
processing the UE measurements configuration response; and
transmitting the UE measurements configuration response to the V2X application-specific client.

2. The method of claim 1, wherein processing the UE measurements configuration request comprises at least one of:
determining a VAE server to send the UE measurements configuration request to;
determining whether or not the UE measurements configuration request can be accepted by determining whether or not reception of UE measurements is supported by the VAE server; and
updating or translating parameters included in the UE measurements configuration request.

3. The method of claim 1 wherein processing the UE measurements configuration response comprises responsive to the UE measurements configuration response indicating an acceptance of the UE measurements configuration request, storing configuration information of the UE measurements indicated in the UE measurement configuration response reporting based on the information in the UE measurements configuration response, the method further comprising:
responsive to determining that the UE measurements configuration cannot be accepted, transmitting a response to the V2X application-specific client indicating failure of the UE measurements configuration request.

4. (canceled)

5. The method of claim 1 further comprising:
receiving a UE measurements configuration cancel request from the VAE server;
determining which V2X application-specific client to send the UE measurements configuration cancel request;
transmitting the UE measurements configuration cancel request to the V2X application-specific client determined;
receiving a UE measurements configuration cancel response from the V2X application-specific client determined;
processing the UE measurements configuration cancel response; and
transmitting the UE measurements configuration cancel response to the VAE server.

6. The method of claim 1 further comprising:
receiving a UE measurements configuration cancel request from the V2X application-specific client;
processing the UE measurements configuration cancel request;
transmitting the UE measurements configuration cancel request to the VAE server;
receiving a UE measurements configuration cancel response from the VAE server;
processing the UE measurements configuration cancel response; and
transmitting the UE measurements configuration cancel response to the V2X application-specific client.

7-9. (canceled)

10. A method performed by a vehicle-to everything, V2X, application enabler, VAE, server, the method comprising:
receiving a user equipment, UE, measurements configuration request from one of a vehicle-to everything, V2X, application-specific server or a VAE client;
processing the UE measurements configuration request; and
transmitting a UE measurements configuration response to the one of the V2X application-specific server or the VAE client.

11. (canceled)

12. The method of claim 10 wherein the UE measurements configuration request comprises information including one or more of:
a list of UE measurements the one of the V2X application-specific server or the VAE client can provide to the VAE server that are generated at the V2X application-specific server or from a V2X application-specific client;
one or more V2X application-specific client identifiers, IDs;
a V2X application-specific server ID of the V2X application-specific server;
one or more V2X service IDs; and
an application flow description, and
wherein processing the UE measurements configuration request comprises determining at least one of:
checking whether the UE measurements configuration request can be accepted by determining whether reception of UE measurements is supported and whether UE measurements can be used at the VAE server; and
determining which UE measurements should be provided and their associated geographical areas, time windows, measurement frequency, and measurement filter information.

13. (canceled)

14. The method of claim 10 further comprising:
responsive to the UE measurements configuration request being accepted, storing configuration information of the UE measurements from the V2X application-specific server or from the VAE client.

15. The method of claim 10 further comprising:
transmitting a UE measurements configuration cancel request to the one of the V2X application-specific server or the VAE client; and
receiving a UE measurements configuration cancel response from the one of the V2X application-specific server or the VAE client,
wherein transmitting the UE measurement configuration cancel request comprises transmitting the UE measurement configuration cancel request responsive to a trigger occurring, wherein the trigger comprises at least one of:
the VAE server stopping tasks to which the UE measurements were associated with; and
a load of the VAE server being above a threshold level or at the threshold level.

16-17. (canceled)

18. The method of claim 10 further comprising:
receiving a UE measurements configuration cancel request from the one of the V2X application-specific server or the VAE client and
transmitting a UE measurements configuration cancel response to the one of the V2X application-specific server or the VAE client.

19. (canceled)

20. The method of claim 18 wherein responsive to no information being included in the UE measurements configuration cancel request, canceling all previously configured UE measurements associated with the one of the V2X application-specific server or the VAE client.

21.-23. (canceled)

24. A method performed by a vehicle-to everything, V2X, application-specific client, the method comprising:
transmitting a user equipment, UE, measurements configuration request towards a vehicle-to everything, V2X, application enabler, VAE, server;
receiving a UE measurements configuration response from the VAE server; and
processing the UE measurements configuration response.

25. The method of claim 24 wherein transmitting the UE measurements configuration request comprises transmitting the UE measurements configuration request responsive to a trigger occurring, wherein the trigger comprises at least one of:
obtaining awareness of support of UE measurements configuration by the VAE server;
determining that receiving a QoS notification by the V2X application-specific server is associated with support of UE measurements;
determining that specific applications or services are active;
determining that the V2X application-specific client is at a specific geographic location; and
determining that the V2X application-specific client is within a specified time window.

26. (canceled)

27. The method of claim 24, further comprising specifying information for the UE measurements configuration request, the information comprising one or more of:
a list of UE measurements the V2X application-specific client can provide to the VAE server;
one or more V2X application-specific client identifiers, IDs;
a V2X application-specific server ID of the V2X application-specific server;
one or more V2X service IDs; and
an application flow description.

28. (canceled)

29. The method of claim 24 further comprising:
invalidating UE measurements configuration of at least one UE measurement;
transmitting a UE measurements configuration cancel request towards the VAE server; and
receiving a UE measurements configuration cancel response from the VAE server.

30. (canceled)

31. The method of claim 29 wherein invalidating the UE measurement configuration comprises invalidating the UE measurements configuration responsive to a trigger occurring, wherein the trigger comprises at least one of:
the V2X application-specific client stopping traffic to which the UE measurements were associated with; and
changes in traffic configuration of an application prioritizing other traffic such that the V2X application-specific client or the V2X application-specific server cannot send UE measurements.

32-34. (canceled)

35. A method performed by a vehicle-to everything, V2X, application-specific server, the method comprising:
transmitting a user equipment, UE, measurements configuration request to a vehicle-to everything, V2X, application enabler, VAE, server;
receiving a UE measurements configuration response from the VAE server; and
processing the UE measurements configuration response.

36. (canceled)

37. The method of claim 35 wherein transmitting the UE measurements configuration request comprises transmitting the UE measurements configuration request responsive to a trigger occurring, wherein the trigger comprises at least one of:
obtaining awareness of support of UE measurements configuration by the VAE server;
determining that receiving a QoS notification by the V2X application-specific server is associated with support of UE measurements;
determining that specific applications or services are active;
determining that the V2X application-specific client is at a specific geographic location; and
determining that the V2X application-specific client is within a specified time window.

38. (canceled)

39. The method of claim 35 further comprising:
receiving a UE measurements configuration cancel request from the VAE server;
invalidating UE measurements indicated in the UE measurements configuration cancel request; and
transmitting a UE measurements configuration cancel response to the VAE server.

40. The method of claim 35 further comprising:
invalidating UE measurements configuration of at least one UE measurement of a V2X application-specific client;
transmitting a UE measurements configuration cancel request to the VAE server; and
receiving a UE measurements configuration cancel response from the VAE server.

41-43. (canceled)
